(19) United States
(12) Patent Application Publication
(10) Pub. No.: US 2026/0041097 A1
(43) Pub. Date: Feb. 12, 2026

(54) PLANT PRIMING COMPOSITIONS AND METHODS OF USE THEREOF

(71) Applicant: ZERO GRAVITY SOLUTIONS, INC., Boca Raton, FL (US)

(72) Inventor: Raveendran POTTATHIL, La Jolla, CA (US)

(21) Appl. No.: 19/067,410

(22) Filed: Feb. 28, 2025

Related U.S. Application Data
(62) Division of application No. 17/761,955, now abandoned.
(60) Provisional application No. 62/893,028, filed on Aug. 28, 2019.

(51) Int. Cl. A01N 59/16; A01N 37/36; A01N 59/20; A01P 21/00

(52) U.S. Cl. CPC A01N 59/16; A01N 37/36; A01N 59/20; A01P 21/00

(57) ABSTRACT

Provided herein are compositions and methods to improve plant resistance to abiotic and biotic stress, thereby improving crop yield. Provided herein are compositions including zinc, copper, and an acid, where the acid is selected from citric acid, sulfuric acid, oxalic acid, humic acid, fulvic acid, boric acid, acetic acid, and a combination thereof. Certain embodiments optionally include ammonium sulfate. Compositions described herein have plant priming activity where the plant's defenses against abiotic and biotic stress are boosted.

### CROSS-REFERENCES TO RELATED APPLICATIONS

This application claims priority to U.S. Application No. 62/893,028 filed Aug. 28, 2019, the disclosure of which is incorporated by reference herein in its entirety.

### BACKGROUND

Plants are constantly confronted by both abiotic and biotic stressors that seriously reduce their productivity. Plant responses to these stressors are complex and involve numerous physiological, molecular, and cellular adaptations. Priming is an adaptive strategy that improves the defensive capacity of plants. This phenomenon is marked by an enhanced activation of induced defense mechanisms. Stimuli from pathogens, beneficial microbes, or arthropods, as well as chemicals and abiotic cues, can trigger the establishment of priming by acting as warning signals. Upon stimulus perception, changes may occur in the plant at the physiological, transcriptional, metabolic, and epigenetic levels. This phase is called the priming phase. Upon subsequent challenge, the plant effectively mounts a faster and/or stronger defense response that defines the post-challenge primed state and results in increased resistance and/or stress tolerance. Priming can be durable and maintained throughout the plant's life cycle and can even be transmitted to subsequent generations, therefore representing a type of plant immunological memory.

Evidence shows that a combination of abiotic and biotic stress can have a positive effect on plant performance by reducing the susceptibility to biotic stressors. Such an interaction between both types of stressors points to a crosstalk between their respective signaling pathways. This crosstalk may be synergistic and/or antagonistic and include the involvement of phytohormones, transcription factors, kinase cascades, and reactive oxygen species (ROS). In certain cases, such crosstalk can lead to a cross-tolerance and enhancement of a plant's resistance against pathogens or stress. Crop plants are subjected to multiple stressors during their lifespan that greatly reduce productivity and threaten global food security.

There remains the need for compositions and methods to prime plants to increase resistance and/or stress tolerance, and increase crop yield.

### BRIEF SUMMARY

In view of the foregoing, there is a need for formulations that improve crop production. The present disclosure addresses this need, and provides additional benefits as well.

In an aspect, provided herein are compositions including zinc, copper, and an acid, where the acid is selected from citric acid, sulfuric acid, oxalic acid, humic acid, fulvic acid, boric acid, acetic acid, and a combination thereof, and optionally ammonium sulfate, where the ratio of copper to zinc is between 1:2 and 1:20, and where the composition has plant priming activity.

In an aspect, provided herein are compositions including zinc, copper, and an acid, where the acid is selected from citric acid, sulfuric acid, oxalic acid, humic acid, fulvic acid, boric acid, acetic acid, and a combination thereof, and optionally ammonium sulfate, where the ratio of copper to zinc is between 1:2 and 1:20, and where the composition is formulated as a dry powder.

In an aspect, provided herein are compositions including zinc, copper, and an acid, where the acid is selected from citric acid, sulfuric acid, oxalic acid, humic acid, fulvic acid, boric acid, acetic acid, and a combination thereof, and optionally ammonium sulfate, where the ratio of copper to zinc is between 1:2 and 1:20, and where the composition is formulated as a foliar spray.

In an aspect, provided herein are methods of reducing cellular damage to a plant including treating the plant with a composition including zinc, copper, and acid, where the acid is selected from citric acid, sulfuric acid, oxalic acid, humic acid, fulvic acid, boric acid, acetic acid, and a combination thereof, and optionally ammonium sulfate, and where the ratio of copper to zinc is between 1:2 and 1:20.

In an aspect, provided herein are methods of priming a plant against abiotic stress factors including treating the plant with a composition including zinc, copper, and acid, where the acid is selected from citric acid, sulfuric acid, oxalic acid, humic acid, fulvic acid, boric acid, acetic acid, and a combination thereof, and optionally ammonium sulfate, and where the ratio of copper to zinc is between 1:2 and 1:20.

In an aspect, provided herein are methods of promoting growth of a plant including treating the plant with a composition including zinc, copper, and acid, wherein the acid is selected from citric acid, sulfuric acid, oxalic acid, humic acid, fulvic acid, boric acid, acetic acid, and a combination thereof, and optionally ammonium sulfate, and where the ratio of copper to zinc is between 1:2 and 1:20.

In an aspect, provided herein are methods of priming a plant against biotic stress factors including treating the plant with a composition comprising zinc, copper, and acid, where the acid is selected from citric acid, sulfuric acid, oxalic acid, humic acid, fulvic acid, boric acid, acetic acid, and optionally ammonium sulfate, and a combination thereof, and where the ratio of copper to zinc is between 1:2 and 1:20.

In an aspect, provided herein are methods of controlling a fungus infection in a plant susceptible thereto. The methods include applying a composition including zinc, copper, and acid, wherein the acid is selected from citric acid, sulfuric acid, oxalic acid, humic acid, fulvic acid, boric acid, acetic acid, and a combination thereof, and optionally ammonium sulfate, and where the ratio of copper to zinc is between 1:2 and 1:20.

### BRIEF DESCRIPTION OF THE DRAWINGS

FIG. 1 demonstrates germination acceleration of Pigeon pea seeds by BAM-FX at different concentrations.

FIG. 2 presents data for BAM-FX strawberry trial at Savino Farms, Tanglewood Ranch in Santa Maria, California in December 2017. BAM-FX treated strawberry plants (left) yielded 21.3% more crates/acre, compared to untreated strawberry plants (UTC; right). BAM-FX treated plants resulted in strawberries with a 5% increase in average BRIX.

FIG. 3 is a bar graph illustrating induction of carboxylic acid production in okra seeds 12 hours, or 24 hours after BAM-FX treatment. UTC: untreated control. Test groups were BAM-FX at 1:175 and 1:500 dilution.

FIG. 4 is a bar graph showing production levels of carboxylic acid, a biomarker of plant priming, in BAM-FX treated maize seeds. UTC: untreated control. Test groups were BAM-FX at 1:175, 1:500, and 1:1000 dilution

FIG. 5 is a bar graph showing levels of succinic acid, a biomarker of plant priming, in BAM-FX treated maize seeds. UTC: untreated control. Test groups were BAM-FX at 1:175, 1:500, and 1:1000 dilution

FIGS. 6A-D presents data showing levels of carboxylic acids induced by BAM-FX in okra seeds. FIG. 6A shows carboxylic acid induction data after 12 hours for okra seeds soaked in 1:175 BAM-FX. FIG. 6B shows carboxylic acid induction data after 24 hours for okra seeds soaked in 1:175 BAM-FX. FIG. 6C shows carboxylic acid induction data after 24 hours for okra seeds soaked in 1:500 BAM-FX. FIG. 6D shows data for the untreated seeds (negative control; soaked in water). Bars are representative of areas under curves of GCMS chromatogram for analysis of biomarkers.

FIGS. 7A-7B presents data showing levels of carboxylic acids induced by BAM-FX in tomato seeds. FIG. 7A shows carboxylic acid induction data after 24 hours for tomato seeds soaked in 1:175 BAM-FX. Bars are representative of areas under curves of GCMS chromatogram for analysis of biomarkers.

FIGS. 8A-8B presents data showing levels of carboxylic acids induced by BAM-FX in chili plants. FIG. 8A shows data for the untreated (negative) control. FIG. 8B shows data for chili plants treated with 1:250 BAM-FX. Bars are representative of areas under curves of GCMS chromatogram for analysis of biomarkers.

FIGS. 9A-9C are bar graphs and graph legend showing levels of biomarkers induced by BAM-FX in okra seeds (FIG. 9A), tomato seeds (FIG. 9B), and the controls including untreated seeds (negative control) and seeds treated with Aspergillus sp. (positive control) (FIG. 9C). Bars are representative of areas under curves of LCMS chromatograms for analysis of biomarkers.

FIGS. 10A-10C are magnified views and the legend of data shown in FIGS. 9A-C. FIG. 10A is a bar graph illustrating levels of biomarkers detected for BAM-FX okra seeds. FIG. 10B is a bar graph illustrating levels of biomarkers detected for BAM-FX okra seeds. FIG. 10C is a bar graph illustrating levels of biomarkers detected for the positive and negative controls.

FIG. 11 is a representative image of radish harvest from control plants (left) and BAM-FX-treated plants (right). One breed of radish plant was tested with 42 plants per condition. BAM-FX was applied by foliar spray, one application per week for 8 weeks.

FIG. 12 is a representative image of control and BAM-FX treated grapes from a wine grape trial in Arroyo Sero, Greenfield, California.

FIG. 13 is a representative image of broccoli from a BAM-FX broccoli seed trial aboard International Space Station. BAM-FX-treated seedlings (two plants bottom of panel) displayed a longer root growth during the same time period as the control seedling (two plants top of panel) in zero gravity conditions of the International Space Station.

FIG. 14 is a representative image of tobacco plants from a BAM-FX trial. Treated tobacco plants yielded larger leaves (right in panel) at harvest than control group leaves (left in panel).

FIG. 15 is a representative image of BAM-FX treated corn plants and control group plants. BAM-FX treated corn yielded larger root clusters (right in panel) at harvest than control group corn (left in panel).

FIG. 16 is a representative image of avocados in a BAM-FX avocado trial in Temecula, California. BAM-FX was applied to mature avocado trees for a whole year's growing season. The harvested fruit from the BAM-FX-treated trees (right in panel) was 57.1% greater in weight on average as compared to the control trees (left in panel), and BAM-FX trees had 134% greater yield of total fruit.

FIG. 17 is a representative image of BAM-FX-treated rice (bottom of panel) and untreated control rice (top of panel).

FIG. 18 is a representative image of BAM-FX-treated corn (right in panel) as compared to control corn (left in panel). At the midpoint of the study, the BAM-FX-treated corn plants yielded ears at an average of 2.2 oz., and the control plants yielded ears at an average of 0.8 oz.

FIG. 19 is a representative image of BAM-FX treated and untreated impatiens plants. BAM-FX application increased the chlorophyll content of the leaves and the overall size and quality of the plant (right in panel) as compared to the control (left in panel).

FIG. 20 is a representative image cannabis plants from a BAM-FX trial in Aurora, Colorado. The BAM-FX-treated plants (right in panel) had improved overall plant quality as well as resistance to fungus and gnat invaders as compared to the control plants (left in panel).

### DETAILED DESCRIPTION

### I. Definitions

The practice of the technology described herein will employ, unless indicated specifically to the contrary, conventional methods of chemistry, biochemistry, organic chemistry, molecular biology, microbiology, agriculture, and plant biology that are within the skill of the art, many of which are described below for the purpose of illustration. Examples of such techniques are available in the literature.

All patents, patent applications, articles and publications mentioned herein, both supra and infra, are hereby expressly incorporated herein by reference in their entireties.

Unless defined otherwise herein, all technical and scientific terms used herein have the same meaning as commonly understood by one of ordinary skill in the art to which this disclosure belongs. Various scientific dictionaries that include the terms included herein are well known and available to those in the art. Although any methods and materials similar or equivalent to those described herein find use in the practice or testing of the disclosure, some preferred methods and materials are described. Accordingly, the terms defined immediately below are more fully described by reference to the specification as a whole. It is to be understood that this disclosure is not limited to the particular methodology, protocols, and reagents described, as these may vary, depending upon the context in which they are used by those of skill in the art.

As used herein, the singular terms “a”, “an”, and “the” include the plural reference unless the context clearly indicates otherwise.

Reference throughout this specification to, for example, “one embodiment”, “an embodiment”, “another embodiment”, “a particular embodiment”, “a related embodiment”, “a certain embodiment”, “an additional embodiment”, or “a further embodiment” or combinations thereof means that a particular feature, structure or characteristic described in connection with the embodiment is included in at least one embodiment of the present disclosure. Thus, the appearances of the foregoing phrases in various places throughout this specification are not necessarily all referring to the same embodiment. Furthermore, the particular features, structures, or characteristics may be combined in any suitable manner in one or more embodiments.

As used herein, the term “about” means a range of values including the specified value, which a person of ordinary skill in the art would consider reasonably similar to the specified value. In embodiments, the term “about” means within a standard deviation using measurements generally acceptable in the art. In embodiments, about means a range extending to +/−10% of the specified value. In embodiments, about means the specified value.

Throughout this specification, unless the context requires otherwise, the words “comprise”, “comprises” and “comprising” will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that no other elements are optional and may or may not be present depending upon whether or not they affect the activity or action of the listed elements.

As used herein, the terms “disease” or “condition” are used in accordance with its plain ordinary meaning and refer to a state of being or health status of a plant capable of being diagnosed and/or treated with compounds or methods provided herein. In embodiments, conditions include abiotic stress. In embodiments, conditions include biotic stress. Diseases include but are not limited to conditions caused by viruses, bacteria, fungus, insects, and combinations thereof.

As used herein, the term “abiotic stress” is used in accordance with its plain ordinary meaning and refers to the negative impact of non-living factors on the living organisms in a specific environment. Examples of abiotic stress in plants include drought, salinity, heat, cold, phosphate starvation, metal toxicity, and a combination thereof.

As used herein, the term “biotic stress” is used in accordance with its plain ordinary meaning and refers to living disturbances or the impact of living factors on the living organisms in a specific environment. Examples of biotic stress in plants include fingus, viral, bacterial, yeast, nematode, arachnid, or insect infection or infestations. Biotic stress may refer to infectious diseases that develop in harvested fruit that is caused by bacteria, fungi, or yeasts. Biotic stress may emerge from weeds among crops.

As used herein, the term “priming” or “plant priming” is used in accordance with its plain ordinary meaning and refers to a physiological process by which a plant prepares to more quickly or aggressively respond to future biotic or abiotic stress The condition of readiness achieved by priming has been termed the “primed state.” Priming may be initiated in response to an environmental cue that reliably indicates an increased probability of encountering a biotic or abiotic stress, but a primed state may also persist as a residual effect following an initial exposure to the stress. For example, the classic pathogen-induced hypersensitive response is often induced with greater efficiency in plants that have previously experienced pathogen attack. In the context of long-lived plants such as trees, a primed state may persist across multiple growing seasons, a phenomenon commonly referred to in the ecological literature as “delayed induced resistance”. Because priming initiates a state of readiness that does not confer resistance per se but rather allows for accelerated induced resistance once an attack occurs, one presumed benefit of priming is that it does not impose the costs associated with full implementation of an induced defense response.

As used herein, “biomarker” refers to a measureable indicator of the physiological state of a plant or seed. The biomarker may be one or more of specific cells, molecules, metabolites, or genes, gene products, proteins, enzymes, or hormones. For example, the presence of a biomarker may indicate that a plant is responding to biotic or abiotic stress.

As used herein, the term “prevent” is used in accordance with its plain ordinary meaning and refers to a decrease in the occurrence of disease symptoms in a plant. The prevention may be complete (no detectable symptoms) or partial, such that fewer symptoms are observed than would likely occur absent treatment. Symptoms include but are not limited to vulnerability to disease, vulnerability to pests, lower growth size, lower crop yield, and decreased seed viability.

As used herein, the term “agriculture composition” and “horticulture composition” are used in accordance with its plain ordinary meaning and refer to a composition used with agriculture crops including but not limited to vegetables, fruit, nuts, grains, and cotton and with horticulture, including flowers, house plants, and the like.

As used herein, the term “copper (II) sulfate pentahydrate” refers to a compound with the following chemical formulation: CuSO₄·5H₂O or CuSO₄·5H₂O or CuH₁₀O₉S. It is alternatively known as “copper sulfate pentahydrate”, “Blue vitriol”, and “cupric sulfate pentahydrate.” The amount of copper in the total compound is 25%.

As used herein, the term “zinc sulfate monohydrate” refers to a compound with the following chemical formulation ZnSO₄·H₂. It is alternatively known a “zinc sulfate hydrate”, “white vitriol” and “goslarite.” The amount of zinc in the total compound is 36%.

As used herein, the term “copper sulfate pentahydrate” or “copper (II) sulfate pentahydrate” refers to a compound with the chemical formulation CuSO₄·5H₂O. Copper sulfate pentahydrate may also be known as “blue vitriol”, “bluestone”, “vitriol of copper”, or “Roman vitriol”. The amount of copper in the total compound is 25%.

As used herein, the term “citric acid” refers to a compound with the chemical formulation C₆H₈O₇. When part of a salt, the formula of the citrate anion may be written as C₆H₅O³⁻₇ or C₃H₅O(COO)³⁻.

As used herein, the term “sulfuric acid” refers to a compound with the chemical formulation H₂SO₄. Sulfuric acid may be referred to as “oil of vitriol”.

As used herein, the term “oxalic acid” refers to a compound with the chemical formulation C₂H₂O₄. Oxalic acid may occur as the dihydrate with the chemical formula oxalic acid occurs as the dihydrate with the formula C₂H₂O₄·2H₂O.

As used herein, the term “humic acid” refers to a class of compounds extracted as colloidal particles from soil into strong basic solutions, and precipitated from the basic solution by adjusting the pH to 1 with acid. Typically, the acid is hydrochloric acid.

As used herein, the term “fulvic acid” refers to a class of organic acids which are naturally occurring in soil organic matter. A fulvic acid may have the chemical formulation C₁₃₅H₁₈₂O₉₅N₅S₂.

As used herein, the term “boric acid” refers to a compound with the chemical formulation H₃BO₃, which may also be written as B(OH)₃. Boric acid may also be referred to as “hydrogen borate”, “boracic acid”, or “orthoboric acid”.

As used herein, the term “acetic acid” refers to a compound with the chemical formulation CH₃COOH, which may also be written as CH₃CO₂H, C₂H₄O₂, or HC₂H₃O₂. Acetic acid may also be referred to as “ethanoic acid”.

As used herein, the term “ammonium sulfate” refers to a compound with the chemical formulation (NH₄)₂SO₄.

As used herein, the term “iron sulfate heptahydrate” or “iron (II) sulfate heptahydrate” refers to a compound with the chemical formulation FeSO₄·7H₂O. Iron sulfate heptahydrate may also be referred to as iron(II) sulphate or ferrous sulfate. Other salts of iron (II) sulfate exist, and are denoted by the formula FeSO₄·xH₂O.

As used herein, the term “calcium lignin sulfate” refers to a compound with the chemical formulation C₂₀H₂₄CaO₁₀S₂. Calcium lignin sulfate may also be referred to as “calcium lignosulfonate” or “lignosulfonic acid, calcium salt”. Calcium lignin sulfate may be utilized as an encapsulating agent for compositions (i.e. BAM-dry formulation).

Compounds described herein may be further described by their physical form. For example, the physical form may be granulation or particle size. For example, copper (II) sulfate pentahydrate may be referred to as large (approximate particle size 8-25 mm), medium (approximate particle size 4-8 mm), small (approximate particle size 1-4 mm), Fine 20 (approximate particle size 20-40 mesh), Fine 30 (approximate particle size 30-100 mesh), which have crystal appearance, Fine 100 (approximate particle size 60-200 mesh), which has a powder appearance, or Fine 200 (approximate particle size 60-325 mesh), which has a fine powder appearance.

As used herein, the term “effective amount” is used in accordance with its plain ordinary meaning and refers to an amount sufficient for a compound to accomplish a stated purpose relative to the absence of the compound (e.g. achieve the effect for which it is administered, treat a disease, reduce enzyme activity, increase enzyme activity, reduce a signaling pathway, or reduce one or more symptoms of a disease or condition). An example of an “effective amount” is an amount sufficient to contribute to the treatment, prevention, or reduction of a symptom or symptoms of a disease, which could also be referred to as a “therapeutically effective amount.” A “reduction” of a symptom or symptoms (and grammatical equivalents of this phrase) means decreasing of the severity or frequency of the symptom(s), or elimination of the symptom(s). A “prophylactically effective amount” of a drug is an amount of a drug that, when administered to a subject, will have the intended prophylactic effect, e.g., preventing or delaying the onset (or reoccurrence) of an injury, disease, pathology or condition, or reducing the likelihood of the onset (or reoccurrence) of an injury, disease, pathology, or condition, or their symptoms. The full prophylactic effect does not necessarily occur by administration of one dose, and may occur only after administration of a series of doses. Thus, a prophylactically effective amount may be administered in one or more administrations.

As used herein, the term “therapeutically effective amount” is used in accordance with its plain ordinary meaning and refers to that amount of the therapeutic agent sufficient to ameliorate the disorder, as described above. For example, for the given parameter, a therapeutically effective amount will show an increase or decrease of at least 5%, 10%, 15%, 20%, 25%, 40%, 50%, 60%, 75%, 80%, 90%, or at least 100%. Therapeutic efficacy can also be expressed as “-fold” increase or decrease. For example, a therapeutically effective amount can have at least a 1.2-fold, 1.5-fold, 2-fold, 5-fold, or more effect over a control.

Dosages may be varied depending upon the requirements of the plant species and the area being treated. The dose administered to a plant, in the context of the present disclosure, should be sufficient to effect a beneficial therapeutic response in the plant over time. The size of the dose also will be determined by the existence, nature, and extent of any adverse side-effects. Determination of the proper dosage for a particular situation is within the skill of the practitioner. Generally, treatment is initiated with smaller dosages which are less than the optimum dose of the compound. Thereafter, the dosage is increased by small increments until the optimum effect under circumstances is reached. Dosage amounts and intervals can be adjusted individually to provide levels of the administered compound effective for the particular indication being treated. This will provide a therapeutic regimen that is commensurate with the severity of the plant's disease state.

As used herein, the term “administering” is used in accordance with its plain ordinary meaning and refers to application of a formulation for treatment of a plant or crop. In embodiments described herein, administering includes applying a formulation described herein to a plant part. For example, formulations described herein may be in a dry powder form that may be reconstituted in liquid. The liquid may then be applied as a foliar spray for applying to plant leaves, stems, or roots. Alternatively, seeds may be soaked in the reconstituted formulation for an amount of time. In other embodiments, formulations described herein may be in a wet or liquid formulation and applied as a foliar spray directly onto the plant or diluted and applied as a drench to the soil.

As used herein, the term “foliar spray” is used in accordance with its plain ordinary meaning and refers to a specific technique of applying a formulation to the leaves of a plant.

As used herein, the term “soil drench” is used in accordance with its plain ordinary meaning and refers to a specific technique of applying a diluted chemical pesticide, herbicide, fungicide, or even fertilizer to a particular plant or tree, or to a specific group of plants, rather than the entire garden or crop.

As used herein, the term “co-administer” is used in accordance with its plain ordinary meaning and refers to composition described herein is administered at the same time, just prior to, or just after the administration of one or more additional compounds, formulations, or treatments. The compounds provided herein can be administered alone or can be co-administered to the plant. Co-administration is meant to include simultaneous or sequential administration of the compounds individually or in combination (more than one compound). Thus, the preparations can also be combined, when desired, with other active substances.

As used herein, the term “cell” is used in accordance with its plain ordinary meaning and refers to a cell carrying out metabolic or other function sufficient to preserve or replicate its genomic DNA. In embodiments, cells include eukaryotic plant cells. In embodiments, cells include prokaryotic cells that include but are not limited to bacteria.

As used herein, the term “control” and “control experiment” are used in accordance with its plain ordinary meaning and refer to an experiment in which the subjects or reagents of the experiment are treated as in a parallel experiment except for omission of a procedure, reagent, or variable of the experiment. In some instances, the control is used as a standard of comparison in evaluating experimental effects. In some embodiments, a control is the measurement of activity or effect in a plant in the absence of a compound as described herein (including embodiments and examples).

As used herein, the term “signaling pathway” is used in accordance with its plain ordinary meaning and refers to a series of interactions between cellular and optionally extra-cellular components (e.g. proteins, nucleic acids, small molecules, ions, lipids) that conveys a change in one component to one or more other components, which in turn may convey a change to additional components, which is optionally propagated to other signaling pathway components.

As used herein, the term “ROS” and “reactive oxygen species” are used in accordance with its plain ordinary meaning and refer to chemically reactive chemical species containing oxygen. Examples include peroxides, superoxide, hydroxyl radical, singlet oxygen, and alpha-oxygen. In a biological context, ROS are formed as a natural byproduct of the normal metabolism of oxygen and have important roles in cell signaling and homeostasis. However, during times of environmental stress (e.g., UV or heat exposure), ROS levels can increase dramatically. This may result in significant damage to cell structures. Cumulatively, this is known as oxidative stress. The production of ROS is strongly influenced by stress factor responses in plants, these factors that increase ROS production include drought, salinity, chilling, nutrient deficiency, metal toxicity and UV-B radiation. ROS may be generated by exogenous sources such as ionizing radiation.

As used herein, the term “phytohormone” or “plant hormone” are used in accordance with its plain ordinary meaning and refer to signal molecules produced within plants, that occur in extremely low concentrations. Plant hormones control all aspects of growth and development, from embryogenesis, the regulation of organ size, pathogen defense, stress tolerance and through to reproductive development. Unlike in animals (in which hormone production is restricted to specialized glands) each plant cell is capable of producing hormones

As used herein, the term “callose” is used in accordance with its plain ordinary meaning and refers to a polysaccharide in the form of beta-1,3-glucan with some beta-1,6-branches and it exists in the cell walls of a wide variety of higher plants. Callose is involved during a variety of processes in plant development and/or in response to multiple biotic and abiotic stresses.

As used herein, the terms “BRIX”, “degrees BRIX”, “BRIX content”, “° Bx”, and “° BRIX” are used in accordance with their plain ordinary meaning and refer to the sugar content of an aqueous solution. One degree Brix is 1 gram of sucrose in 100 grams of solution and represents the strength of the solution as percentage by mass. If the solution contains dissolved solids other than pure sucrose, then the ° Bx only approximates the dissolved solid content. The ° Bx is traditionally used in the wine, sugar, carbonated beverage, fruit juice, maple syrup and honey industries. Brix is used in the food industry for measuring the approximate amount of sugars in fruits, vegetables, juices, wine, soft drinks and in the starch and sugar manufacturing industry.

As used herein, the term “encapsulate” or “enclose” refers to surrounding something (i.e. a composition) on all sides, or confining something within a container. For example, BAM-FX or BAM-O may be enclosed within a capsule made of calcium lignin sulfate. Encapsulating may preserve active properties of the composition. Encapsulating may protect the composition from contaminants. Encapsulating may protect the surroundings from the composition.

### II. Compositions

In an aspect, provided herein are compositions including zinc, copper, and an acid, where the acid is selected from citric acid, sulfuric acid, oxalic acid, humic acid, fulvic acid, boric acid, acetic acid, and a combination thereof, and optionally ammonium sulfate, where the ratio of copper to zinc is between 1:2 and 1:20, and where the composition has plant priming activity.

In embodiments, the zinc is selected from zinc sulfate (ZnS), zinc chlorate (Zn(ClO₃)₂), zinc nitrate (Zn(NO₃)₂, zinc phosphate (Zn₃(PO₄)₂), zinc molybdate (ZnMoO₄), and salts or hydrates thereof. In embodiments, the composition includes zinc sulfate (ZnS). In embodiments, the composition includes zinc chlorate (Zn(ClO₃)₂). In embodiments, the composition includes zinc nitrate (Zn(NO₃)₂. In embodiments, the composition includes zinc phosphate (Zn₃(PO₄)₂). In embodiments, the composition includes zinc molybdate (ZnMoO₄). In embodiments, the composition includes zinc sulfate monohydrate (ZnSO₄·H₂O).

In embodiments, the copper is selected from copper (II) sulfate, copper (II) nitrate, copper (II) sulfide, cuprous chloride, cuprous bromide, and salts or hydrates thereof. In embodiments, the composition includes copper (II) sulfate. In embodiments, the composition includes copper (II) nitrate. In embodiments, the composition includes copper (II) sulfide. In embodiments, the composition includes cuprous chloride. In embodiments, the composition includes cuprous bromide. In embodiments, the composition includes copper (II) sulfate pentahydrate (CuSO₄·5H₂O).

In embodiments, the compositions further includes iron floride, iron chloride, iron bromide, iron sulfide, iron sulfate, and salts or hydrates thereof. In embodiments, the composition includes iron floride. In embodiments, the composition includes iron chloride. In embodiments, the composition includes iron bromide. In embodiments, the composition includes iron sulfide. In embodiments, the composition includes iron sulfate. In embodiments, the composition includes iron (II) sulfate heptahydrate (FeSO₄·7H₂O).

In embodiments, the ratio of copper to zinc is between 1:2 and 1:20, 1:3 and 1:20, 1:4 and 1:20, 1:5 and 1:20, 1:6 and 1:20, 1:7 and 1:20, 1:8 and 1:20, 1:9 and 1:20, 1:10 and 1:20, 1:11 and 1:20, 1:12 and 1:20, 1:13 and 1:20, 1:14 and 1:20, 1:15 and 1:20, 1:16 and 1:20, 1:17 and 1:20, 1:18 and 1:20, 1:19 and 1:20, 1:2 and 1:19, 1:3 and 1:19, 1:4 and 1:19, 1:5 and 1:19, 1:6 and 1:19, 1:7 and 1:19, 1:8 and 1:19, 1:9 and 1:219, 1:10 and 1:19, 1:11 and 1:19, 1:12 and 1:19, 1:13 and 1:19, 1:14 and 1:19, 1:15 and 1:19, 1:16 and 1:19, 1:17 and 1:19, 1:18 and 1:19, 1:2 and 1:18, 1:3 and 1:18, 1:4 and 1:18, 1:5 and 1:18, 1:6 and 1:18, 1:7 and 1:18, 1:8 and 1:18, 1:9 and 1:18, 1:10 and 1:18, 1:11 and 1:18, 1:12 and 1:18, 1:13 and 1:18, 1:14 and 1:18, 1:15 and 1:18, 1:16 and 1:18, 1:17 and 1:18, 1:2 and 1:17, 1:3 and 1:17, 1:4 and 1:17, 1:5 and 1:17, 1:6 and 1:17, 1:7 and 1:17, 1:8 and 1:17, 1:9 and 1:17, 1:10 and 1:17, 1:11 and 1:17, 1:12 and 1:17, 1:13 and 1:17, 1:14 and 1:17, 1:15 and 1:17, 1:16 and 1:17, 1:2 and 1:16, 1:3 and 1:16, 1:4 and 1:16, 1:5 and 1:16, 1:6 and 1:16, 1:7 and 1:16, 1:8 and 1:16, 1:9 and 1:16, 1:10 and 1:16, 1:11 and 1:16, 1:12 and 1:16, 1:13 and 1:16, 1:14 and 1:16, 1:15 and 1:16, 1:2 and 1:15, 1:3 and 1:15, 1:4 and 1:15, 1:5 and 1:15, 1:6 and 1:15, 1:7 and 1:15, 1:8 and 1:15, 1:9 and 1:15, 1:10 and 1:15, 1:11 and 1:15, 1:12 and 1:15, 1:13 and 1:15, 1:14 and 1:15, 1:2 and 1:14, 1:3 and 1:14, 1:4 and 1:14, 1:5 and 1:14, 1:6 and 1:14, 1:7 and 1:14, 1:8 and 1:14, 1:9 and 1:14, 1:10 and 1:14, 1:11 and 1:14, 1:12 and 1:14, 1:13 and 1:14, 1:2 and 1:213, 1:3 and 1:13, 1:4 and 1:13, 1:5 and 1:13, 1:6 and 1:13, 1:7 and 1:13, 1:8 and 1:13, 1:9 and 1:13, 1:10 and 1:13, 1:11 and 1:13, 1:12 and 1:13, 1:2 and 1:12, 1:3 and 1:12, 1:4 and 1:12, 1:5 and 1:12, 1:6 and 1:12, 1:7 and 1:12, 1:8 and 1:12, 1:9 and 1:12, 1:10 and 1:12, 1:11 and 1:12, 1:2 and 1:11, 1:3 and 1:11, 1:4 and 1:11, 1:5 and 1:11, 1:6 and 1:11, 1:7 and 1:11, 1:8 and 1:11, 1:9 and 1:11, 1:10 and 1:11, 1:2 and 1:10, 1:3 and 1:10, 1:4 and 1:10, 1:5 and 1:10, 1:6 and 1:10, 1:7 and 1:10, 1:8 and 1:10, 1:9 and 1:10, 1:2 and 1:9, 1:3 and 1:29, 1:4 and 1:9, 1:5 and 1:9, 1:6 and 1:9, 1:7 and 1:9, 1:8 and 1:9, 1:2 and 1:8, 1:3 and 1:28, 1:4 and 1:8, 1:5 and 1:8, 1:6 and 1:8, 1:7 and 1:8, 1:2 and 1:7, 1:3 and 1:7, 1:4 and 1:27, 1:5 and 1:7, 1:6 and 1:7, 1:2 and 1:6, 1:3 and 1:6, 1:4 and 1:6, 1:5 and 1:6, 1:2 and 1:5, 1:3 and 1:5, 1:4 and 1:5, 1:2 and 1:4, 1:3 and 1:4, or 1:2 and 1:3.

In embodiments, the ratio copper to zinc is 1:3. In embodiments, the ratio copper to zinc is 1:5. In embodiments, the ratio copper to zinc is 1:10.

In embodiments, the composition includes an acid where the acid is in solid form. In embodiments, the composition includes an acid where the acid is in liquid form. In embodiments, the composition includes an acid salt.

In embodiments, the composition includes an acid where the acid is between about 0.1% and 20% of the total weight of the composition. In embodiments, the composition includes an acid between about 0.1% and 19%, about 0.1% and 18%, about 0.1% and 17%, about 0.1% and 16%, about 0.1% and 15%, about 0.1% and 14%, about 0.1% and 13%, about 0.1% and 12%, about 0.1% and 11%, about 0.1% and 10%, about 0.1% and 9%, about 0.1% and 8%, about 0.1% and 7%, about 0.1% and 6%, about 0.1% and 5%, about 0.1% and 4%, about 0.1% and 3%, about 0.1% and 2%, about 0.1% and 1%, about 0.2% and 19%, about 0.2% and 18%, about 0.2% and 17%, about 0.2% and 16%, about 0.2% and 15%, about 0.2% and 14%, about 0.2% and 13%, about 0.2% and 12%, about 0.2% and 11%, about 0.2% and 10%, about 0.2% and 9%, about 0.2% and 8%, about 0.2% and 7%, about 0.2% and 6%, about 0.2% and 5%, about 0.2% and 4%, about 0.2% and 3%, about 0.2% and 2%, about 0.2% and 1%, about 0.3% and 19%, about 0.3% and 18%, about 0.3% and 17%, about 0.3% and 16%, about 0.3% and 15%, about 0.3% and 14%, about 0.3% and 13%, about 0.3% and 12%, about 0.3% and 11%, about 0.3% and 10%, about 0.3% and 9%, about 0.3% and 8%, about 0.3% and 7%, about 0.3% and 6%, about 0.3% and 5%, about 0.3% and 4%, about 0.3% and 3%, about 0.3% and 2%, about 0.3% and 1%, about 0.4% and 19%, about 0.4% and 18%, about 0.4% and 17%, about 0.4% and 16%, about 0.4% and 15%, about 0.4% and 14%, about 0.4% and 13%, about 0.4% and 12%, about 0.4% and 11%, about 0.4% and 10%, about 0.4% and 9%, about 0.4% and 8%, about 0.4% and 7%, about 0.4% and 6%, about 0.4% and 5%, about 0.4% and 4%, about 0.4% and 3%, about 0.4% and 2%, about 0.4% and 1%, about 0.5% and 19%, about 0.5% and 18%, about 0.5% and 17%, about 0.5% and 16%, about 0.5% and 15%, about 0.5% and 14%, about 0.5% and 13%, about 0.5% and 12%, about 0.5% and 11%, about 0.5% and 10%, about 0.5% and 9%, about 0.5% and 8%, about 0.5% and 7%, about 0.5% and 6%, about 0.5% and 5%, about 0.5% and 4%, about 0.5% and 3%, about 0.5% and 2%, about 0.5% and 1%, about 0.6% and 19%, about 0.6% and 18%, about 0.6% and 17%, about 0.6% and 16%, about 0.6% and 15%, about 0.6% and 14%, about 0.6% and 13%, about 0.6% and 12%, about 0.6% and 11%, about 0.6% and 10%, about 0.6% and 9%, about 0.6% and 8%, about 0.6% and 7%, about 0.16% and 6%, about 0.6% and 5%, about 0.6% and 4%, about 0.6% and 3%, about 0.6% and 2%, about 0.6% and 1%, about 0.7% and 19%, about 0.7% and 18%, about 0.7% and 17%, about 0.7% and 16%, about 0.7% and 15%, about 0.7% and 14%, about 0.7% and 13%, about 0.7% and 12%, about 0.7% and 11%, about 0.7% and 10%, about 0.7% and 9%, about 0.7% and 8%, about 0.7% and 7%, about 0.7% and 6%, about 0.7% and 5%, about 0.7% and 4%, about 0.7% and 3%, about 0.7% and 2%, about 0.7% and 1%, about 0.8% and 19%, about 0.8% and 18%, about 0.8% and 17%, about 0.8% and 16%, about 0.8% and 15%, about 0.8% and 14%, about 0.8% and 13%, about 0.8% and 12%, about 0.8% and 11%, about 0.8% and 10%, about 0.8% and 9%, about 0.8% and 8%, about 0.8% and 7%, about 0.8% and 6%, about 0.8% and 5%, about 0.8% and 4%, about 0.8% and 3%, about 0.8% and 2%, about 0.8% and 1%, about 0.9% and 19%, about 0.9% and 18%, about 0.9% and 17%, about 0.9% and 16%, about 0.9% and 15%, about 0.9% and 14%, about 0.9% and 13%, about 0.9% and 12%, about 0.9% and 11%, about 0.9% and 10%, about 0.9% and 9%, about 0.9% and 8%, about 0.9% and 7%, about 0.9% and 6%, about 0.9% and 5%, about 0.9% and 4%, about 0.9% and 3%, about 0.9% and 2%, about 0.9% and 1%, about 1% and 19%, about 1% and 18%, about 1% and 17%, about 1% and 16%, about 1% and 15%, about 1% and 14%, about 1% and 13%, about 1% and 12%, about 1% and 11%, about 1% and 10%, about 1% and 9%, about 1% and 8%, about 1% and 7%, about 1% and 6%, about 1% and 5%, about 1% and 4%, about 1% and 3%, about 1% and 2%, about 2% and 19%, about 2% and 18%, about 2% and 17%, about 2% and 16%, about 2% and 15%, about 2% and 14%, about 2% and 13%, about 2% and 12%, about 2% and 11%, about 2% and 10%, about 2% and 9%, about 2% and 8%, about 2% and 7%, about 2% and 6%, about 2% and 5%, about 2% and 4%, about 2% and 3%, about 3% and 19%, about 3% and 18%, about 3% and 17%, about 3% and 16%, about 3% and 15%, about 3% and 14%, about 3% and 13%, about 3% and 12%, about 3% and 11%, about 3% and 10%, about 3% and 9%, about 3% and 8%, about 3% and 7%, about 3% and 6%, about 3% and 5%, about 3% and 4%, about 4% and 19%, about 4% and 18%, about 4% and 17%, about 4% and 16%, about 4% and 15%, about 4% and 14%, about 4% and 13%, about 3% and 12%, about 4% and 11%, about 4% and 10%, about 4% and 9%, about 4% and 8%, about 4% and 7%, about 4% and 6%, about 4% and 5%, about 5% and 19%, about 5% and 18%, about 5% and 17%, about 5% and 16%, about 5% and 15%, about 5% and 14%, about 5% and 13%, about 5% and 12%, about 5% and 11%, about 5% and 10%, about 5% and 9%, about 5% and 8%, about 5% and 7%, about 5% and 6%, about 6% and 19%, about 6% and 18%, about 6% and 17%, about 6% and 16%, about 6% and 15%, about 6% and 14%, about 6% and 13%, about 6% and 12%, about 6% and 11%, about 6% and 10%, about 6% and 9%, about 6% and 8%, about 6% and 7%, about 7% and 19%, about 7% and 18%, about 7% and 17%, about 7% and 16%, about 7% and 15%, about 7% and 14%, about 7% and 13%, about 7% and 12%, about 7% and 11%, about 7% and 10%, about 7% and 9%, about 7% and 8%, about 8% and 19%, about 8% and 18%, about 8% and 17%, about 8% and 16%, about 8% and 15%, about 8% and 14%, about 8% and 13%, about 8% and 12%, about 8% and 11%, about 8% and 10%, about 8% and 9%, about 9% and 19%, about 9% and 18%, about 9% and 17%, about 9% and 16%, about 9% and 15%, about 9% and 14%, about 9% and 13%, about 9% and 12%, about 9% and 11%, about 9% and 10%, about 10% and 19%, about 10% and 18%, about 10% and 17%, about 10% and 16%, about 10% and 15%, about 10% and 14%, about 10% and 13%, about 10% and 12%, about 10% and 11%, about 11% and 19%, about 11% and 18%, about 11% and 17%, about 11% and 16%, about 11% and 15%, about 11% and 14%, about 11% and 13%, about 11% and 12%, about 12% and 19%, about 12% and 18%, about 12% and 17%, about 12% and 16%, about 12% and 15%, about 12% and 14%, about 12% and 13%, about 13% and 19%, about 13% and 18%, about 13% and 17%, about 13% and 16%, about 13% and 15%, about 13% and 14%, about 14% and 19%, about 14% and 18%, about 14% and 17%, about 14% and 16%, about 14% and 15%, about 15% and 19%, about 15% and 18%, about 15% and 17%, about 15% and 16%, about 16% and 19%, about 16% and 18%, about 16% and 17%, about 17% and 19%, about 17% and 18%, and about 18% and 19% of the total weight of the composition.

In embodiments, the composition includes about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% acid.

In embodiments, the compositions include acid selected from citric acid, sulfuric acid, oxalic acid, humic acid, fulvic acid, boric acid, acetic acid, and a combination thereof. In embodiments, the compositions include citric acid. In embodiments, the compositions include sulfuric acid. In embodiments, the compositions include oxalic acid. In embodiments, the compositions include humic acid. In embodiments, the compositions include fulvic acid. In embodiments, the compositions include boric acid. In embodiments, the compositions include acetic acid. In embodiments, the composition includes a combination of citric acid, oxalic acid, humic acid, fulvic acid, boric acid, and/or acetic acid. In embodiments, the composition includes a combination of citric acid and oxalic acid. In embodiments, the composition includes a combination of citric acid and humic acid. In embodiments, the composition includes a combination of citric acid and fulvic acid. In embodiments, the composition includes a combination of citric acid and boric acid. In embodiments, the composition includes a combination of citric acid and acetic acid. In embodiments, the composition includes a combination of oxalic acid and humic acid. In embodiments, the composition includes a combination of oxalic acid and fulvic acid. In embodiments, the composition includes a combination of oxalic acid and boric acid. In embodiments, the composition includes a combination of oxalic acid and acetic acid. In embodiments, the composition includes a combination of humic acid and fulvic acid. In embodiments, the composition includes a combination of humic acid and boric acid. In embodiments, the composition includes a combination of humic acid and acetic acid. In embodiments, the composition includes a combination of fulvic acid and boric acid. In embodiments, the composition includes a combination of fulvic acid and acetic acid. In embodiments, the composition includes a combination of boric acid and acetic acid.

In embodiments, the composition includes about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% sulfuric acid. In embodiments, the composition includes 0.2% to about 5% sulfuric acid. In embodiments, the composition includes 0.2% sulfuric acid. In embodiments, the composition includes 5% sulfuric acid.

In embodiments, the composition includes about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% citric acid. In embodiments, the composition includes 5% citric acid. In embodiments, the composition includes 10% citric acid.

In embodiments, the composition includes about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% fulvic acid. In embodiments, the composition includes 1% fulvic acid. In embodiments, the composition includes 5% fulvic acid.

In embodiments, the composition includes about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% boric acid. In embodiments, the composition includes 0.1% boric acid. In embodiments, the composition includes 1% boric acid.

In embodiments, the composition includes ammonium sulfate. In embodiments, the composition includes about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% includes ammonium sulfate. In embodiments, the composition includes about 0.5% to about 5% ammonium sulfate. In embodiments, the composition includes about 0.6% ammonium sulfate.

In embodiments, the compositions include zinc sulfate monohydrate (ZnSO₄·H₂O), copper (II) sulfate pentahydrate (CuSO₄·5H₂O), and citric acid. In specific embodiments, the compositions include zinc sulfate monohydrate (ZnSO₄·H₂O), copper (II) sulfate pentahydrate (CuSO₄·5H₂O), and 10% (by weight) citric acid and where the copper to zinc ratio is 1:5.

In embodiments, the compositions include zinc sulfate monohydrate (ZnSO₄·H₂O), copper (II) sulfate pentahydrate (CuSO₄·5H₂O), sulfuric acid, and ammonium sulfate. In specific embodiments, the compositions include zinc sulfate monohydrate (ZnSO₄·H₂O), copper (II) sulfate pentahydrate (CuSO₄·5H₂O), 0.2% (by weight) sulfuric acid, 0.6% ammonium sulfate, and where the copper to zinc ratio is 1:5.

In embodiments, the compositions include zinc sulfate monohydrate (ZnSO₄·H₂O), copper (II) sulfate pentahydrate (CuSO₄·5H₂O), sulfuric acid, and ammonium sulfate. In specific embodiments, the compositions include zinc sulfate monohydrate (ZnSO₄·H₂O), copper (II) sulfate pentahydrate (CuSO₄·5H₂O), 5% (by weight) sulfuric acid, 0.6% ammonium sulfate, and where the copper to zinc ratio is 1:5.

In embodiments, compositions that include an acid other than sulfuric acid can include additional actives such as iron.

In embodiments, the compositions do not include ammonium sulfate.

In embodiments, the compositions described herein further include a binding agent. In embodiments, the compositions described herein further include a binding agent is selected from molasses, gum, native starch, and modified starch. In embodiments, the binding agent is molasses. In embodiments, the binding agent is gum. In embodiments, the binding agent is native starch. In embodiments, the binding agent is modified starch.

Compositions as described have a number of effects on plants including: expression of plant priming biomarkers; enhanced biomass and root system; resistance to biotic and abiotic stress; increased flowering and product yield; longer shelf life for cut flowers; increase in germination rate; and improvements in product quality.

### III. Methods of Manufacture

In an aspect, provided herein are compositions including zinc, copper, and an acid, where the acid is selected from citric acid, sulfuric acid, oxalic acid, humic acid, fulvic acid, boric acid, acetic acid, and a combination thereof, where the ratio of copper to zinc is between 1:2 and 1:20, and where the composition is formulated as a dry powder. In embodiments, the compositions further include ammonium sulfate. In embodiments, the compositions do not include ammonium sulfate.

In embodiments, provided herein are compositions including zinc, copper, sulfuric acid, and optionally ammonium sulfate, where the ratio of copper to zinc is between 1:2 and 1:20, and where the composition is formulated as a dry powder.

In an aspect, provided herein are compositions including zinc, copper, and an acid, where the acid is selected from citric acid, sulfuric acid, oxalic acid, humic acid, fulvic acid, boric acid, acetic acid, and a combination thereof, where the ratio of copper to zinc is between 1:2 and 1:20, and where the composition is formulated as a foliar spray.

In an aspect, provided herein are compositions zinc sulfate monohydrate (ZnSO₄·H₂O), copper (II) sulfate pentahydrate (CuSO₄·5H₂O), and an acid, where the acid is selected from citric acid, sulfuric acid, oxalic acid, humic acid, fulvic acid, boric acid, acetic acid, and a combination thereof, where the ratio of copper to zinc is between 1:2 and 1:20, and where the composition is formulated as a dry powder. In embodiments, the acid is a solid acid or salt thereof.

In an aspect, provided herein are compositions zinc sulfate monohydrate (ZnSO₄·H₂O), copper (II) sulfate pentahydrate (CuSO₄·5H₂O), and an acid, where the acid is selected from citric acid, sulfuric acid, oxalic acid, humic acid, fulvic acid, boric acid, acetic acid, and a combination thereof, where the ratio of copper to zinc is between 1:2 and 1:20, and where the composition is formulated as a foliar spray.

In embodiments, the compositions are formulated as a dry powder. In embodiments, the dry formulation of compositions described herein can be manufactured, for example, by weighing the ingredients, grinding, and mixing to a defined particle size. For example, manufacturing of a dry formulation may be made by weighing 16 kilograms of zinc sulfate monohydrate (granular), 4 kilograms copper sulfate pentahydrate (Fine 30 form), and 5 kilograms of citric acid, anhydrous (Fine granular). The expected output is 25 kilograms. The ingredients are mixed and grinded with a 40-60 Mesh/400-250 μm. The ratio of copper to zinc is 1:5.7 (1 copper to 5.7 zinc). This dry formulation may be referred to herein as BAM-dry or BAM-dry formulation.

In embodiments, the defined particle size is about 150 μm to about 500 μm. In embodiments, the defined particle size is about 200 μm to about 500 μm. In embodiments, the defined particle size is about 250 μm to about 500 μm. In embodiments, the defined particle size is about 300 μm to about 500 μm. In embodiments, the defined particle size is about 350 μm to about 500 μm. In embodiments, the defined particle size is about 400 μm to about 500 μm.

In embodiments, the defined particle size is about 150 μm to about 450 μm. In embodiments, the defined particle size is about 150 μm to about 400 μm. In embodiments, the defined particle size is about 150 μm to about 400 μm. In embodiments, the defined particle size is about 150 μm to about 350 μm. In embodiments, the defined particle size is about 150 μm to about 300 μm. In embodiments, the defined particle size is about 150 μm to about 250 μm. In embodiments, the defined particle size is about 500 μm, about 450 μm, about 400 μm, about 350 μm, about 300 μm, about 250 μm, about 200 μm or about 150 μm.

In embodiments, the dry formulation is encapsulated. In embodiments, the encapsulation comprises calcium lignin sulfate. In embodiments, the dry formulation is further processed to be encased or encapsulated in about 1 to about 20% calcium lignin sulfate. This may shield or inhibit the corrosive properties of the dry formulation during handling and/or transport. In embodiments, the dry formulation is encapsulated in 1%, 2%, 3%, 4%, 5%, 6%, 7%, 8%, 9%, 10%, 11%, 12%, 13%, 14%, 15%, 16%, 17%, 18%, 19%, or 20% calcium lignin sulfate. In embodiments, the dry formulation is encapsulated in 1% calcium lignin sulfate. In embodiments, the dry formulation is encapsulated in 2% calcium lignin sulfate. In embodiments, the dry formulation is encapsulated in 3% calcium lignin sulfate. In embodiments, the dry formulation is encapsulated in 4% calcium lignin sulfate. In embodiments, the dry formulation is encapsulated in 5% calcium lignin sulfate. In embodiments, the dry formulation is encapsulated in 6% calcium lignin sulfate. In embodiments, the dry formulation is encapsulated in 7% calcium lignin sulfate. In embodiments, the dry formulation is encapsulated in 8% calcium lignin sulfate. In embodiments, the dry formulation is encapsulated in 9% calcium lignin sulfate. In embodiments, the dry formulation is encapsulated in 10% calcium lignin sulfate. In embodiments, the dry formulation is encapsulated in 11% calcium lignin sulfate. In embodiments, the dry formulation is encapsulated in 12% calcium lignin sulfate. In embodiments, the dry formulation is encapsulated in 13% calcium lignin sulfate. In embodiments, the dry formulation is encapsulated in 14% calcium lignin sulfate. In embodiments, the dry formulation is encapsulated in 15% calcium lignin sulfate. In embodiments, the dry formulation is encapsulated in 16% calcium lignin sulfate. In embodiments, the dry formulation is encapsulated in 17% calcium lignin sulfate. In embodiments, the dry formulation is encapsulated in 18% calcium lignin sulfate. In embodiments, the dry formulation is encapsulated in 19% calcium lignin sulfate. In embodiments, the dry formulation is encapsulated in 20% calcium lignin sulfate.

In embodiments, the compositions are formulated as a liquid or wet formulation. Liquid formulations may be referred to herein as BAM-FX or BAM-0, depending on the acid used and/or presence of ammonium sulfate. In embodiments, BAM-FX refers to liquid formulations that include sulfuric acid and/or ammonium sulfate. In embodiments, BAM-FX refers to liquid formulations that include sulfuric acid. In embodiments, BAM-FX refers to liquid formulations that include ammonium sulfate. In embodiments, BAM-O refers to liquid formulations that do not include sulfuric acid and/or ammonium sulfate. In embodiments, BAM-O refers to liquid formulations that do not include sulfuric acid. In embodiments, BAM-O refers to liquid formulations that do not include ammonium sulfate. In embodiments, BAM-O refers to liquid formulations that include organic acid.

In embodiments, a liquid formulation of compositions described herein can be manufactured, for example, by providing water at about 95° F., adding ammonium sulfate and then sulfuric acid (at a concentration of 10-90%) and air agitate for a sufficient time until mixing is complete; then, slowly adding zinc sulfate monohydrate (granular), and allowing the temperature to rise to about 115-125° F.; next, air agitating the mixture thoroughly until the solution is homogenous; then adding copper sulfate pentahydrate (Fine 30) and air agitating thoroughly. The final concentration of ammonium sulfate is about 0.1% to about 0.6% and the final concentration of sulfuric acid is about 0.2% to about 5%. Additional mixing time may be required.

In embodiments, methods of making liquid formulation of compositions described herein include providing water at about 75° F., 76° F., 77° F., 78° F., 79° F., 80° F., 81° F., 82° F., 83° F., 84° F., 85° F., 86° F., 87° F., 88° F., 89° F., 90° F., 91° F., 92° F., 93° F., 94° F., 95° F., 96° F., 97° F., 98° F., 99° F., 100° F., 101° F., 102° F., 103° F., 104° F., 105° F., 106° F., 107° F., 108° F., 109° F., 110° F., 111° F., 112° F., 113° F., 114° F., 115° F., 116° F., 117° F., 118° F., 119° F., or 120F. In embodiments, methods of making liquid formulation of compositions described herein include providing water at about 75° F. In embodiments, methods of making liquid formulation of compositions described herein include providing water at about 76° F. In embodiments, methods of making liquid formulation of compositions described herein include providing water at about 77° F. In embodiments, methods of making liquid formulation of compositions described herein include providing water at about 78° F. In embodiments, methods of making liquid formulation of compositions described herein include providing water at about 79° F. In embodiments, methods of making liquid formulation of compositions described herein include providing water at about 80° F. In embodiments, methods of making liquid formulation of compositions described herein include providing water at about 81° F. In embodiments, methods of making liquid formulation of compositions described herein include providing water at about 82° F. In embodiments, methods of making liquid formulation of compositions described herein include providing water at about 83° F. In embodiments, methods of making liquid formulation of compositions described herein include providing water at about 84° F. In embodiments, methods of making liquid formulation of compositions described herein include providing water at about 85° F. In embodiments, methods of making liquid formulation of compositions described herein include providing water at about 86° F. In embodiments, methods of making liquid formulation of compositions described herein include providing water at about 87° F. In embodiments, methods of making liquid formulation of compositions described herein include providing water at about 88° F. In embodiments, methods of making liquid formulation of compositions described herein include providing water at about 89° F. In embodiments, methods of making liquid formulation of compositions described herein include providing water at about 90° F. In embodiments, methods of making liquid formulation of compositions described herein include providing water at about 91° F. In embodiments, methods of making liquid formulation of compositions described herein include providing water at about 92° F. In embodiments, methods of making liquid formulation of compositions described herein include providing water at about 93° F. In embodiments, methods of making liquid formulation of compositions described herein include providing water at about 94° F. In embodiments, methods of making liquid formulation of compositions described herein include providing water at about 95° F. In embodiments, methods of making liquid formulation of compositions described herein include providing water at about 96° F. In embodiments, methods of making liquid formulation of compositions described herein include providing water at about 97° F. In embodiments, methods of making liquid formulation of compositions described herein include providing water at about 98° F. In embodiments, methods of making liquid formulation of compositions described herein include providing water at about 99° F. In embodiments, methods of making liquid formulation of compositions described herein include providing water at about 100° F. In embodiments, methods of making liquid formulation of compositions described herein include providing water at about 101° F. In embodiments, methods of making liquid formulation of compositions described herein include providing water at about 102° F. In embodiments, methods of making liquid formulation of compositions described herein include providing water at about 103° F. In embodiments, methods of making liquid formulation of compositions described herein include providing water at about 104° F. In embodiments, methods of making liquid formulation of compositions described herein include providing water at about 105° F. In embodiments, methods of making liquid formulation of compositions described herein include providing water at about 106° F. In embodiments, methods of making liquid formulation of compositions described herein include providing water at about 107° F. In embodiments, methods of making liquid formulation of compositions described herein include providing water at about 108° F. In embodiments, methods of making liquid formulation of compositions described herein include providing water at about 109° F. In embodiments, methods of making liquid formulation of compositions described herein include providing water at about 110° F. In embodiments, methods of making liquid formulation of compositions described herein include providing water at about 111° F. In embodiments, methods of making liquid formulation of compositions described herein include providing water at about 112° F. In embodiments, methods of making liquid formulation of compositions described herein include providing water at about 113° F. In embodiments, methods of making liquid formulation of compositions described herein include providing water at about 114° F. In embodiments, methods of making liquid formulation of compositions described herein include providing water at about 115° F. In embodiments, methods of making liquid formulation of compositions described herein include providing water at about 116° F. In embodiments, methods of making liquid formulation of compositions described herein include providing water at about 117° F. In embodiments, methods of making liquid formulation of compositions described herein include providing water at about 118° F. In embodiments, methods of making liquid formulation of compositions described herein include providing water at about 119° F. In embodiments, methods of making liquid formulation of compositions described herein include providing water at about 120° F.

In embodiments, methods of making a liquid formulation of compositions described herein include slowly adding zinc sulfate monohydrate (granular), and allowing the temperature to rise to about 100-125° F., about 111-125° F., about 112-125° F., about 113-125° F., about 114-125° F., about 115-125° F., about 116-125° F., about 117-125° F., about 118-125° F., about 119-125° F., about 120-125° F., about 121-125° F., about 122-125° F., about 123-125° F., about 124-125° F., about 110-135° F., about 110-134° F., about 110-133° F., about 110-132° F., about 110-131° F., about 110-130° F., about 110-129° F., about 110-128° F., about 110-127° F., or about 110-126° F. In embodiments, methods of making liquid formulation of compositions described herein include slowly adding zinc sulfate monohydrate (granular), and allowing the temperature to rise to about 100° F., about 101° F., about 102° F., about 103° F., about 104° F., about 105° F., about 106° F., about 107° F., about 108° F., about 109° F., about 110° F., about 111° F., about 112° F., about 113° F., about 114° F., about 115° F., about 116° F., about 117° F., about 118° F., about 119° F., about 120° F., about 121° F., about 122° F., about 123° F., about 124° F., about 125° F., about 126° F., about 127° F., about 128° F., about 129° F., 130° F., about 131° F., about 132° F., about 133° F., about 134° F., or about 135° F.

### IV. Methods of Use

In an aspect, provided herein are methods of reducing cellular damage to a plant including treating the plant with a composition including zinc, copper, and acid, where the acid is selected from citric acid, sulfuric acid, oxalic acid, humic acid, fulvic acid, boric acid, acetic acid, and a combination thereof, and optionally ammonium sulfate, and where the ratio of copper to zinc is between 1:2 and 1:20.

In embodiments, cellular damage includes one or more of destructive protein modifications, mutagenic DNA strand breaks, purine oxidation, protein-DNA crosslinks, membrane leakage, cell lysis, and a combination thereof. In embodiments, the cellular damage is caused by reactive oxygen species. In embodiments, cellular damage includes destructive protein modifications. In embodiments, cellular damage includes mutagenic DNA strand breaks. In embodiments, cellular damage includes purine oxidation. In embodiments, cellular damage includes protein-DNA crosslinks. In embodiments, cellular damage includes membrane leakage. In embodiments, cellular damage includes cell lysis. In embodiments, cellular damage includes a combination of one or more of destructive protein modifications, mutagenic DNA strand breaks, purine oxidation, protein-DNA crosslinks, membrane leakage, and cell lysis. In embodiments, the cellular damage is caused by reactive oxygen species.

In embodiments, methods of reducing cellular damage to a plant include treating the plant with a composition as described herein and where the cellular damage is destructive protein modifications. In embodiments, methods of reducing cellular damage to a plant include treating the plant with a composition as described herein and the cellular damage is mutagenic DNA strand breaks. In embodiments, methods of reducing cellular damage to a plant include treating the plant with a composition as described herein and the cellular damage is purine oxidation. In embodiments, methods of reducing cellular damage to a plant include treating the plant with a composition as described herein and the cellular damage is protein-DNA crosslinks. In embodiments, methods of reducing cellular damage to a plant include treating the plant with a composition as described herein and the cellular damage is membrane leakage. In embodiments, methods of reducing cellular damage to a plant include treating the plant with a composition as described herein and the cellular damage is cell lysis. In embodiments, methods of reducing cellular damage to a plant include treating the plant with a composition as described herein and the cellular damage is a combination of one or more of destructive protein modifications, mutagenic DNA strand breaks, purine oxidations, protein-DNA cross links, membrane leakage, and cell lysis.

In embodiments, methods of reducing cellular damage to a plant include treating the plant with a composition as described herein. In embodiments, methods of reducing cellular damage to a plant including treating the plant with a composition including zinc sulfate monohydrate (ZnSO₄·H₂O), copper (II) sulfate pentahydrate (CuSO₄·5H₂O), and 10% (by weight) citric acid and where the copper to zinc ratio is 1:5.

In embodiments, methods of reducing cellular damage to a plant include induction of direct and/or indirect plant pathways for reducing cellular damage. In embodiments, the compositions described herein when applied to a plant surface including seeds, roots, leaves, and/or stems, prepares the plant for reducing cellular damage. Such preparation includes modulating gene expression, signaling pathways, and/or ion channels as required for reducing cellular damage. Examples of methods by which plants reduce cellular damage include reducing reactive oxygen species, increasing reactive species scavenging mechanisms, and production or increase of antioxidants.

In an aspect, provided herein are methods of priming a plant against abiotic stress factors including treating the plant with a composition including zinc, copper, and acid, where the acid is selected from citric acid, sulfuric acid, oxalic acid, humic acid, fulvic acid, boric acid, acetic acid, and a combination thereof, and optionally ammonium sulfate, and where the ratio of copper to zinc is between 1:2 and 1:20.

In embodiments, provided herein are methods of priming a plant against abiotic stress factors including drought, salinity, heat, cold, phosphate starvation, metal toxicity, and a combination thereof. In embodiments, the abiotic stress factor is drought salinity. In embodiments, the abiotic stress factor is heat. In embodiments, the abiotic stress factor is cold. In embodiments, the abiotic stress factor is phosphate starvation. In embodiments, the abiotic stress factor is metal toxicity. In embodiments, the abiotic stress factor is a combination of one or more of drought, salinity, heat, cold, phosphate starvation, and metal toxicity.

In embodiments, methods of priming a plant against abiotic stress factors include treating the plant with a composition as described herein. In embodiments, methods of priming a plant against abiotic stress factors include treating the plant with a composition including zinc sulfate monohydrate (ZnSO₄·H₂O), copper (II) sulfate pentahydrate (CuSO₄·5H₂O), and 10% (by weight) citric acid and where the copper to zinc ratio is 1:5.

In embodiments, methods of priming against abiotic stress include induction of direct and/or indirect plant defenses. In embodiments, the compositions described herein when applied to a plant surface including seeds, roots, leaves, and/or stems, prepares the plant for defense against an abiotic stress. Such preparation includes modulating gene expression, signaling pathways, and/or ion channels as required for the particular abiotic stress.

In an aspect, provided herein are methods of promoting growth of a plant including treating the plant with a composition including zinc, copper, and acid, wherein the acid is selected from citric acid, sulfuric acid, oxalic acid, humic acid, fulvic acid, boric acid, acetic acid, and a combination thereof, and optionally ammonium sulfate, and where the ratio of copper to zinc is between 1:2 and 1:20.

In embodiments, growth of a plant includes increase in yield, size, and/or weight of the plant, fruit, seed, nut, and/or flower. In embodiments, growth of a plant includes increase in yield of fruit, seed, nuts, or flower. In embodiments, growth of a plant includes increase in yield of fruit. In embodiments, growth of a plant includes increase in yield of seed. In embodiments, growth of a plant includes increase in yield of nuts. In embodiments, growth of a plant includes increase in yield of flower. In embodiments, growth of a plant includes increase in size of a plant, fruit, seed, nuts, or flower. In embodiments, growth of a plant includes increase in size of a plant. In embodiments, growth of a plant includes increase in size of fruit. In embodiments, growth of a plant includes increase in size of a seed. In embodiments, growth of a plant includes increase in size of a nut. In embodiments, growth of a plant includes increase in size of a flower. In embodiments, growth of a plant includes increase in weight of the plant, fruit, seed, nut, and/or flower. In embodiments, growth of a plant includes increase in weight of a plant. In embodiments, growth of a plant includes increase in size of a fruit. In embodiments, growth of a plant includes increase in size of a seed. In embodiments, growth of a plant includes increase in size of a nut. In embodiments, growth of a plant includes increase in size of a flower.

In embodiments, methods of promoting growth of a plant including treating the plant with a composition as described herein. In embodiments, methods of promoting growth of a plant including treating the plant with a composition including zinc sulfate monohydrate (ZnSO₄·H₂O), copper (II) sulfate pentahydrate (CuSO₄·5H₂O), and 10% (by weight) citric acid and where the copper to zinc ratio is 1:5.

In embodiments, methods of promoting growth of a plant includes induction of direct and/or indirect plant pathways for plant. In embodiments, the compositions described herein when applied to a plant surface including seeds, roots, leaves, and/or stems, improves and/or accelerates plant growth. Methods by which plant growth is improved or accelerated include modulating gene expression, signaling pathways, and/or ion channels as required for increase in yield, size, and/or weight of the plant, fruit, seed, nut, and/or flower.

In embodiments, promoting growth of a plant includes increasing crop yield, increasing plant height, increasing size of fruit, increasing size of vegetable, or nut weight, vegetable weight, or flower quantity, and a combination thereof. In embodiments, promoting growth of a plant includes increasing crop yield. In embodiments, promoting growth of a plant includes increasing plant height. In embodiments, promoting growth of a plant includes increasing size of fruit. In embodiments, promoting growth of a plant includes increasing size of vegetable. In embodiments, promoting growth of a plant includes nut weight. In embodiments, promoting growth of a plant includes vegetable weight. In embodiments, promoting growth of a plant includes flower quantity.

In an aspect, provided herein are methods of priming a plant against biotic stress factors including treating the plant with a composition comprising zinc, copper, and acid, where the acid is selected from citric acid, sulfuric acid, oxalic acid, humic acid, fulvic acid, boric acid, acetic acid, and a combination thereof, and optionally ammonium sulfate, and where the ratio of copper to zinc is between 1:2 and 1:20.

In embodiments, priming a plant against biotic stress factors includes treating the plant with a composition as described herein. In embodiments, priming a plant against biotic stress factors includes treating the plant with a composition including zinc sulfate monohydrate (ZnSO₄·H₂O), copper (II) sulfate pentahydrate (CuSO₄·5H₂O), and 10% (by weight) citric acid and where the copper to zinc ratio is 1:5.

In embodiments, priming against biotic stress includes induction of direct and/or indirect plant defenses. In embodiments, the compositions described herein when applied to a plant surface including seeds, roots, leaves, and/or stems, prepares the plant for defense against a biotic stress. Such preparation includes modulating gene expression, signaling pathways, and/or ion channels as required for the particular biotic stress.

In embodiments, priming includes induction of priming pathways or expression of biomarkers indicative of priming. In embodiments, priming includes induction of priming pathways. In embodiments, priming includes production of biomarkers indicative of priming. In embodiments, the biomarkers include carboxylic acids. In embodiments, biomarkers include protein biomarkers. In embodiments, the protein biomarkers are biomarkers involved in anti-oxidant protective pathways. In embodiments, the protein biomarkers are transcription factors. In embodiments, the protein biomarkers are epigenetic markers. In embodiments, the biomarkers are chemical biomarkers. In embodiments, the chemical biomarkers are plant metabolites. In embodiments, the biomarkers are gene biomarkers.

In embodiments, the biomarkers include 1H-Imidazole-4,5-dicarboxylic acid, 5-[(3-methoxy-phenyl)-amide]4-O-tolylamide, 2 propenoic acid, hexanoic acid or propanedioic acid, hydrastininic acid, succinic acid, Thiocyanic acid, thiocyanic acid or 5-alpha-cholestan-3 betayl ester, benzoic acid, 3′-Bromobenzo[1′,2′-b]-1,4-diazabicyclo[2.2.2]octane, 5-tert-Butyl-4-chloromethyl-furan-2-carboxylic acid amide, carbamic acid, L-Aspartic acid, N-glycyl-, N-[10,11-dihydro-5-(2-methylamino-1-oxoethyl)-3-5H-dibenzo[b,f]azepi, 2,2,3,3,3-Pentafluoro-N-[2-bis(2,2,3,3,3-pentafluoropropanoylamino)phenyl]propanamid, Indole-3-carboxylic acid, 5-hydroxy-2-(4-morpholylmethyl)-1-phenyl, ethyl ester, Diethylcarbamodithioic acid, alpha-trifluoroacetylbenzyl ester, 2-Methylglutaconic acid, O,O,O′-tris(trimethylsilyl) derivative, Calconcarboxylic acid, 2-Thiophenecarboxylic acid, 5-(1,1-dimethylethoxy)-.

In embodiments, the biomarker is 1H-Imidazole-4,5-dicarboxylic acid, 5-[(3-methoxy-phenyl)-amide]4-O-tolylamide. In embodiments, the biomarker is 2 propenoic acid. In embodiments, the biomarker is hexanoic acid. In embodiments, the biomarker is propanedioic acid. In embodiments, the biomarker is hydrastininic acid. In embodiments, the biomarker is succinic acid. In embodiments, the biomarker is thiocyanic acid, 5-alpha-cholestan-3 betayl ester. In embodiments, the biomarker is benzoic acid. In embodiments, the biomarker is 3′-Bromobenzo[1′,2′-b]-1,4-diazabicyclo[2.2.2]octene. In embodiments, the biomarker is 5-tert-Butyl-4-chloromethyl-furan-2-carboxylic acid amide. In embodiments, the biomarker is carbamic acid, N-[10,11-dihydro-5-(2-methylamino-1-oxoethyl)-3-5H-dibenzo[b,f]azepi. In embodiments, the biomarker is 2,2,3,3,3-Pentafluoro-N-[2-bis(2,2,3,3,3-pentafluoropropanoylamino)phenyl]propanamid. In embodiments, the biomarker is Indole-3-carboxylic acid. In embodiments, the biomarker is 5-hydroxy-2-(4-morpholylmethyl)-1-phenyl-, ethyl ester. In embodiments, the biomarker is Diethylcarbamodithioic acid. In embodiments, the biomarker is alpha-trifluoroacetylbenzyl ester. In embodiments, the biomarker is 2-Methylglutaconic acid, O,O,O′-tris(trimethylsilyl) derivative. In embodiments, the biomarker is Calconcarboxylic acid. In embodiments, the biomarker is 1-Piperazinecarboxylic acid, ethyl ester. In embodiments, the biomarker is L-Aspartic acid, N-glycyl-. In embodiments, the biomarker is 2-Thiophenecarboxylic acid, 5-(1,1-dimethylethoxy)-.

In embodiments, the biomarkers include Sebacic acid, 2,2-dichloroethyl isobutyl ester, anthranilic acid, benzoic acid, Cyclohexaneacetic acid, 2,2,3,3,4,4,5,5,6,6,7,7-dodecafluoroheptyl ester, 1,4-Cyclohexadiene-1-propanoic acid, 3-(dichloromethyl)-3-methyl-6-oxo-, ethyl ester, Octadecanoic acid, 3-hydroxy-, methyl ester, 1H-[1,2,4]Triazole-3-carboxylic acid [4-(2-methyl-piperidine-1-sulfonyl)-phenyl]-amide, 2-Ketoisocaproic acid oxime, bis(trimethylsilyl)-derivative, Dimethylmalonic acid, 2-ethylhexyl octyl ester, Fumaric acid, 2,4-dichlorophenyl 2,4,6-trichlorophenyl ester, butanoic acid, 2-(3-pentadecylphenoxy)-, silicic acid.

In embodiments, the biomarker is Sebacic acid, 2,2-dichloroethyl isobutyl ester. In embodiments, the biomarker is anthranilic acid. In embodiments, the biomarker is benzoic acid. In embodiments, the biomarker is Cyclohexaneacetic acid, 2,2,3,3,4,4,5,5,6,6,7,7-dodecafluoroheptyl ester, 1,4-Cyclohexadiene-1-propanoic acid, 3-(dichloromethyl)-3-methyl-6-oxo-, ethyl ester. In embodiments, the biomarker is 3-Methoxy-5-methyl-4-nitrophthalic acid. In embodiments, the biomarker is Octadecanoic acid, 3-hydroxy-, methyl ester. In embodiments, the biomarker is 1H-[1,2,4]Triazole-3-carboxylic acid [4-(2-methyl-piperidine-1-sulfonyl)-phenyl]-amide. In embodiments, the biomarker is 2-Ketoisocaproic acid oxime, bis(trimethylsilyl)- derivative. In embodiments, the biomarker is Dimethylmalonic acid, 2-ethylhexyl octyl ester. In embodiments, the biomarker is fumaric acid, 2,4-dichlorophenyl 2,4,6-trichlorophenyl ester, butanoic acid, 2-(3-pentadecylphenoxy)-. In embodiments, the biomarker is silicic acid.

In embodiments, the biomarkers include (S)-10-Hydroxycamptothecin, Erythromycin, Turmerone, 18 B Glycyrrhetinic acid, Aconitine, Arachidonic acid, Artemisinin, Aspartic acid, Epimedin A, Gedunin, Ginsenosides, Guanidosuccinic acid, Jervine, Picrotoxinin, Psoralidin, Quinine, Rescinnamine, Ricinine, Taxifolin, Linoleic acid, or Ascorbic acid.

In embodiments, the biomarker is (S)-10-Hydroxycamptothecin. In embodiments, the biomarker is Erythromycin. In embodiments, the biomarker is Turmerone. In embodiments, the biomarker is 18 B Glycyrrhetinic acid. In embodiments, the biomarker is Aconitine. In embodiments, the biomarker is Arachidonic acid. In embodiments, the biomarker is Artemisinin. In embodiments, the biomarker is Aspartic acid. In embodiments, the biomarker is Epimedin A. In embodiments, the biomarker is Gedunin. In embodiments, the biomarker is Ginsenosides. In embodiments, the biomarker is Guanidosuccinic acid. In embodiments, the biomarker is Jervine. In embodiments, the biomarker is Picrotoxinin. In embodiments, the biomarker is Psoralidin. In embodiments, the biomarker is Quinine. In embodiments, the biomarker is Rescinnamine. In embodiments, the biomarker is Ricinine. In embodiments, the biomarker is Taxifolin. In embodiments, the biomarker is Linoleic acid. In embodiments, the biomarker is Ascorbic acid.

In embodiments, the biomarkers include abscisic acid (ABA), salicylic acid (SA), jasmonic acid (JA), or ethylene (ET). In embodiments, the biomarker is abscisic acid (ABA). In embodiments, the biomarker is salicylic acid (SA). In embodiments, the biomarker is jasmonic acid (JA). In embodiments, the biomarker is ethylene (ET).

In embodiments, the biomarkers include a combination of two or more biomarkers provided herein.

In embodiments, biotic stress factors include infection or infestation by virus, bacteria, fungus, insects or a combination thereof. In embodiments, the biotic stress factor is viral infection or disease. In embodiments, the biotic stress factor is bacterial infection or disease. In embodiments, the biotic stress factor is fungus infection or disease. In embodiments, the biotic stress factor is insect infestation. In embodiments, the biotic stress factor is a combination of one or more of virus, bacteria, fungus, and insect disease or infestation.

In an aspect, provided herein are methods of controlling a fungus infection in a plant susceptible thereto. The methods include applying a composition including zinc, copper, and acid, wherein the acid is selected from citric acid, sulfuric acid, oxalic acid, humic acid, fulvic acid, boric acid, acetic acid, and a combination thereof, and optionally ammonium sulfate, and where the ratio of copper to zinc is between 1:2 and 1:20.

In embodiments, controlling a fungus infection in a plant susceptible thereto includes treating the plant with a composition as described herein. In embodiments, controlling a fungus infection in a plant includes treating the plant with a composition including zinc sulfate monohydrate (ZnSO₄·H₂O), copper (II) sulfate pentahydrate (CuSO₄·5H₂O), and 10% (by weight) citric acid and where the copper to zinc ratio is 1:5.

In embodiments, controlling includes eliminating, treating, or preventing the spread of a fungal infection.

In embodiments of methods provided herein, fungal infections include but are not limited to anthracnose, black knot, blight, chestnut blight, late blight, canker, clubroot, damping-off, Dutch elm disease, ergot, Fusarium wilt, Panama disease, leaf blister, mildew, downy mildew, powdery mildew, oak wilt, rot, basal rot, gray mold rot, heart rot, rust, blister rust, cedar-apple rust, coffee rust, scab, apple scab, smut, bunt, corn smut, snow mold, sooty mold, and Verticillium wilt. In embodiments, the fungal infection is anthracnose. In embodiments, the fungal infection is black knot. In embodiments, the fungal infection is blight. In embodiments, the fungal infection is chestnut blight. In embodiments, the fungal infection is late blight. In embodiments, the fungal infection is canker. In embodiments, the fungal infection is clubroot. In embodiments, the fungal infection is damping-off. In embodiments, the fungal infection is Dutch elm disease. In embodiments, the fungal infection is ergot. In embodiments, the fungal infection is Fusarium wilt. In embodiments, the fungal infection is Panama disease. In embodiments, the fungal infection is leaf blister. In embodiments, the fungal infection is mildew. In embodiments, the fungal infection is downy mildew. In embodiments, the fungal infection is powdery mildew. In embodiments, the fungal infection is oak wilt. In embodiments, the fungal infection is rot. In embodiments, the fungal infection is basal rot. In embodiments, the fungal infection is gray mold rot. In embodiments, the fungal infection is heart rot. In embodiments, the fungal infection is rust. In embodiments, the fungal infection is blister rust. In embodiments, the fungal infection is cedar-apple rust. In embodiments, the fungal infection is coffee rust. In embodiments, the fungal infection is scab. In embodiments, the fungal infection is apple scab. In embodiments, the fungal infection is smut. In embodiments, the fungal infection is bunt. In embodiments, the fungal infection is corn smut. In embodiments, the fungal infection is snow mold. In embodiments, the fungal infection is sooty mold. In embodiments, the fungal infection is Verticillium wilt.

In embodiments, fungal pathogens or fungus-like pathogens (such as, for example, Chromista) can belong to the group including Plasmodiophoramycota, Oomycota, Ascomycota, Chytridiomycetes, Zygomycetes, Basidiomycota or Deuteromycetes (Fungi imperfecti).

In embodiments the fungal pathogens or fungus-like pathogens belongs to the group Plasmodiophoramycota. In embodiments the fungal pathogens or fungus-like pathogens belongs to the group Oomycota. In embodiments the fungal pathogens or fungus-like pathogens belongs to the group Ascomycota. In embodiments the fungal pathogens or fungus-like pathogens belongs to the group Chytridiomycetes. In embodiments the fungal pathogens or fungus-like pathogens belongs to the group Zygomycetes. In embodiments the fungal pathogens or fungus-like pathogens belongs to the group Basidiomycota. In embodiments the fungal pathogens or fungus-like pathogens belongs to the group Deuteromycetes.

In embodiments, the methods provided herein include treating the seeds of a plant with any of the compositions provided herein, including embodiments thereof. In embodiments, treating the seeds includes soaking the seeds in a solution including the composition.

In embodiments, a dry formulation of BAM-FX is produced. In embodiments, the dry formulation is combined with water to make a liquid formulation of BAM-FX. In embodiments, a stock or concentrate of BAM-FX is made with 400 grams of dry powder BAM-FX mixed in 1 liter of water. This stock solution may be further diluted.

In embodiments, the stock solution is diluted in water from about 1:100 to about 1:1000 ratio. In embodiments, the stock solution is diluted in water to about a 1:100 ratio. In embodiments, the stock solution is diluted in water to about a 1:125 ratio. In embodiments, the stock solution is diluted in water to about a 1:150 ratio. In embodiments, the stock solution is diluted in water to about a 1:175 ratio. In embodiments, the stock solution is diluted in water to about a 1:200 ratio. In embodiments, the stock solution is diluted in water to about a 1:300 ratio. In embodiments, the stock solution is diluted in water to about a 1:400 ratio. In embodiments, the stock solution is diluted in water to about a 1:500 ratio. In embodiments, the stock solution is diluted in water to about a 1:600 ratio. In embodiments, the stock solution is diluted in water to about a 1:700 ratio. In embodiments, the stock solution is diluted in water to about a 1:800 ratio. In embodiments, the stock solution is diluted in water to about a 1:900 ratio. In embodiments, the stock solution is diluted in water to about a 1:1000 ratio.

In embodiments, the solution is about 1:100 to about 1:1500 dry formulation to water. In embodiments, the solution is about 1:200 to about 1:1500 dry formulation to water. In embodiments, the solution is about 1:300 to about 1:1500 dry formulation to water. In embodiments, the solution is about 1:400 to about 1:1500 dry formulation to water. In embodiments, the solution is about 1:500 to about 1:1500 dry formulation to water. In embodiments, the solution is about 1:600 to about 1:1500 dry formulation to water. In embodiments, the solution is about 1:700 to about 1:1500 dry formulation to water. In embodiments, the solution is about 1:800 to about 1:1500 dry formulation to water. In embodiments, the solution is about 1:900 to about 1:1500 dry formulation to water. In embodiments, the solution is about 1:1000 to about 1:1500 dry formulation to water. In embodiments, the solution is about 1:1100 to about 1:1500 dry formulation to water. In embodiments, the solution is about 1:1200 to about 1:1500 dry formulation to water. In embodiments, the solution is about 1:1300 to about 1:1500 dry formulation to water.

In embodiments, the seeds are soaked from about 5 minutes to about 300 minutes. In embodiments, the seeds are soaked from about 5 minutes to about 20 minutes. In embodiments, the seeds are soaked from about 5 minutes to about 40 minutes. In embodiments, the seeds are soaked from about 5 minutes to about 60 minutes. In embodiments, the seeds are soaked from about 5 minutes to about 80 minutes. In embodiments, the seeds are soaked from about 5 minutes to about 100 minutes. In embodiments, the seeds are soaked from about 5 minutes to about 120 minutes. In embodiments, the seeds are soaked from about 5 minutes to about 140 minutes. In embodiments, the seeds are soaked from about 5 minutes to about 160 minutes. In embodiments, the seeds are soaked from about 5 minutes to about 180 minutes. In embodiments, the seeds are soaked from about 5 minutes to about 200 minutes. In embodiments, the seeds are soaked from about 5 minutes to about 220 minutes. In embodiments, the seeds are soaked from about 5 minutes to about 240 minutes. In embodiments, the seeds are soaked from about 5 minutes to about 360 minutes.

In embodiments, the seeds are soaked from about 5 minutes to about 280 minutes. In embodiments, the seeds are soaked from about 5 minutes to about 260 minutes. In embodiments, the seeds are soaked from about 5 minutes to about 240 minutes. In embodiments, the seeds are soaked from about 5 minutes to about 220 minutes. In embodiments, the seeds are soaked from about 5 minutes to about 200 minutes. In embodiments, the seeds are soaked from about 5 minutes to about 180 minutes. In embodiments, the seeds are soaked from about 5 minutes to about 160 minutes. In embodiments, the seeds are soaked from about 5 minutes to about 140 minutes. In embodiments, the seeds are soaked from about 5 minutes to about 120 minutes. In embodiments, the seeds are soaked from about 5 minutes to about 100 minutes. In embodiments, the seeds are soaked from about 5 minutes to about 80 minutes. In embodiments, the seeds are soaked from about 5 minutes to about 60 minutes. In embodiments, the seeds are soaked from about 5 minutes to about 40 minutes. In embodiments, the seeds are soaked for about 5 minutes, 20 minutes, 40 minutes, 60 minutes, 80 minutes, 100 minutes, 120 minutes, 140 minutes, 160 minutes, 180 minutes, 200 minutes, 220 minutes, 240 minutes, 260 minutes, 280 minutes, or 300 minutes.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

### EMBODIMENTS

Embodiment 1. A composition comprising zinc, copper, and an acid, wherein the acid is selected from citric acid, sulfuric acid, oxalic acid, humic acid, fulvic acid, boric acid, acetic acid, and a combination thereof, and optionally ammonium sulfate, wherein the ratio of copper to zinc is between 1:2 and 1:20, and wherein said composition has plant priming activity.

Embodiment 2. The composition of embodiment 1, wherein the ratio of copper to zinc is between 1:3 and 1:10.

Embodiment 3. The composition of embodiment 1, wherein the ratio of copper to zinc is 1:3.

Embodiment 4. The composition of embodiment 1, wherein the ratio of copper to zinc is 1:5.

Embodiment 5. The composition of embodiment 1, wherein the ratio of copper to zinc is 1:10.

Embodiment 6. The composition of any one of embodiments 1-5, wherein the zinc is zinc sulfate monohydrate (ZnSO₄·H₂O).

Embodiment 7. The composition of embodiment 6, wherein the zinc sulfate monohydrate (ZnSO₄·H₂O) has a zinc content of 36%.

Embodiment 8. The composition of any one of embodiments 1-5, wherein the copper is copper (II) sulfate pentahydrate (CuSO₄·5H₂O).

Embodiment 9. The composition of embodiment 7, wherein the copper (II) sulfate pentahydrate (CuSO₄·5H₂O) has a copper content of 25%.

Embodiment 10. The composition of any one of embodiments 1-9, further comprising iron.

Embodiment 11. The composition of embodiment 10, wherein the ratio of ratio of copper to zinc to iron is 1:3:1.

Embodiment 12. The composition of any one of embodiments 10 or 11, wherein the iron is iron (II) sulfate heptahydrate (FeSO₄·7H₂O).

Embodiment 13. The composition of any one of embodiments 1-12, wherein the acid is between about 0.1% and 20% of the total weight.

Embodiment 14. The composition of any one of embodiments 1-13, wherein the acid is citric acid.

Embodiment 15. The composition of embodiment 14, wherein the citric acid is between about 5% and 10% of the total weight.

Embodiment 16. The composition of any one of embodiments 1-12, wherein the acid is fulvic acid.

Embodiment 17. The composition of embodiment 16, wherein the fulvic acid is between about 1% and about 5% of the total weight.

Embodiment 18. The composition of any one of embodiments 1-12, wherein the acid is boric acid.

Embodiment 19. The composition of embodiment 18, wherein the boric acid is between about 0.1% and about 1% of the total weight.

Embodiment 20. The composition of any one of embodiments 1-17, further comprising a binding agent.

Embodiment 21. The composition of embodiment 18, wherein the binding agent is selected from molasses, gum, native starch, and modified starch.

Embodiment 22. The composition of any one of embodiments 1-21, wherein the composition does not comprise ammonium sulfate.

Embodiment 23. The composition of any one of embodiments 1-22, wherein the acid is not sulfuric acid.

Embodiment 24. The composition of any one of embodiments 1-23, wherein the composition is formulated as a dry powder.

Embodiment 25. A composition comprising zinc sulfate monohydrate (ZnSO₄·H₂O), copper (II) sulfate pentahydrate (CuSO₄·5H₂O), and an acid, wherein the acid is selected from citric acid, sulfuric acid, oxalic acid, humic acid, fulvic acid, boric acid, acetic acid, and a combination thereof, wherein the ratio of copper to zinc is between 1:2 and 1:20, and wherein the composition is formulated as a dry powder.

Embodiment 26. The composition of any of embodiments 1-25, wherein the composition is formulated as a foliar spray, seed treatment, or drenching treatment.

Embodiment 27. A composition comprising zinc sulfate monohydrate (ZnSO₄·H₂O), copper (II) sulfate pentahydrate (CuSO₄·5H₂O), and an acid, wherein the acid is selected from citric acid, sulfuric acid, oxalic acid, humic acid, fulvic acid, boric acid, acetic acid, and a combination thereof, wherein the ratio of copper to zinc is between 1:2 and 1:20, and wherein the composition is formulated as a foliar spray.

Embodiment 28. The composition of any one of embodiments 1-25, wherein the composition is enclosed within a calcium lignin sulfate capsule.

Embodiment 29. A method of reducing cellular damage to a plant comprising treating the plant with composition comprising zinc, copper, and acid, wherein the acid is selected from citric acid, sulfuric acid, oxalic acid, humic acid, fulvic acid, boric acid, acetic acid, and a combination thereof, and optionally ammonium sulfate, wherein the ratio of copper to zinc is between 1:2 and 1:20.

Embodiment 30. A method of priming a plant against abiotic stress factors comprising treating the plant with a composition comprising zinc, copper, and acid, wherein the acid is selected from citric acid, sulfuric acid, oxalic acid, humic acid, fulvic acid, boric acid, acetic acid, and a combination thereof, and optionally ammonium sulfate, wherein the ratio of copper to zinc is between 1:2 and 1:20.

Embodiment 31. The method according to embodiment 30, wherein the abiotic stress factor is drought, salinity, heat, or combinations thereof.

Embodiment 32. A method of promoting growth of a plant comprising treating the plant with a composition comprising zinc, copper, and acid, wherein the acid is selected from citric acid, sulfuric acid, oxalic acid, humic acid, fulvic acid, boric acid, acetic acid, and a combination thereof, and optionally ammonium sulfate, wherein the ratio of copper to zinc is between 1:2 and 1:20.

Embodiment 33. A method of priming a plant against biotic stress factors comprising treating the plant with a composition comprising zinc, copper, and acid, wherein the acid is selected from citric acid, sulfuric acid, oxalic acid, humic acid, fulvic acid, boric acid, acetic acid, and a combination thereof, wherein the ratio of copper to zinc is between 1:2 and 1:20.

Embodiment 34. The method according to embodiment 33, wherein the biotic stress factor is fungal, bacterial, viral, or insect infection or combinations thereof.

Embodiment 35. The method of any one of embodiments 29-34, wherein treating the plant comprises treating a seed of the plant with the composition.

Embodiment 36. A method of controlling a fungus infection in a plant susceptible thereto, the method comprising applying a composition comprising zinc, copper, and acid, wherein the acid is selected from citric acid, sulfuric acid, oxalic acid, humic acid, fulvic acid, boric acid, acetic acid, and a combination thereof, and optionally ammonium sulfate, wherein the ratio of copper to zinc is between 1:2 and 1:20.

Embodiment 37. The method of embodiment 36, wherein the composition is applied to a seed of the plant.

Embodiment 38. The method of embodiment 35 or embodiment 37, wherein the seed is soaked in a solution comprising the composition.

Embodiment 39. The method of any one of embodiments 29-36, wherein the ratio of copper to zinc is between 1:3 and 1:10.

Embodiment 40. The method of any one of embodiments 29-36, wherein the ratio of copper to zinc is 1:3.

Embodiment 41. The method of any one of embodiments 29-36, wherein the ratio of copper to zinc is 1:5.

Embodiment 42. The method of any one of embodiments 29-36, wherein the ratio of copper to zinc is 1:10.

Embodiment 43. The method of any one of embodiments 29-36, wherein the zinc is zinc sulfate monohydrate (ZnSO₄·H₂O).

Embodiment 44. The method of embodiment 43, wherein the zinc sulfate monohydrate (ZnSO₄·H₂O) has a zinc content of 36%.

Embodiment 45. The method of any one of embodiments 30-44, wherein following treatment the plant increases production of one or more plant priming biomarkers.

Embodiment 46. The method of claim 45, wherein the one or more biomarkers include silicic acid, butanoic acid, ascorbic acid, linoleic acid, hexanoic acid, propanedioic acid, succinic acid, 2-Ketoisocaproic acid oxime, bis(trimethylsilyl)- derivative, 5-tert-butyl-4-chloromethyl-furan-2-carboxylic acid amide, fumaric acid, 2,4-dichlorophenyl 2,4,6-trichlorophenyl ester, guanidosuccinic acid, aspartic acid, arachidonic acid, acontine, quinine, epimedin A, ginsenosides, taxifolin, psoralidin, artemisinin, picrotoxinin, indole-3-carboxylic acid, 5-hydroxy-2-(4-morpholylmethyl)-1-phenyl-, ethyl ester, sebacic acid, 2,2-dichloroethyl isobutyl ester, Cyclohexaneacetic acid, 2,2,3,3,4,4,5,5,6,6,7,7-dodecafluoroheptyl ester, 1,4-Cyclohexadiene-1-propanoic acid, 3-(dichloromethyl)-3-methyl-6-oxo-, ethyl ester, anthranilic acid, or benzoic acid

Embodiment 47. The method of any one of embodiments 29-44, wherein the copper is copper (II) sulfate pentahydrate (CuSO₄·5H₂O).

Embodiment 48. The method of embodiment 45, wherein the copper (II) sulfate pentahydrate (CuSO₄·5H₂O) has a copper content of 25%.

Embodiment 49. The method of any one of embodiments 29-46, further comprising iron.

Embodiment 50. The method of embodiment 47, wherein the ratio of ratio of copper to zinc to iron is 1:3:1.

Embodiment 51. The method of embodiment 47 or 48, wherein the iron is iron (II) sulfate heptahydrate (FeSO₄·7H₂O).

Embodiment 52. The method of any one of embodiments 29-49, wherein the acid is between about 0.1% and 20% of the total weight.

Embodiment 53. The method of any one of embodiments 29-50, wherein the acid is citric acid.

Embodiment 54. The method of embodiment 51, wherein the citric acid is between about 5% and 10% of the total weight.

Embodiment 55. The method of any one of embodiments 30-52, wherein the acid is fulvic acid.

Embodiment 56. The method of embodiment 55, wherein the fulvic acid is between about 1% and about 5% of the total weight.

Embodiment 57. The method of any one of embodiments 29-54, wherein the acid is boric acid.

Embodiment 58. The method of embodiment 55, wherein the boric acid is between about 0.1% and about 1% of the total weight.

Embodiment 59. The method of any one of embodiments 29-56, further comprising a binding agent.

Embodiment 60. The method of embodiment 57, wherein the binding agent is selected from molasses, gum, native starch, and modified starch.

Embodiment 61. The method of any one of embodiments 28-58, wherein the composition does not comprise ammonium sulfate.

Embodiment 62. The method of any one of embodiments 28-59, wherein the acid is not sulfuric acid.

Embodiment 63. A method of making the composition of any one of embodiments 1-27, comprising weighing, grinding, and mixing each component to a defined particle size.

Embodiment 64. The method of embodiment 61, wherein the defined particle size is about 250 μm to about 400 um.

### Examples

### Example 1: Production of BAM-FX

The dry formulation of compositions described herein can be manufactured, for example, by weighing the ingredients, grinding, and mixing to a defined particle size. For example, manufacturing of a dry formulation was made by weighing 16 kilograms of zinc sulfate monohydrate (granular), 4 kilograms copper sulfate pentahydrate (Fine 30 form), and 5 kilograms of citric acid, anhydrous (Fine granular). The output is about 25 kilograms. The ingredients are mixed and grinded with a 40-60 Mesh/400-250 μm. The ratio of copper to zinc is 1:5.7 (1 copper to 5.7 zinc). Dry formulations may be referred to herein as BAM-dry or BAM-dry formulation.

In embodiments, the dry formulation may be encapsulated using 1-20% calcium lignosulfate or sodium lignosulfate. In embodiments, 10% calcium lignosulfate is used to encapsulate the dry formulation. This allows extrusion and pellet formation which masks the corrosiveness of the active ingredients during handling and shipment.

Liquid formulation of compositions described herein can be manufacture, for example, by the following protocol:
1) Add 420 gallons of purified water at 95° F., add 50 gallons of ammonium sulfate and sulfuric acid (10-90% concentration) and air agitate for 5 minutes until mixture is complete;
2) Slowly add 1150 pounds of zinc sulfate monohydrate (granular), temperature will rise to 115-125° F.;
3) Air agitate thoroughly for 120-180 minutes or until solution is homogenous;
4) Add 500 pounds of copper sulfate pentahydrate (Fine 30);
5) Air agitate thoroughly for 20 minutes.

Additional mixing time may be required. The final concentration of ammonium sulfate is about 0.1-0.6%. The final concentration of sulfuric acid is about 0.5-5%. This formulation may be referred to as BAM-FX

The expected output is 520 gallons.

In some embodiments, the liquid formulation is prepared similar to above except instead of sulfuric acid an organic acid made be used and ammonium sulfate excluded from the preparation. This embodiment may be referred to as BAM-O.

Some formulations have been prepared to provide a ratio of copper to zinc of 1 copper to 3 zinc (or 1:3). Some formulations have been prepared to provide a ratio of copper to zinc of 1 copper to 3 zinc to 1 iron (or 1:3:1). In some formulations, the iron is ferrous sulfate heptahydrate. In some formulations the iron is iron (III) chloride. In some formulations, acid is between around 1% and 10% of the total weight. Some formulations include sulfuric acid at between around 0.5% and 5% of the total weight. Some formulations include citric acid at between around 5% and 10% of the total weight. Some formulations include fulvic acid at between around 1% and 5% of the total weight. Some formulations include boric acid at between around 1% and 5% of the total weight. Some formulations further include binding agents. Examples of binders and agglomeration agents include molasses, native starch, gums, and modified starch.

### Example 2: BAM-FX: a Novel Mineral Composition with Priming Effects on Seeds and Plants

Crop plants are subjected to multiple abiotic stresses during their lifespan that greatly reduce productivity and threaten global food security. Plants can be primed by chemical compounds to better tolerate different abiotic stresses.

Plant priming using chemical agents such as sodium nitroprusside, hydrogen peroxide, sodium hydrosulfide, melatonin, and polyamines enhances plant tolerance to different abiotic stresses, improving cellular homeostasis and plant growth under stress conditions.

Plants have evolved mechanisms to deal with various and complex types of interactions involving numerous environmental factors. In the course of evolution, they have evolved specific mechanisms allowing them to adapt and survive stressful events.

Examples of abiotic stress include non-living factors, events, or conditions with a negative effect on a plant in a specific environment. Examples of abiotic stress in plants include drought, salinity, heat, cold, phosphate starvation, metal toxicity, and a combination thereof.

Examples of biotic stress include living factors that impact a living organisms in a specific environment. Examples of biotic stress in plants include fungus, viral, bacterial, or insect infection or infestations.

A crucial step in plant defense is the timely perception of the stress in order to respond in a rapid and efficient manner. After recognition, the plants' constitutive basal defense mechanisms lead to an activation of complex signaling cascades of defense varying from one stress to another. Following exposure to abiotic and/or biotic stress, specific ion channels and kinase cascades are activated, reactive oxygen species (ROS), phytohormones like abscisic acid (ABA), salicylic acid (SA), jasmonic acid (JA), and ethylene (ET) accumulate, and a reprogramming of the genetic machinery results in adequate defense reactions and an increase in plant tolerance in order to minimize the biological damage caused by the stress.

Signaling pathways are induced by multiple stress responses. The interaction between abiotic and biotic stress induces complex responses to the different stressors. Under stress, the accumulation of certain metabolites positively affects a plant's response to both stresses and therefore protects it from multiple aggressors. Callose accumulation, changes in ions fluxes, ROS, and phytohormones are some of the first responses induced to combat the stress and the resulting signal transduction triggers metabolic reprogramming towards defense.

There are molecular changes associated with stress. Transcriptomics, proteomics, and metabolomics have revealed plant responses under stress and their underlying mechanisms and point to potential target genes, proteins or metabolites for inducing tolerance and improve plant responses. A comprehensive, detailed view of gene and protein expression during abiotic and biotic stress combinations is not well understood. Although complete genome sequences are available for an increasing number of crop and model plants, in comparison, protein and metabolite databases are still rather incomplete, thus complicating the task of integrating all observations. Additionally, different plant species or even cultivars may behave differently, plant responses are also often organ-dependent, and results obtained with whole plants may be misleading.

BAM-FX (Bio-Available Minerals-Formula X) is a highly positively charged cationic Zinc²⁺ and cationic Copper²⁺ solution balanced together in a specific ratio and in acid. The compositions tested herein include sulfuric acid and ammonium sulfate. Similar compositions were tested using zinc, copper, and citric acid and these compositions provided similar results. This unique blend of positive electrical charge, together with only the most bioavailable forms of four elements (Zn, Cu, S, N), results in a micro and macronutrient product that optimizes application and delivery of these nutrients where they are needed inside leaves and roots. Because these nutrients are transported throughout the plant systemically, this formulation has many apparent positive effects, such as faster seed germination and seedling growth, improved environmental stress tolerance, increased biomass and greater yield and quality. BAM-FX works when used as a foliar or root based application and can be used safely in conjunction with a wide variety of other products.

The experiments described herein support the conclusion that the compositions described herein provide plants a mechanism by which to successively handle biotic and abiotic stresses. While not wishing to be bound by theory, the effect of the composition is believed to be at the level of signal transduction. BAM-FX is chemical formulation that is an effective priming agent. The experiments described herein demonstrate that in dry or wet formulation it can be applied to a variety of plant parts to promote positive effects. BAM-FX has been shown to modulate the plant physiology in a number of crops under a variety of stress conditions. The modulations have been shown to result in resistance to biotic and abiotic stress, and improvement in the quality of products.

### Example 3: Increased Resistance to Fungal Disease in Pigeon Peas Seeds Treated with BAM-FX

BAM-FX treatment resulted in resistance to fungal infections in pigeon peas.

Pigeon pea (Cajanus cajan (L.) Mill sp.) is a perennial member of the family leguminosae. It is a multi-purpose species and is extensively used as food grain and green manure crop for soil fertility amelioration in local cropping systems. It is an important grain legume crop of rain-field agriculture in the tropics and subtropics. Many fungal diseases are known to affect plants including collar rot and wilt disease. Collar rot is a disease that affects about 100 crop species including vegetables, ornamentals and horticultural crops and is present in about 14 countries. One of the most serious fungal diseases is wilt disease (Fusarium udum). This fungus enters the plant through the roots and may persist in soil-borne stubble for a long time. Fungi reported from seeds of pigeon pea are Alternaria sp., Aspergillus sp., Colletotrichum lagenarium, Coleophoma empetri, Fusarium equiseti, Macrophomina phaseolina, Myrothecium roridum, Rhizoctonia solani, Rhizopus sp., and Sclerotium rolfsii.

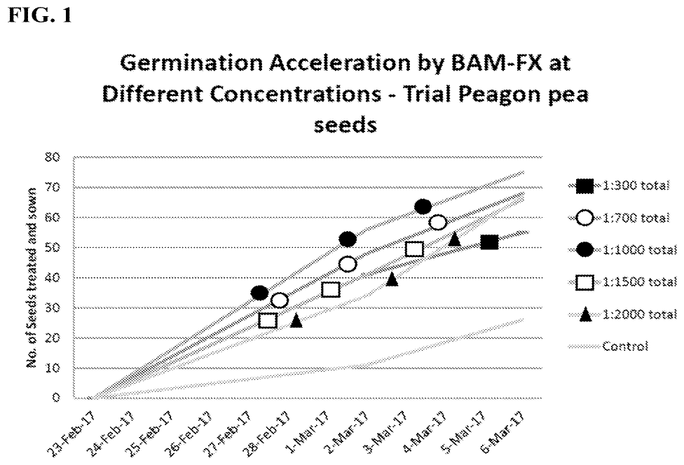

The aim of the experimental approach described herein was to determine if BAM-FX could provide beneficial effects to pigeon peas against a fungal stressor. Pigeon pea seeds were soaked with BAM-FX at various dilutions and planted in soil contaminated with potential root rot disease pathogens. FIG. 1 shows germination rate at different BAM-FX concentrations.

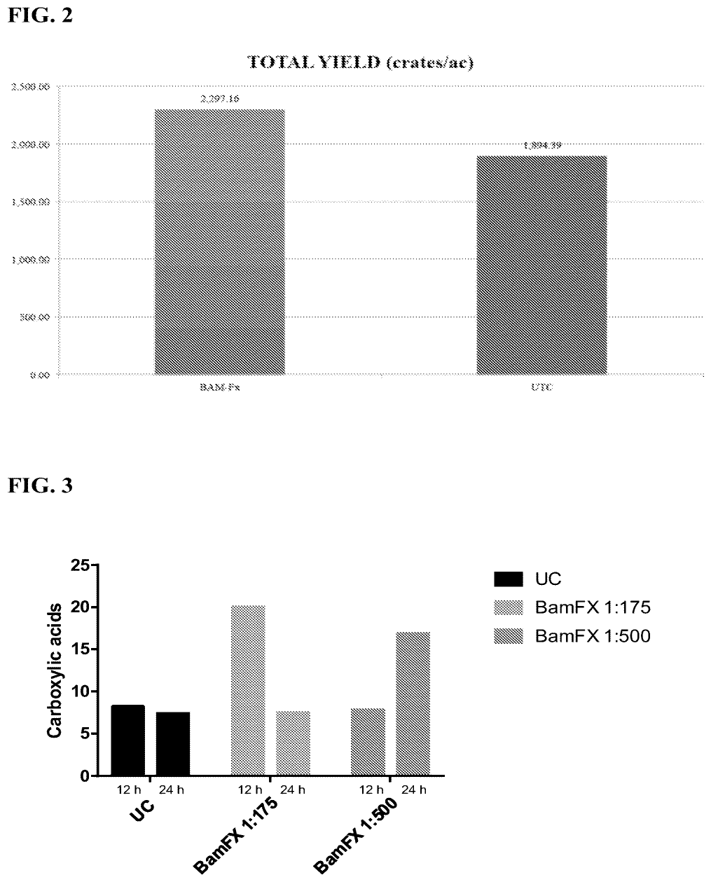

The data showed that untreated control (seeds that were not treated with BAM-FX) showed root rot disease in 98% of cases while the treated seeds (seeds soaked in BAM-FX) showed infection in only 0.025%. See FIG. 2. The pathogens were isolated and identified as Aspergillus sp. by DNA sequencing.

The data demonstrated that treatment of seeds with BAM-FX for as little as 3 hours resulted in resistance to fungal infection for the entire crop cycle. Resistance was shown within 14 days after germination.

### Example 4: The Duration of Soaking Seeds in BAM-FX was Optimized

Characteristics of Maize seeds used in this study are as shown in Table 1.

TABLE 1
Maize Seed General Characteristics

| Parameters | Average value |
|---|---|
| Size of the seed | 0.6 to 0.8 cm |
| Color | Yellow and bicolored colored seeds |
| % germination as per manufacturer | 70% |
| Shape | Oval shape seeds |

The seeds were soaked in either water or BAM-FX as indicated in Table 2.

TABLE 2
Conditions for seeds soaked in water or BAM-FX

| | | BAM-FX | BAM-FX | BAM-FX | BAM-FX |
|---|---|---|---|---|---|
| | Untreated control | 1:175 | 1:250 | 1:500 | 1:1000 |
| Duration | (500 ml) | (500 ml) | (500 ml) | (500 ml) | (500 ml) |
| 5 mins | 25 seeds | 25 seeds | 25 seeds | 25 seeds | 25 seeds |
| 10 mins | 25 seeds | 25 seeds | 25 seeds | 25 seeds | 25 seeds |
| 20 mins | 25 seeds | 25 seeds | 25 seeds | 25 seeds | 25 seeds |
| 40 mins | 25 seeds | 25 seeds | 25 seeds | 25 seeds | 25 seeds |

TABLE 3
Results of Maize Seeds Soaked in water or BAM-FX.

| BAM-FX | | | | | | | | |
|---|---|---|---|---|---|---|---|---|
| dilutions | 1:175 | 1:175 | 1:175 | 1:175 | 1:250 | 1:250 | 1:250 | 1:250 |
| Exposure | 5 | 10 | 20 | 40 | 5 | 10 | 20 | 40 |
| time to | | | | | | | | |
| BAM-FX | | | | | | | | |
| (min) | | | | | | | | |
| Germination | 100 | 100 | 60 | 25 | 80 | 80 | 80 | 80 |
| % Seeds | | | | | | | | |
| Growth (mm) | 20 | 2 to 10 | 1 to 20 | 10 to 25 | 6 to 8 | 7 to 8 | 10 to 20 | 5 to 10 |
| Water Uptake | yes | yes | yes | yes | yes | yes | yes | yes |
| Other | lateral | only in | only in 25% | | | | | |
| Observations | roots | 20% of | of seeds | | | | | |
| | | seeds | lateral | | | | | |
| | | lateral | roots | | | | | |
| | | roots | formed | | | | | |
| | | formed | | | | | | |
| BAM-FX | | | | | | | | |
| dilutions | 1:500 | 1:500 | 1:500 | 1:500 | 1:1000 | 1:1000 | 1:1000 | 1:1000 |
| Exposure | 5 | 10 | 20 | 40 | 5 | 10 | 20 | 40 |
| time to | | | | | | | | |
| BAM-FX | | | | | | | | |
| (min) | | | | | | | | |
| Germination | 100 | 100 | 100 | 100 | 100 | 100 | 80 | 60 |
| % Seeds | | | | | | | | |
| Growth (mm) | 20 | 20 | 22 | 10 | 10 to 20 | 30 | 20 | 20 |
| Water Uptake | yes | yes | yes | yes | yes | yes | yes | yes |

The results in Table 3 illustrate that for maize, a 1:500 dilution of BAM-FX was found to be effective for seed germination and plant growth. Plant growth was optimum when seeds were exposed to a concentration of 1:500 diluted BAM-FX for 20 min.

### Wheat Seeds Soaked in BAM-FX

Triticum dicoccum Schuh L (Family: Grammeae) seeds were purchased from the local vendor. The seeds were found intact and without noteable physical damage. The characteristics of the seeds are as shown in Table 4, and treatment conditions for the study are as shown in Table 5.

TABLE 4
Wheat seed characteristics

| Parameters | Average value |
|---|---|
| Size of the seed | 0.4 to 0.6 cm |
| Color | Faint Yellow |
| % germination as per manufacturer | Minimum 70% |
| Shape | Oval, natural |

TABLE 5
Treatment conditions for seeds soaked in water or BAM-FX

| | Untreated | BAM-FX | BAM-FX | BAM-FX | BAM-FX |
|---|---|---|---|---|---|
| | control | 1:175 | 1:250 | 1:500 | 1:1000 |
| Duration | (500 ml) | (500 ml) | (500 ml) | (500 ml) | (500 ml) |
| 5 mins | 25 seeds | 25 seeds | 25 seeds | 25 seeds | 25 seeds |
| 10 mins | 25 seeds | 25 seeds | 25 seeds | 25 seeds | 25 seeds |
| 20 mins | 25 seeds | 25 seeds | 25 seeds | 25 seeds | 25 seeds |
| 40 mins | 25 seeds | 25 seeds | 25 seeds | 25 seeds | 25 seeds |

Results for the study are as shown in Table 6.

TABLE 6
Results for wheat seeds soaked in water or BAM-FX

| BAM-FX | | | | | | | | |
|---|---|---|---|---|---|---|---|---|
| Dilution | 1:175 | 1:175 | 1:175 | 1:175 | 1:250 | 1:250 | 1:250 | 1:250 |
| Exposure time | 5 | 10 | 20 | 40 | 5 | 10 | 20 | 40 |
| to BAM-FX | | | | | | | | |
| Germination % | 100 | 100 | 100 | 100 | 100 | 100 | 100 | 100 |
| Seeds | | | | | | | | |
| Growth (mm) | 10 | 10 | 20-25 | 20-25 | 20-25 | 20-25 | 20-25 | 20-25 |
| Water Uptake | yes | yes | yes | yes | yes | yes | yes | yes |
| Other | many | many | more | more | | | | |
| Observation | roots | roots | than | than | | | | |
| | | | 4 roots | 4 roots | | | | |
| | | | were | were | | | | |
| | | | formed | formed | | | | |
| Maize | 1:500 | 1:500 | 1:500 | 1:500 | 1:1000 | 1:1000 | 1:1000 | 1:1000 |
| Exposure time | 5 | 10 | 20 | 40 | 5 | 10 | 20 | 40 |
| to BAM-FX | | | | | | | | |
| Germination % | 100 | 100 | 100 | 100 | 100 | 100 | 100 | 100 |
| Seeds | | | | | | | | |
| Growth (mm) | 20 | 25 | 25 | 25 | 5-10 | 20 | 30 | 30 |
| Water Uptake | yes | yes | yes | yes | yes | yes | yes | yes |
| Other | shaft | shaft | shaft | shaft | shaft | shaft | shaft | shaft |
| Observation | appears | appears | appears | appears | appears | appears | appears | appears |
| | green | green | green | green | green | green | green | green |

The results indicate that wheat growth was observed in 1:250, 1:500 and 1:1000 dilutions. The optimum concentration of BAM-FX was found to be a 1:500 dilution of BAM-FX and the optimal soak time was 20 min.

### Example 5: Determination of Molecular Markers Involved in Priming by BAM-FX

In search of the metabolites induced by BAM-FX, okra seeds were divided into groups, and set on plates where they were treated with BAM-FX 1:175, 1:500 for 30 minutes at room temperature. From each plate, 10 seeds were collected after 12 hours and 24 hours growth. The seeds were crushed and extracted by using two different methods—Hot methanolic and cold methanolic methods. In the first method, 10 ml of methanol:water (1:1) was mixed with 1 gram of crushed seeds and kept at 70° C. for 15 minutes. After 15 minutes, the mixture was kept for room temperature and used for the preparation of ester. In second method, 10 ml of Methanol was mixed with crushed seeds and kept at 4° C. for 14 hours. After incubation, the mixture was used for the methyl ester preparation.

For methyl ester preparation, 250 μg or 50 μl of lipid samples were added to 1 ml of 1% NaOH in methanol (freshly prepared). The samples were heated at 55° C. for 15 minutes. In hot tubes, 2 ml of 5% methanolic HCL (freshly prepared) was added and again heated for 15 minutes at 55° C. The fatty acid methyl esters (FAME) were eluted by adding 1 ml of hexane to the reaction mix. The fatty acid methyl esters (FAME) were transported in 8-10° C. (All the steps were performed in screw cap glass tube only).

Reagents: 1% w/v NaOH in methanol, prepared by dissolving 1 g of NaOH in 90 ml of Methanol (HPLC grade) and after mixing makeup the volume up to 10 ml by Methanol. Five-percent (5%) methanolic HCL was prepared by adding 5 ml methanol (HPLC grade) in 95 ml concentrated HCL. The reaction mixture was kept at 8-10° C. References: Carreau and debacq 1978. J chromatograph. Sahu Abhishek et.al., Phytochemistry 2013 (89) 53-58.

FAMEs were analyzed by GCMS.

Fatty acid methyl esters were analyzed by gas chromatography-mass spectroscopy (GC-MS). Results showed that carboxylic acids were induced in 1:175 concentration BAM-FX treated seed after 12 hours growth (20%). A decrease in the carboxylic acids was found after 24 hours in 1:175 treated seeds (7.5%). This was also confirmed by cold methanolic extraction method, where 19.3% carboxylic acids were found in 1:500 treated seed in 24 hours. In untreated control seeds, the quantity of carboxylic acids were found 8.25%. This is similar to the percentage of carboxylic acid found in 1:500 (12 h). The dose dependent priming induction was observed in seeds treated with BAM-FX 1:500. Carboxylic acids percentage was found increased from 7.8% (12 h) to 16.85% (24 h). Results illustrated in FIG. 3 confirmed that the BAM-FX treatment induces the carboxylic acid in time and dose dependent manner in okra.

Further carboxylic acids were found upon priming induction. Fumaric acid induction (19%) was also found in seeds treated with BAM-FX at a concentration of 1:500. Additionally, propionic acid was found in the initial period of treatment. Propionic acid 3.56% and 8.84% found in 1:175 and 1:500 treated seeds, respectively. This was not detected in untreated seeds (Table 7).

TABLE 7
Compounds produced by untreated and BAM-FX treated samples.

| | | | BAM treated | | | |
|---|---|---|---|---|---|---|
| | Untreated | Untreated | 1:175 | | | |
| | control | control | 12 | 1:175 | 1:500 | 1:500 |
| Metabolites | 12 h | 24 hours | hours | 24 h | 12 h | 24 h |
| Pentanoic acid | 8.54 | | 2.4 | | 7.32 | |
| Bis(trimethylsilyl)benzene | 18.61 | | | 1.35 | | |
| Purine-2,6-dione, 8-(3- | 6.83 | | | 2.07 | | |
| ethoxypropylamino)-1,3-di | | | | | | |
| silane | | 2.95 | | | | |
| 2'-Hydroxypropiophenone | | 1.66 + 1.68 | | | | |
| Silicic acid | | 2.84 | | | | |
| carboxylic acid | 8.25 | 7.4 | 20 | 7.5 | 7.8 | 16.85 |
| many types | | | | | | |
| trisiloxane, 1,1,1,5,5,5- | | 2.33 + 7.09 | | 3.02 | cyclo is | 9.36 + 8.73 |
| hexamethyl-3-[(trimethylsi | | | | | present | |
| Phenol, 2,4-dichloro-6-nitro- | | 2.93 | 4.32 | | | |
| Trimethylsilyl 3-methyl-4- | | 4.55 | | 1.6 | | |
| [(trimethylsilyl)oxy]ben | | | | | | |
| Ethyl homovanillate, | | 2.94 | | | 5.95 | |
| TMS derivative | | | | | | |
| 3-Ethoxy-1,1,1,5,5,5- | | 2.32 | | | | 6.22 |
| hexamethyl-3- | | | | | | |
| (trimethylsilo | | | | | | |
| d-Mannitol, 1-O-heptyl- | | 2.22 | 3.39 | 3.24 | | |
| Succinic acid | | 3.97 | 1.96 | | | |
| Uridine, 5- | | | 1.26 | | | |
| heptafluoropropyl- | | | | | | |
| Cyclohexanepropanoic | | | 3.56 | | 8.84 | |
| acid, | | | | | | |
| Thiophene-2-carboxylic | | | | 1.54 + 1.88 | | |
| acid | | | | | | |
| Octadecanoic acid | | | yes | 1.52 + 4.74 | | |
| 1,2-Cinnolinedicarboxylic | | | | 0.95 | | |
| acid, 1,2,3,5,6,7,8,8a-o | | | | | | |
| Fumaric acid, eicosyl 2- | | | | | | |
| methylpentyl ester | | | | | | |
| 3-Methylsalicylic acid, | | | | | | |
| 2TMS derivative | | | | | | |

TABLE 8
Metabolites found in BAM-FX treated Okra seeds.

| | | | | **CL means |
|---|---|---|---|---|
| | | BAM treated | | cold |
| Metabolites | UC 24 CL | 175 24 CL | 500 24 CL | methanol |
| Pentanoic acid | | | | |
| Bis(trimethylsilyl)benzene | | | | |
| Purine-2,6-dione, 8-(3- | | | | |
| ethoxypropylamino)-1,3-di | | | | |
| silane | 5.02 | | | |
| 2′-Hydroxypropiophenone | | 11.16 | | increasing |
| Silicic acid | | 11.55 | | increasing |
| carboxylic acid many | 4.84 | 9.82 | 19.3 | involved in |
| types | | | | priming |
| trisiloxane, 1,1,1,5,5,5- | | | | increasing |
| hexamethyl-3-[(trimethylsi | | | | |
| Phenol, 2,4-dichloro-6-nitro- | | | | |
| Trimethylsilyl 3-methyl-4- | 5.02 | | | |
| [(trimethylsilyl)oxy]ben | | | | |
| Ethyl homovanillate, TMS | | | | |
| derivative | | | | |
| 3-Ethoxy-1,1,1,5,5,5- | | 8.41 | | increasing |
| hexamethyl-3- | | | | |
| (trimethylsilo | | | | |
| d-Mannitol, 1-O-heptyl- | | | | |
| Succinic acid | | | | |
| Uridine, 5- | 7.51 | | | |
| heptafluoropropyl- | | | | |
| Cyclohexanepropanoic | | | | |
| acid, | | | | |
| Thiophene-2-carboxylic | | | | |
| acid | | | | |
| Octadecanoic acid | | | | |
| 1,2-Cinnolinedicarboxylic | | 9.28 | | |
| acid, 1,2,3,5,6,7,8,8a-o | | | | |
| Fumaric acid, eicosyl 2- | | | 15.36 + 3.22 | involved in |
| methylpentyl ester | | | | priming |
| 3-Methylsalicylic acid, | | yes | | |
| 2TMS derivative | | | | |

### Determination of Molecular Markers Involved in Priming by BAM-FX in Maize

To find out the molecular markers involved in priming by BAM-FX, maize seeds were treated with 1:175, 1:500, or 1:1000 diluted BAM-FX for 30 minutes at room temperature. The seeds were collected from each plate after 72 hours. The seeds were then crushed and extracted by using two different methods. Ten (10) ml of methanol was mixed with crushed seeds and kept at 4° C. for 14 hours. After incubation, the mixture was used for the ester preparation by method described earlier.

The maize seeds treated with BAM-FX 1:175, 1:500 and 1:1000 were then analyzed by GCMS.

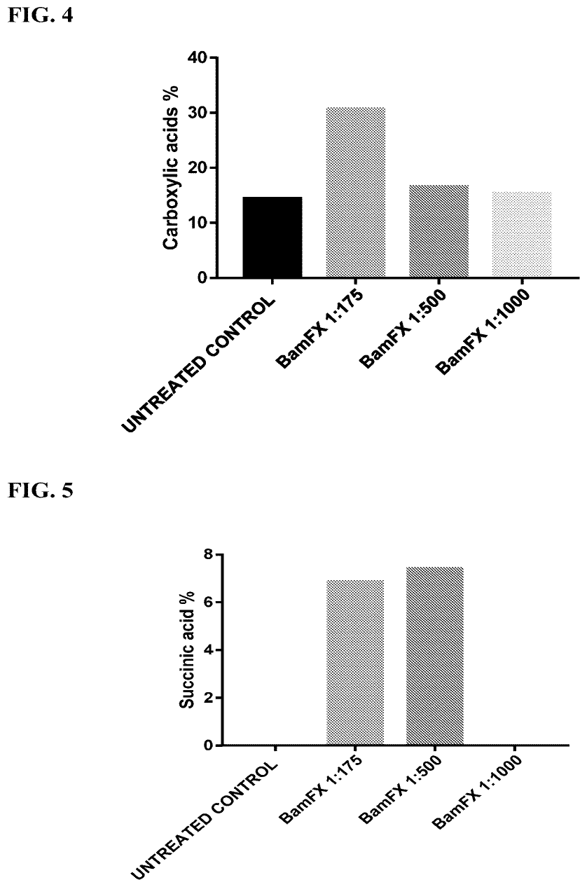

Results show that carboxylic acid percentage increased in BAM-FX treated seeds. In 1:175 diluted BAM-FX treated seeds, carboxylic acids were found 30.71%. In the 1:500 and 1:1000 dilution conditions, the carboxylic acids were found 16.59 and 15.71%, respectively (FIG. 4). The dose dependent effect on carboxylic acid occurrence in the BAM-FX treated seeds.

Results show that succinic acid was found in BAM-FX 1:175 and 1:500 treated seeds at 6.86 and 7.41%, respectively (FIG. 5). Further, propionic acid found 16%, 3.57%, and 13.43% in BAM-FX 1:175, 1:500 and 1:1000, respectively.

Next, experiments were conducted to determine protein expression associated with BAM-FX induced biotic resistance. Gel electrophoretic separation of total protein showed at least three protein bands expressed in BAM-FX treated seedlings as compared to untreated seedlings (data not shown). Seedlings are the early plant growth from seeds as they germinate.

### Example 6: Increased Yield in Tomato Plants Treated with BAM-FX Foliar Spray

BAM-FX was then tested for its efficacy as a fertilizer for tomato plants. In a BAM-FX tomato trial in Aurangpur, Manjarwadi Pure, India, one breed of tomato plant was tested with 88 plants per condition. Tomato plants were treated either by foliar spray alone (100% dose), or foliar spray (50% dose)+drenching. The control group was not treated. Measurements on harvested fruit, stem height, stem diameter, average branch number, average leaf number, number of flowers, total fruit numbers, and seeds with pulp weight were made and are summarized in Table 9.

TABLE 9
Tomato BAM-FX treatment trial results and summary of observations.

| | | Drenching + | Foliar spray | | Yield % |
|---|---|---|---|---|---|
| | | foliar spray | BAM-FX | | spray |
| Observation | | BAN-FX dose | dose | | vs. |
| date | Description | 50% each | 100% | Control | control |
| Dec. 29, 2017 | Total no. of plants | 88 | 88 | 88 | |
| | under test | | | | |
| Feb. 21, 2017 | No. of plants observed | 9 | 9 | 9 | |
| | and harvested fruits | | | | |
| Feb. 21, 2017 | Average stem height | 41.88 | 53.66 | 41.77 | 28% |
| | (last measured) | | | | |
| Feb. 21, 2017 | Average stem diameter | 9.12 | 12.11 | 9.22 | 31% |
| | (last measured) | | | | |
| Feb. 15, 2017 | Average no. of | 20.33 | 35.88 | 16.88 | 113% |
| | branches | | | | |
| Feb. 15, 2017 | No. of flowers (last | 63.44 | 88.11 | 63 | 40% |
| | counted) | | | | |
| Jan. 19, 2017 | Average no. of leaves | 97.33 | 120.33 | 94.33 | 28% |
| | (last counted) | | | | |
| Feb. 27, 2017 | Fruits nos. total all | 23 | 31 | 23 | 35% |
| | sizes | | | | |
| Feb. 27, 2017 | Fruits nos. size < 35 | 5 | 1 | 5 | −80% |
| | mm | | | | |
| Feb. 27, 2017 | Fruits nos. sizes (35 to | 18 | 30 | 18 | 67% |
| | 65 mm) | | | | |
| Feb. 27, 2017 | Fruits nos. sizes > 65 | 0 | 0 | 0 | |
| | mm | | | | |
| Feb. 27, 2017 | Fruits weight total (kg) | 0.83 | 1.2 | 0.81 | 48% |
| Mar. 22, 2017 | Seeds with pulp weight | 12.8 | 23.4 | 12.8 | 82.81% |
| | total in grams | | | | |

The following conclusions were made based on the data and observations. For the same seed breed, RDF (recommended dose of fertilizer) and agricultural practices, BAM-FX improved yield per plant. The performance of plants with BAM-FX foliar spray showed overall better yield in terms of stem size, number of branches, leaves, flowers, fruits, uniformity in fruit size and seed yield. Seed and seed pulp measured together shows 82.81% higher yield in case of foliar spray than control. Plants which received drenching plus foliar spray where half the quantity of BAM-FX was applied through foliar spray and half through drenching showed no better result than control. It could be concluded that less than optimal dose of BAM-FX had no beneficial effect on yield. Drenching may not have been effective due to alkaline soil condition and optimal dose needed to be determined.

### Example 7: Increased Plant Height in Plants Treated with BAM-FX Foliar Spray

Marigold plants were treated with a foliar composition described herein. The variety of marigold was Goldspot 2 ad indus 43. The marigolds were divided into either a control or a BAM-FX foliar spray group. Plant spacing was 4.5×1.5 ft. in a field in Manjarwadi, India. Application rate of BAM-FX was three sprays at 2 ml/L at 15, 30, and 90 days. Results are summarized in Table 10.

TABLE 10
BAM-FX marigold trial results.

| Parameter | POP | POP + Treated at 2 ml |
|---|---|---|
| Plant height (cm) | 92 | 112 |
| Primary branches/plant after 90 | 24 | 28 |
| days | | |
| Average flower weight/plant (kg) | 1.2 | 1.5 |
| Leaf length (cm) | 4.6 | 5.5 |
| Leaf width (cm) | 1.2 | 1.5 |
| Average number of flowers | 61 | 67 |
| Days of 1st flowering pick | 50 | 48 |
| Flower diameter (cm) | 5.90 | 7.30 |
| Chlorophyll (visual observation) | Medium | High |

The following conclusions were made based on the data and observations. Three sprays of BAM-FX at 2 ml/L effectively increased plant height, number of branches, leaf area index, average number of flowers/plant, weight and yield. Spraying of BAM-FX at 2 ml gave a significantly higher yield over existing Package of Practice (POP). BAM-FX did not show any phytotoxic effect on marigold when sprayed at a dose up to 2 nil/Lt.

### Example 8: Effects of Different Test Conditions of DBAM-FX Treatment Methods on Cotton Growth

The effect of BAM-FX on BT Cotton was tested in the Pandhari Pimplegaon District, Aurangabad Maharashtra, India.

The objective of the BT Cotton study was to test four different types of test conditions to determine the efficacy of the composition. The results were also compared to a control group and three different BAM-FX competitors. Each product was applied 3 times by foliar spray.

The results from direct comparison between the control group, three local competitors, and BAM-FX are given in balls of cotton per acre, listed in Table 11.

TABLE 11
BAM-FX cotton trial harvest results.

| | | | | | % Yield over |
|---|---|---|---|---|---|
| Comparison | Parameters | Min | Max | Average | control |
| (C) Control | No. of Balls | 12.00 | 24.00 | 17.37 | 100% |
| (Ag) Agromin | | | | | |
| MAX | No. of Balls | 13.67 | 27.67 | 18.83 | 108% |
| (Bz) Biozyme ® | | | | | |
| crop+ | No. of Balls | 12.67 | 28.33 | 19.50 | 112% |
| (KT) KIECITE G | No. of Balls | 13.67 | 25.33 | 19.40 | 112% |
| (Fx)_BAM-FX | No. of Balls | 16.33 | 29.00 | 22.30 | 128% |

### Example 9: Increased Yield of Cabbage Treated with BAM-FX

The effect of BAM-FX was tested on three different breeds of cabbage in Aurangabad, India.

The testing procedure was as described herein. Three different breeds of cabbage were tested. For each breed, two groups of 13 plants were studied. One group was treated with BAM-FX, and the other group was untreated (control). The quantity of BAM-FX applied by foliar spray was 3.9 mL, and was applied to just adequately cover the visible leaf areas of each plant, one side of the leaf only. The weight of each cabbage head was measured at the end of the trial.

The dosing regimen used for the study was a total of eight weekly sprays. A total of 39 mL of BAM-FX was used, and the dilution rate was gradually increased with each application, biweekly. The dosing amounts are listed in Table 12 and the rate of dilution for spraying is given in Table 13.

TABLE 12
BAM-FX cabbage trial dosage regime.

| | Foliar spray | |
|---|---|---|
| Description | Quantity | Unit |
| Number of plants | 52 | 52 |
| Number of sprays | 8 | No. |
| Interval between | 7 | Days (weekly) |
| spraying | | |
| BAM-FX | 39 | ML |
| Water | 10367 | ML |
| Total (BAM-FX + | 10406 | ML |
| Water) | | |

TABLE 13
BAM-FX cabbage trial dilution regime.

| | Week 1 | Week 2 | Week 3 | Week 4 | Week 5 | Week 6 | Week 7 | Week 8 |
|---|---|---|---|---|---|---|---|---|
| BAM-FX | 3.820 | 3.820 | 3.805 | 3.805 | 3.826 | 3.826 | 3.904 | 3.904 |
| Vol. in ML | | | | | | | | |

The observations from the study are provided in Table 14.

TABLE 14
BAM-FX cabbage trial results.
Cabbage BAM-FX Treatment Trial Results-Observations

| | | | | | Increase | |
|---|---|---|---|---|---|---|
| | | | | BAM- | in | |
| | | | | FX | Yield | |
| | | | Control | treated | (treated- | % |
| | Seed | Test Plant | Weight | Weight | control = | Increase |
| Plot no. | Variety | Sr. no. | (kg) | (kg) | additional) | Yield |
| I | Seed variety- | 1 | 0.94 | 1.1 | 0.16 | 17% |
| | Breed-1 | | | | | |
| I | Seed variety- | 2 | 0.95 | 1.12 | 0.17 | 18% |
| | Breed-1 | | | | | |
| I | Seed variety- | 3 | 1.1 | 1.14 | 0.04 | 4% |
| | Breed-1 | | | | | |
| I | Seed variety- | 4 | 1.15 | 1.26 | 0.11 | 10% |
| | Breed-1 | | | | | |
| A | Average | Seed variety- | 1.035 | 1.155 | 0.12 | 12% |
| | Breed-1 | | | | | |
| II | Seed variety- | 1 | 0.6 | 1.05 | 0.45 | 75% |
| | Breed-2 | | | | | |
| II | Seed variety- | 2 | 0.87 | 1.12 | 0.25 | 29% |
| | Breed-2 | | | | | |
| II | Seed variety- | 3 | 1.04 | 1.55 | 0.51 | 49% |
| | Breed-2 | | | | | |
| II | Seed variety- | 4 | 1.08 | 1.83 | 0.75 | 69% |
| | Breed-2 | | | | | |
| B | Average | Seed variety- | 0.897 | 1.387 | 0.49 | 55% |
| | | Breed-2 | | | | |
| III | Seed variety- | 1 | 0.71 | 1.08 | 0.37 | 52% |
| | Breed-3 | | | | | |
| III | Seed variety- | 2 | 0.81 | 1.15 | 0.34 | 42% |
| | Breed-3 | | | | | |
| III | Seed variety- | 3 | 0.89 | 1.39 | 0.5 | 56% |
| | Breed-3 | | | | | |
| III | Seed variety- | 4 | 1.5 | 1.94 | 0.44 | 29% |
| | Breed-3 | | | | | |
| C | Average | Seed variety- | 0.977 | 1.51 | 0.533 | 55% |
| | | Breed-3 | | | | |
| | AVERAGE | =(A + B + C)/3 | 0.97 | 1.351 | 0.381 | 40% |

Several observations were made at the conclusion of the study. For the same breed, the recommended dose of fertilizer (RDF) and agricultural practices utilized to apply BAM-FX improve yield per plant. In two varieties of seeds tested, the average additional yield was 55% each, and in the third variety it was 12%. The maximum yield improvement was 75%, and the minimum was 4%, and the average was 40%. The average yield improvement was 36% without including the maximum or minimum values. The different yield improvement rate per seed breed indicated a difference in genetic potential for each breed's response to BAM-FX, and/or potential differences in individual seeds.

### Example 10: Increased Yield of Cauliflower Treated with BAM-FX

The effect of BAM-FX was tested on cauliflower in Aurangabad, India.

The testing procedure was as follows. One breed of cauliflower was tested. Two groups of 14 plants were studied. One group was treated with BAM-FX, and the other group was untreated (control). The quantity of BAM-FX applied by foliar spray was 3.9 mL, applied form the top, and was applied to just adequately cover the visible leaf areas of each plant, one side of the leaf only.

The dosing regime used for the study was a total of eight weekly sprays. A total of 11 mL of BAM-FX was used, and the dilution rate was gradually increased with each application, biweekly. The dosing amounts are listed in Table 15 and the rate of dilution for spraying is given in Table 16.

TABLE 15
BAM-FX cauliflower trial dosage regime

| Description | Foliar spray | |
|---|---|---|
| Quantity | Quantity | Unit |
| No of plants under test | 14 | No. |
| Number of sprays | 8 | No. |
| Interval between spraying | 7 | Day (weekly) |
| BAM-FX | 11 | ML |
| Water | 2791 | ML |
| Total (BAM-FX + Water) | 2802 | ML |

TABLE 16
BAM-FX cauliflower trial diluion regime.

| | Week 1 | Week 2 | Week 3 | Week 4 | Week 5 | Week 6 | Week 7 | Week 8 |
|---|---|---|---|---|---|---|---|---|
| Vol. in ML | 3.820 | 3.820 | 3.805 | 3.805 | 3.826 | 3.826 | 3.904 | 3.904 |
| BAM-FX | | | | | | | | |

TABLE 17
BAM-FX cauliflower trial results
Cauliflower BAM-FX Treatment Trial Results-Summary Observations

| | | Foliar spray | | |
|---|---|---|---|---|
| Observation | | BAM-FX | | Yield % Spray |
| Date | Description | dose 100% | Control | v/s control |
| Dec. 29, 2017 | Total no. of | 14 | 14 | |
| | plants under test | | | |
| Feb. 21, 2017 | No. of Plants | 3 | 3 | |
| | observed | | | |
| Jan. 28, 2017 | Average Stem | 11 | 8.3 | 24.58% |
| | height (last | | | |
| | measured) | | | |
| Feb. 21, 2017 | Average Stem | | | |
| | dia (last | | | |
| | measured) | | | |
| Jan. 17, 2017 | Early Curd | 14 | 4 | 100% (28%) |
| | formation | | | |
| Jan. 17, 2017 | Average Curd | 8.5 | 5.7 | 49.12% |
| | dia in cms | | | |
| Jan. 28, 2017 | Early flowering | 14 | 6 | 100% (42%) |
| | stage | | | |
| Feb. 6, 2017 | Plants in | 14 | 7 | 100% (50%) |
| | flowering stage | | | |
| | (last counted) | | | |
| Feb. 15, 2017 | Early legume | 14 | 3 | 100% (21%) |
| | stage | | | |
| Feb. 21, 2017 | Average No. of | 496 | 472 | 4.94% |
| | legumes | | | |

Several observations were made at the conclusion of the study. For the same breed, the recommended dose of fertilizer (RDF) and agricultural practices utilized to apply BAM-FX improves yield per plant. The performance of plants with BAM-FX foliar spray shows over all better yield in terms of stem size, number of branches, leaves, flowers, fruits, uniformity in fruit size, early curd, and seed yield.

### Example 11: Increased Yield of Radish Treated with BAM-FX

The effect of BAM-FX was tested on one breed of radish in a field trial in Aurangabad, India.

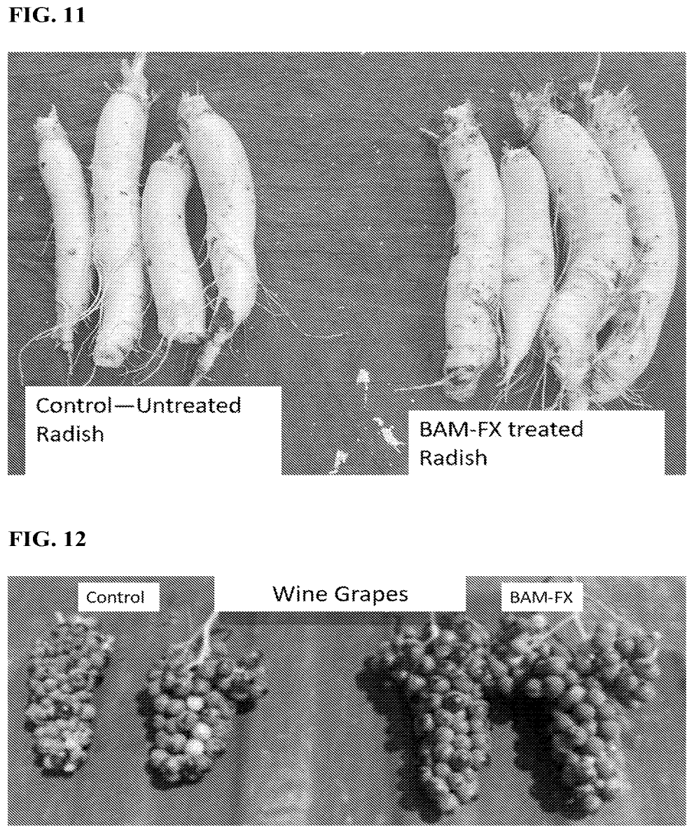

The testing procedure was as follows. One breed of radish was tested. Two groups of 42 plants were studied. One group was treated with BAM-FX, and the other group was untreated (control). The quantity of BAM-FX applied by foliar spray was 3.9 mL diluted in 1 L of water, and was applied to just adequately cover the visible leaf areas of each plant, applied from the top, one side of the leaf only. The weight of root and legume formation were critical factors for yield comparison between the experimental and control groups. Results are shown in FIG. 11.

The dosing regimen used for the study was a total of eight weekly sprays. A total of 16 mL of BAM-FX was used, and the dilution rate was gradually increased with each application, biweekly. The dosing amounts are listed in Table 18.

TABLE 18
BAM-FX radish trial dosage regime.

| | Foliar spray | |
|---|---|---|
| Description | Quantity | Unit |
| No of plants | 21 | Nos. |
| under test | | |
| Number of | 8 | No. |
| sprays | | |
| Interval between | 7 | Days (weekly) |
| spraying | | |
| BAM-FX | 16 | ML |
| Water | 4187 | ML |
| Total (BAM-FX + | 4203 | ML |
| Water) | | |

The observations from the study are provided in Table 19.

TABLE 19
BAM-FX radish trial results.
Radish BAM-FX Treatment Trial Results-Summary Observations

| | | Foliar spray | | Yield % |
|---|---|---|---|---|
| | | BAM- | | Spray |
| Observation | | FX dose | | v/s |
| Date | Description | 100% | Control | control |
| Dec. 29, 2017 | Total no. of plants | 42 | 42 | |
| | under test | | | |
| Feb. 21, 2017 | No. of Plants | 8 | 8 | |
| | observed & | | | |
| | harvested for | | | |
| | roots | | | |
| Feb. 21, 2017 | Average no of | 29 | 24.66 | 17.57% |
| | leaves (last | | | |
| | counted) | | | |
| Feb. 6, 2017 | Average no of | 0 | 4.5 | 21.43% |
| | Deformed plants | | | |
| Feb. 6, 2017 | No of flowering | 12.5 | 7 | 17.10% |
| | stage plants (last | | | |
| | counted) | | | |
| Feb. 21, 2017 | Percentage of | 21 (100%) | 14 (84.85%) | 14.5% |
| | legume producing | | | |
| | plants (after | | | |
| | adjusting for | | | |
| | deformed plants | | | |
| | removed from | | | |
| | control group) | | | |
| Feb. 27, 2017 | Average Root | 31.5 | 27.25 | 15.60% |
| | height (last | | | |
| | measured) in CM | | | |
| Feb. 27, 2017 | Average Root dia | 58.75 | 51.25 | 14.63% |
| | (last measured)in | | | |
| | CM | | | |
| Feb. 27, 2017 | Sample Radish | 1.84 | 1.17 | 57.26% |
| | Root weight Total | | | |
| | in (kg) 4 nos. | | | |
| | each | | | |

Several observations were made at the conclusion of the study. For the same seed breed, the recommended dose of fertilizer (RDF) and agricultural practices utilized to apply BAM-FX improved yield per plant. The performance of plants with BAM-FX foliar spray showed an overall better yield in terms of stem, number leaves, root size, weight, and legume. The root weight showed an average of 57.62% higher yield for the BAM-FX treated plants vs. control plants. The average number of deformities found the in control group roots was 21.43% overall, whereas there were no observed deformities in roots from the BAM-FX treated plants overall.

### Example 12: Increased Yield and Salt Resistance in Rice Treated with BAM-FX

The effect of BAM-FX was tested on rice at Sills Ag Consulting Inc., in Northern California, USA.

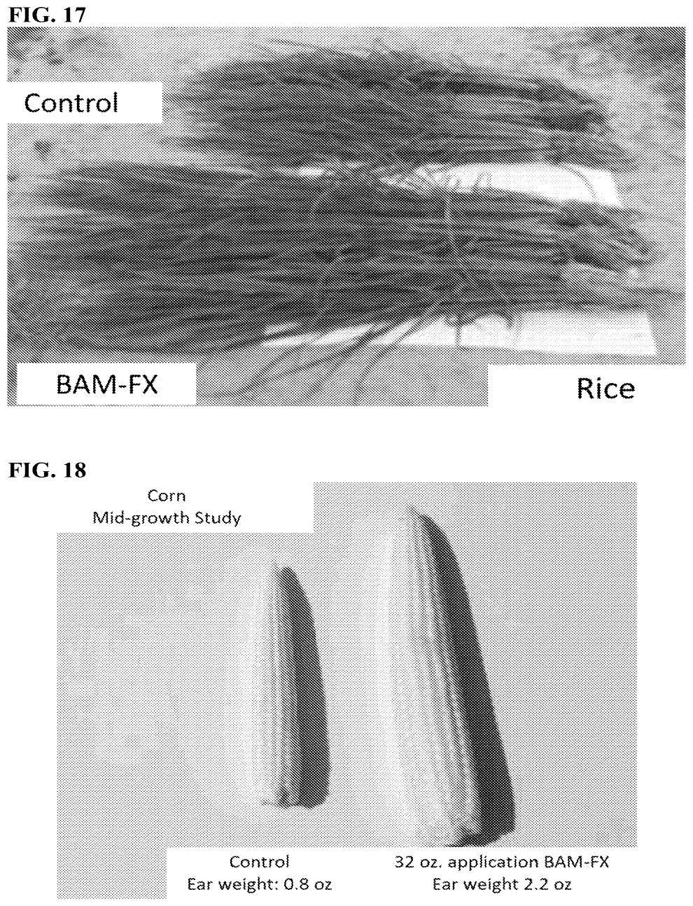

The effect of applying BAM-FX in the flowering (heading) stage versus the mid-tillering phase (mid-vegetative phase) was studied. The resulting increase in yields as compared to standard growing conditions were 19.96% greater for mid-tillering application, and 9.24% for the flowering application, as measured in pounds per acre rice. See FIG. 17.

### Example 13: Increased BRIX in Fruit Treated with BAM-FX

The effect of BAM-FX was tested on chardonnay and Grenache noir grapes, and the study data was assessed in China at Yantai, Junding Chateau and Planting Base and Yantai, Delonghong Chateau and Planting Base, respectively.

A comparison study of chardonnay and grenache noir grapes grown with BAM-FX versus standard growing standard growing conditions was undertaken at two vineyards. BAM-FX was applied three times over the course of the growing season, and the resulting grapes were assessed for their BRIX (sugar) content and acidity. The plants treated with BAM-FX were observed to be healthier in general. The results for the chardonnay grapes are provided in Table 20 and for the Grenache noir grapes in Table 21. See FIG. 12.

TABLE 20
BAM-FX chardonnay grape trial results.

| Treatment | Wine Grape Index | | | |
|---|---|---|---|---|
| (3 times) | Grape varieties | Total Sugar | Total Acid | PH |
| Control | chardonnay | 143 | 6.5 | 3.38 |
| BAM(1:350) | chardonnay | 164 | 6.3 | 3.4 |
| BAM(1:250) | chardonnay | 180 | 6 | 3.44 |
| BAM(1:150) | chardonnay | 183 | 5.7 | 3.52 |

TABLE 21
BAM-FX Grenache noir grape trial results.

| Treatment | Wine Grape Index | | | |
|---|---|---|---|---|
| (3 times) | Grape varieties | Brix | Total Acid | PH |
| Control | Grenache Noir | 20.4 | 4.5 | 3.61 |
| BAM(1:350) | Grenache Noir | 23.6 | 5.8 | 3.48 |
| BAM(1:250) | Grenache Noir | 22.6 | 5.5 | 3.44 |
| BAM(1:150) | Grenache Noir | 21.8 | 4.8 | 3.40 |

These results were further confirmed in trials conducted in Dikshi, Nasik, India where table grape plants were treated with BAM-FX. On average, the BRIX content of BAM-FX treated grapes were about 25% higher than untreated grapes. Furthermore, BAM-FX treated plants yielded a harvest of 60 kg of fruit, while the control group of plants yielded in a harvest of about 48 kg of fruit.

The effect of BAM-FX was similarly tested in watermelon plans in Aurangabad, India. Compared to untreated plants, BAM-FX treatment resulted in watermelons that had approximately 8.3% higher BRIX count compared to untreated plants.

Collectively, these results indicate that BAM-FX may optimize BRIX content in a variety of fruit. In addition to producing higher quality, sweeter fruit, the results show that BAM-FX increases harvest yields.

### Example 14: Increased Yield in Pomegranate Treated with BAM-FX

The effect of BAM-FX was tested on pomegranate in Aurangabad, Manjarwadi, India.

Pomegranate is one of the important fruit crops commercially grown in Maharashtra, India. The varieties that are grown commercially includes Ganesh, G-137 and Mridula. The varieties such as Bhagawa and Phule Arakta have been recommended and released respectively for cultivation in the state.

Extensive survey work on pomegranate orchards indicated that the ‘Bhagawa’ variety of pomegranate is heavy yielder and possesses desirable fruit characters. This variety matures in 180-190 days with average yield of 30.38 kg fruits/tree. Bigger fruit size, sweet, bold and attractive arils, glossy, very attractive saffron colored thick skin makes it suitable for distant markets. This variety was found less susceptible to fruit spots and thrips as compared to other varieties of pomegranate. Thrips refer to insects that feed primarily on plants, and many species of thrips are pests of commercial crops. Certain varieties of thrips may further feed on and redistribute fungal spores. In addition to pomegranates, thrips damage crops including onions, potatoes, tobacco, and cotton, among others.

There is currently no solution to the problem of TELYA disease on pomegranate, also known as bacterial blight. Xanthomonas axonopodis pv punicae is a bacteria responsible for the disease. Symptoms of bacterial blight on young and developing pomegranate fruits. Initially, spots are black and round and surrounded by bacterial ooze. Under favorable conditions, spots enlarge to become raised, dark brown lesions with indefinite margins that cause the fruit to crack. The disease may cause up to 90% yield reduction. The disease occurs widely and outbreaks have been recorded in all major pomegranate-growing states including Maharashtra, Karnataka, and Andhra Pradesh. Bacterial blight of pomegranate affects leaves, twigs, and fruits. Infected fruit and twigs are potential sources of primary inoculum. The secondary spread of bacterium is mainly through rain and spray splashes, irrigation water, pruning tools, humans, and insect vectors. Entry is through wounds and natural openings in the plant or fruit. The first water-soaked lesions develop within 2-3 days and appear as dark red spots. Disease buildup is rapid from July to September. Severity increases during June and July and reaches a maximum in September and October and then declines. Bacterial cells are capable of surviving in soil for >120 days and also survive in fallen leaves during the off-season. High temperatures and low humidity or both favor disease development. Optimal temperature for growth of bacterium is 30° C.; thermal death point is about 52° C.

At the initiation of the study, 15 out of 550 Bhagawa pomegranate trees were infected with bacterial blight. Fruit formation had already started and fruits were nearly half the normal full-grown fruit size. The new fruiting immediately before the BAM-FX spray application was observed to be disease free.

One month after the first BAM-FX spray application, the already healthy trees were observed to have greener leaves, increased fruit size, and increased fruit glossiness. The bacterial blight-infected trees were observed to be recovering overall, the fruit damage was controlled (not spreading to previously uninfected fruit), and new leaf formation started. The application of BAM-FX prevented the infected trees from being uprooted and destroyed in order to control the spread of bacterial blight to healthy trees.

### Example 15: Summary of Results from Crops Treated with BAM-FX

BAM-FX formulations have been tested in a variety of crops for a wide range of applications.

The effect of BAM-FX on root development has been confirmed in numerous varieties of plants. Spinach, tomato, lettuce, corn, and winter wheat plants treated with BAM-FX all displayed thicker, heavier root systems compared to their untreated counterparts. Similarly, BAM-FX application to broccoli seeds in a trial aboard the International Space Station resulted in longer root growth for treated broccoli compared to untreated plants in the same zero gravity conditions.

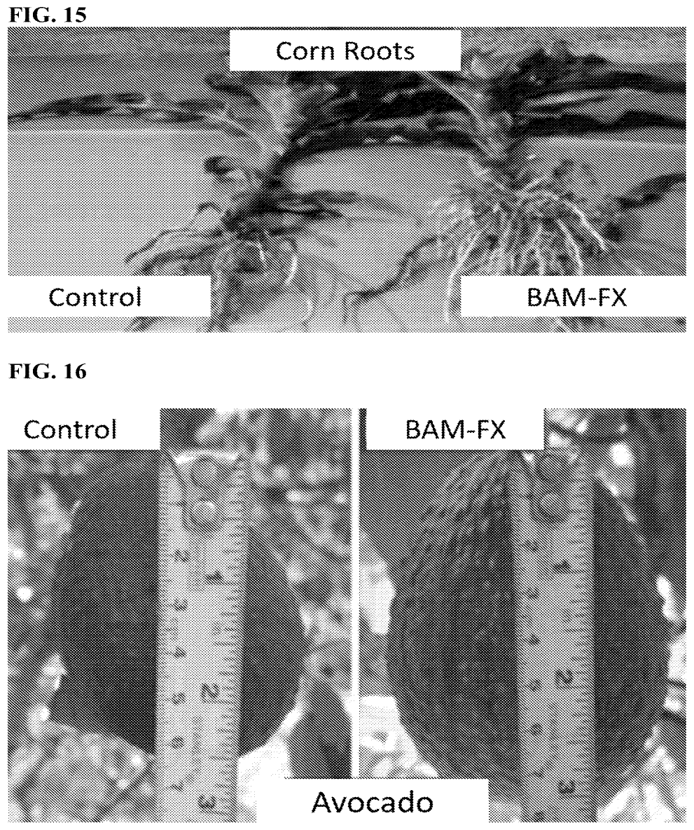

BAM-FX showed similarly beneficial results in corn plants. See FIG. 15 and FIG. 18. Corn plants subjected to treatment yielded larger root clusters at harvest than a control group of corn. At the midpoint of the study, BAM-FX effect on corn ear yield was assessed, and results showed that BAM-FX-treated plants yielded ears at an average of 2.2 oz., while the control plants yielded ears at an average of 0.8 oz.

Moreover, BAM-FX application has shown to improve height, overall size, and quality of treated plants. For instance, impatiens plants treated with BAM-FX displayed increased chlorophyll content in their leaves. See FIG. 19. The treated plants were also larger, and were generally more robust compared to untreated impatiens. Higher chlorophyll levels were also seen in the leaves of treated wine grape plants and marigolds. Furthermore, BAM-FX treated tobacco plants yielded larger leaves at harvest than control plants that did not receive treatment. See FIG. 14.

Similarly, in a BAM-FX trial for cannabis plants in Aurora, Colorado, plant growth was improved, in addition to disease resistance. For instance, BAM-FX treated cannabis plants were shown have resistance to fungus and gnat invaders compared to the untreated controls. Furthermore, the plants treated with BAM-FX had improved plant quality, including denser leaves.

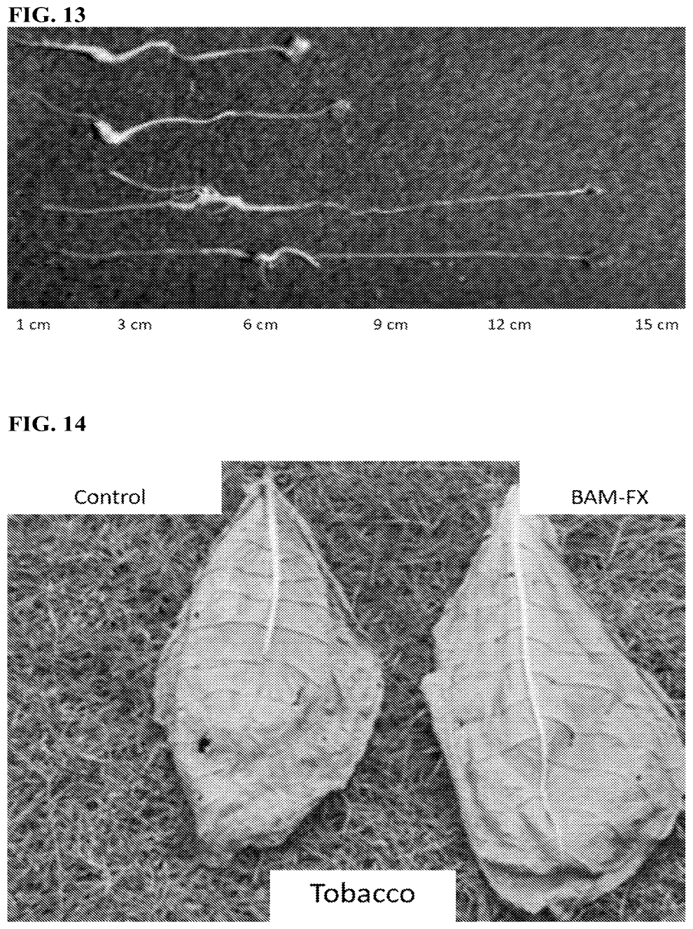

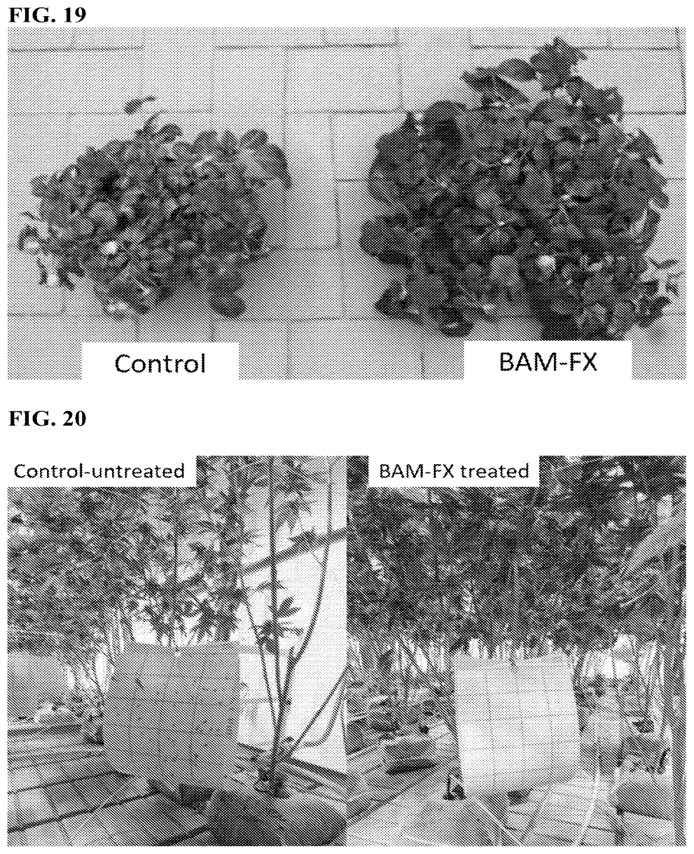

The summary of results for a variety of plants, fruits and crops described herein are provided in Tables 22 and 23 below. BAM-FX trial results summary for spinach, rice, mandarin citrus tree, avocado, almonds, orange tree, tomato, cabbage, cotton, cannabis, strawberry, cannabis, wine grapes, and grapes are provided in Table 22. Results were measured by a third, independent party from the growers and Zero Gravity. Improvements in several crops after BAM-FX treatment as compared to control crops is provided in Table 23. See FIGS. 2 and 11-20.

TABLE 22
BAM-FX trial results summary.

| | | Post-Harvest Analysis(3rd | % Yield Increase (BAM- |
|---|---|---|---|
| Crop | Location | Party Results) | FX vs. Std.) |
| Spinach | Rios Farms | 18.18% increase in financial | 20% (pounds/acre) |
| | Monterey County, | gains per acre vs. control. | |
| | CA | | |
| Rice | Sills Ag | BAM-FX applied at mid- | 19.96% (at mid-tillering |
| | Consulting, Inc. | tillering (mid-vegetative) | stage)9.24% when applied |
| | Northern California | resulted in the highest yield | during heading/flowering |
| | | response, indicating earlier | stage (pounds/acre) |
| | | applications of BAM-FX | |
| | | results in a greater yield | |
| | | response. | |
| Mandarin | Temecula, CA | Lower fertilizer cost and | Avg. Fruit count −100% |
| Citrus(Kishu | | usage plus higher yield and | Avg. Fruit Size −33% |
| trees) | | more robust fruit 16% Brix | |
| | | content increase vs control | |
| | | and higher ROI. | |
| Avacodo | Temecula, CA | As a result of just one | 57.1% (weight) 134% |
| | | season's application of | (avg. fruit count vs |
| | | BAM-FX leaf analysis | control) |
| | | conducted by Fruit Growers | |
| | | Lab, Inc. showed BAM-FX | |
| | | increased Zinc and Nitrogen | |
| | | levels, reduced Chloride | |
| | | levels while improving the | |
| | | Phosphorus to Zinc ratio. | |
| | | The BAM-FX treated trees | |
| | | exhibited significantly | |
| | | improved vitality expressed | |
| | | by growth, fruit yield and | |
| | | quality. | |
| Almonds | Sanger, CA | Using BAM-FX as a | 33% (Pounds/acre)BAM- |
| | | standalone increased fruit set | FX standalone vs |
| | | %, number of fruit per foot, | unsprayed control |
| | | overall fruit weight and yield | |
| | | versus the unsprayed control. | |
| Oranges | Sanger, CA | Both fruit set % and number | 36.6% (BAM-FX vs |
| | | of fruit per square foot was | control lbs/acre)19.1% |
| | | highest in the BAM-FX | (BAM-FX vs BAM-FX |
| | | treatment only and lowest in | mixed with Hye-Green |
| | | the control. Total weight per | 21-21-21, lbs/acre) |
| | | plot and total number of fruit | |
| | | per plot was highest in the | |
| | | BAM-FX only treatment and | |
| | | lowest in the Hye-Green 21- | |
| | | 21-21 only treatment. Brix | |
| | | content increased by just | |
| | | under 1% vs control. | |
| Tomato | Aurangabad | Fraction of fruit 35 mm or | 48%(weight)67% (avg. |
| | Maharashtra, India | larger increased. BAM-FX | size) |
| | | increased sizes of stems and | |
| | | uniformity in fruit size; and | |
| | | numbers of branches, leaves, | |
| | | flowers, and fruits. | |
| Cabbage | Aurangabad | Visually noticeable benefits | 40% (weight in kgs.) |
| | Maharashtra, India | of BAM-FX vs control in all | |
| | | stages of growth. | |
| Cotton | Aurangabad | 4 separate trials, including a | 28.3% vs control (number |
| | Maharashtra, India | foliar trial with 30% | of bolts) |
| | | reduction in fertilizer, which | |
| | | yielded 12.19% | vs control. |
| | | Comparison trial was | |
| | | performed against the | |
| | | effectiveness of other | |
| | | BioStimulants. BAM-FX | |
| | | yielded 34.6% higher than | |
| | | the next leading | |
| | | BioStimulant. | |
| Cannabis | Fulsol Farms | At an avg. price of | 44.75% (avg. dry-flower |
| | Humboldt, CA | $1200/pound, ROI | increased weight) |
| | | $182 per plant. | |
| Strawberry | Savino Farms Santa | 5% increase in Brix content | 21.3% (crates/acre) |
| | Maria, CA | vs. control. | |
| Cannabis | CW Analytical | Average control showed | 23.02% (measured in total |
| | Laboratories | 15.76% yield in total | cannabinoids) |
| | | cannabinoids | |
| Wine Grapes | Arroyo Seco | Brix increase by an avg. of | 33.95% (weight)40 Acre |
| | Greenfield, CA | 1.8%.BAM-FX established | Test |
| | | an overall healthier | |
| | | environment and soil quality | |
| | | to allow growth and for the | |
| | | plants to maximize | |
| | | chlorophyll levels and stress | |
| | | tolerances. (FIG. 12) | |
| Grapes | Vaishnavi Agro | Brix content along with yield | 25% (weight) |
| | Clinic India | increased by 25% | |

TABLE 23
Improvements in several crops after BAM-FX
treatment as compared to control crops.

| Crop | Results |
|---|---|
| Cannabis | 44.75% dry flower weight |
| Marigold | 21.7% height, 9.8% flower count, 23.7% diameter |
| Strawberry | 21.3% crates/acre, 5% increase in average BRIX |
| Table Grape | 25% weight, 25% average BRIX increase |
| Tobacco | 50% dry weight vs. control |
| Tomato | 48% weight |
| Tomato Seed | 82.81% weight |
| Wine Grape | 33.95% weight |

These data indicate that BAM-FX may be used for a variety of applications, including disease prevention, fertilization, and improving general quality and disease resistance of plants in a variety of environments.

### Example 16: BAM-FX and BAM-O Citrus for Use in Treating Citrus Greening Disease

Huanglongbing (HBL), also known as citrus greening, was first documented in 1919, in Guangdong Province in south China. Observers saw symptoms that characterize HLB today: infected trees develop mottled yellow leaves, yellow shoots, and small, lopsided green fruits that drop early. As the fruits begin to mature, instead of signaling their ripened state by turning yellow or orange from the bottom up, the color change often starts at the top, where the fruits attach to the stem. HLB attacks a tree's phloem—the vascular tissue that it uses to transport nutrients—so infected trees don't grow at the rate of healthy ones, and their canopies become sparse. Although they appear healthy initially, trees with HLB become unproductive within a few years, as the phloem becomes affected and clogged.

The culprit behind the widespread disease is a microbe called Candidatus Liberibacter asiaticus, or CLas, which comes from a family of bacteria that can wreck potatoes and other economically important crops. CLas reproduces and hides in citrus trees' phloem.

BAM-FX and BAM-O were investigated for their efficacy in controlling and mitigating citrus greening disease. BAM-FX is the liquid formulation described in Example 1. BAM-O is a liquid formulation using BAM-dry formulation and made into a liquid formulation without sulfuric acid and without ammonium sulfate and with organic acid.

Application frequency for the study was 4 applications on Day 0, Day 7, Day 14, and 21, and formulations were prepared as follows:

BAM-FX liquid was prepared at a concentration of 1 oz per gallon. For 1 application on 30-45 trees (1 row), 16 gallons of preparation was sufficient.

BAM-O liquid was prepared by taking BAM-dry formulation dissolved to a concentration of 1 oz per gallon. For a 1:250 solution, 2 kg was dissolved in 2.1 gallons of deionized water. For a 1.500 solution, 4 kg was reconstituted in 2.1 Gallons, and 1 oz of this solution was diluted in a gallon of water. For 1 application on 30-45 trees (1 row), 16 gallons of preparation was sufficient.

A total of four rows of trees were treated. Rows 1 and 2 were treated with BAM-MX row 3 was treated with the 1:500 solution of 4BAM-O and row 4 was treated with the 1:250 solution of BAM-O. Treatment conditions are as shown in Table 24.

TABLE 24
Citrus greening study sampling and treatment conditions

| | Sampling | | |
|---|---|---|---|
| Row-Date | Frequency | Product | Application Rate |
| 1 & 2 (BAM-FX) STAGE 1 | Day 0, 7, 14, 21, | BAM-FX Lot: | 1 oz per Gallon, 16 |
| Day 0: Sep. 11, 2019 1^{st} Application | 28, 35, 42, 49 & 56 | 71119-1 Liquid | Gallons total |
| Day 7: Sep. 18, 2019 2^{nd} Application | | | preparation |
| Day 14: Sep. 25, 2019 3^{rd} Application | | | 4 weekly |
| Day 21: Oct. 2, 2019 4^{th} Application | | | applications |
| Day 28: Oct. 9, 2019 Observation and Sample | | | |
| Day 35: Oct. 16, 2019 Observation and Sample | | | |
| Day 42: Oct. 23, 2019 Observation and Sample | | | |
| Day 49: Oct. 30, 2019 Observation | | | |
| Day 56: Nov. 6, 2019 Observation and Sample | | | |
| 3 (BAM-O 1:500) STAGE 1 | Day 0, 7, 14, 21, | BAM-O Lot: | 2 Kg dissolved on |
| Day 0: Sep. 18, 2019 1^{st} Application | 28, 35, 42, 49 & 56 | 80119-1 Dry | 2.1 gallons of |
| Day 7: Sep. 25, 2019 2^{nd} Application | | Powder | water, 1 oz per Gal. |
| Day 14: Oct. 2, 2019 3^{rd} Application | | formulation | 1:500 4 weekly |
| Day 21: Oct. 9, 2019 4^{th} Application | | | applications |
| Day 28: Oct. 16, 2019 Observation and Sample | | | |
| Day 35: Oct. 23, 2019 Observation and Sample | | | |
| Day 42: Oct. 30, 2019 Observation and Sample | | | |
| Day 49: Nov. 6, 2019 Observation and Sample | | | |
| 4 (BAM-O 1:250) STAGE 1 | Day 0, 7, 14, 21, | BAM-O Lot: | 4 Kg dissolved on |
| Day 0: Sep. 25, 2019 Application | 28, 35, 42, 49 & 56 | 80119-1 Dry | 2.1 gallons of |
| Day 7: Oct. 2, 2019 Application | | Powder | water, 1 oz per Gal. |
| Day 14: Oct. 9, 2019 Application | | formulation | 1:250 4 weekly |
| Day 21: Oct. 16, 2019 Application | | | applications |
| Day 28: Oct. 23, 2019 Observation and Sample | | | |
| Day 35: Oct. 30, 2019 Observation and Sample | | | |
| Day 42: Nov. 6, 2019 Observation and Sample | | | |

The following parameters were assessed following application: excessive shedding, evidence of new growth, weather conditions, evident bio stimulation and priming, iodine-based starch test (HLB Testing), diagnosing huanglongbing, PCR confirmation (CT and titer quantification.

Sampling and observations were conducted for a maximum of 60 days after Day 0 (first application). Samples were analyzed on the same day of collection unless they were preserved under refrigerated conditions (no longer than 7 days).

Prior to treatment, leaves were yellowing and dropping from the trees. Further, fruit showed signed of disease, and there was fruit drop observed from some of the affected trees.

As early as Day 7 of treatment with BAM-FX, improvement to citrus tree health was observed. New leaf growth was observed on Day 7 and by Day 14, significant growth was observed both in the interior and exterior of the tree. Growth continued significantly following Day 17, and by Day 28, it was observed that a severely infected tree displayed significant new leaf growth.

BAM-O application similarly showed some new leaf growth as early as Day 7 of treatment. By Day 14, higher amounts of new growth was observed. On Day 21, even heavily infected trees show improvement, which continued to Day 35.

Results from the study are as shown in Table 24. HLB Positive indicates presence of starch accumulation or high bacterial load and HLB Negative indicates no signs of starch accumulation or low to none bacterial load.

HBL testing included measurement of starch levels in citrus leaves. One of the most prominent characteristics of huanglongbing (HLB or citrus greening)-affected citrus trees is the abundant starch accumulation in photosynthetic cells and all other remaining parenchyma cells of aerial parts. Under natural conditions, citrus leaves store very low levels of starch and detectable amounts are only seen as a result of zinc deficiency or accidental girdling of branches. Therefore, leaf starch concentrations over a threshold level should indicate the presence of HLB.

In HLB-affected trees, starch accumulates for some time before a tree tests positive using PCR. Thus, the distribution of starch for HLB-negative trees partially overlaps the distribution of starch for HLB positive trees (Turechek et al., 2009). Just as it takes time for starch to accumulate in the leaves, the likelihood of selecting a leaf that will test positive for CLas when the tree is HLB-positive increases as the titer of CLas increases. The distributions of starch values from HLB-positive and HLB-negative trees are each considered to be normally distributed.

Concurrent with starch accumulation in aerial parts, the depletion of carbohydrate reserves from the root system not only reflects a general disturbance in carbohydrate metabolism but is also believed to be a main reason for HLB associated tree senescence (Achor et al., 2010; Etxeberria et al., 2009). The elevated levels of leaf starch resulting from CLas infection have been associated with HLB symptoms in citrus trees (Etxeberria et al., 2009; Onuki et al., 2002; Taba et al., 2006; Takushi t al., 2007). These tests are based on the binding of iodine to starch, resulting in a blue/purple-colored solution (McGrane Lt al., 1998). The results shown in Table 25 are indicative of HLB infection or recovery.

TABLE 25
BAM-FX and BAM-O treatment results for citrus greening

| | | |
|---|---|---|
| Treatment | Days after Treatment | Biomass Response |

BAM-FX

| | | |
|---|---|---|
| BAM-FX (1^{st} Application) | 0 | HLB Positive |
| BAM-FX (2^{st} Application) | 7 | HLB Positive |
| BAM-FX (3^{rd} Application) | 14 | HLB Questionable |
| BAM-FX (4^{th} Application) | 21 | HLB Questionable |
| RAM-FX | 28 | HLB Negative |
| BAM-FX | 35 | HLB Negative |
| BAM-FX | 42 | HLB Negative |
| BAM-FX | 56 | HLB Negative |

BAM-O 1:500 (Half Strength)

| | | |
|---|---|---|
| BAM-O 1:500 (1^{st} Application) | 0 | HLB Positive |
| BAM-O 1:500 (2^{st} Application) | 7 | HLB Positive |
| BAM-O 1:500 (3^{rd} Application) | 14 | HLB Positive |
| BAM-O 1:500 (4^{th} Application) | 21 | HLB Positive |
| BAM-O 1:500 | 28 | HLB Negative |
| BAM-O 1:500 | 35 | HLB Questionable |
| BAM-O 1:500 | 42 | HLB Negative |
| BAM-O 1:500 | 49 | HLB Negative |

BAM-O 1:250 (Full Strength)

| | | |
|---|---|---|
| BAM-O 1:250 (1^{st} Application) | 0 | HLB Positive |
| BAM-O 1:250 (2^{st} Application) | 7 | HLB Positive |
| BAM-O 1:250 (3^{rd} Application) | 14 | HLB Positive |
| BAM-O 1:250 (4^{th} Application) | 21 | HLB Questionable |
| BAM-O 1:250 | 28 | HLB Negative |
| BAM-O 1:250 | 35 | HLB Negative |
| BAM-O 1:250 | 42 | HLB Negative |

The results indicate that both BAM-O and BAM-FX were effective in treating HLB in citrus trees. Further, the formulations reversed damage done to citrus trees by promoting new leaf growth, even in severely damaged plants.

### Example 16. Effect of BAM-FX—Seed Treatment

The purpose of this experiment was to analyze biomarker induction, particularly carboxylic acids, in seeds. BAM-FX was tested on Okra and Tomato seeds. BAM-FX dilutions were prepared at concentrations of 1:175 and 1:500. Seeds were soaked in BAM-FX solutions for 30 min at room temperature.

Seeds were soaked in BAM-FX solutions for 30 min at room temperature. A first dish included control untreated seeds. A second dish included okra seeds that were soaked in 1:175 BAM-FX for 30 min. A third dish included okra seeds soaked in 1:500 BAM-FX for 30 min. A fourth dish included tomato seeds soaked in 1:175 BAM-FX for 30 min. Finally, a fifth dish included tomato seeds soaked in 1:500 BAM-FX for 30 min

The seeds were crushed to a powder, and 1 ml of 1:0.2 methanol:chloroform solution was added to 1 g of the crushed seed powder. The mixture was sonicated for 15 min at 40 Htz at 30 C. Extraction of the biomarkers was completed with a cold methanol procedure. After 24 hours, methyl esters were prepared and subject to GCMS analysis.

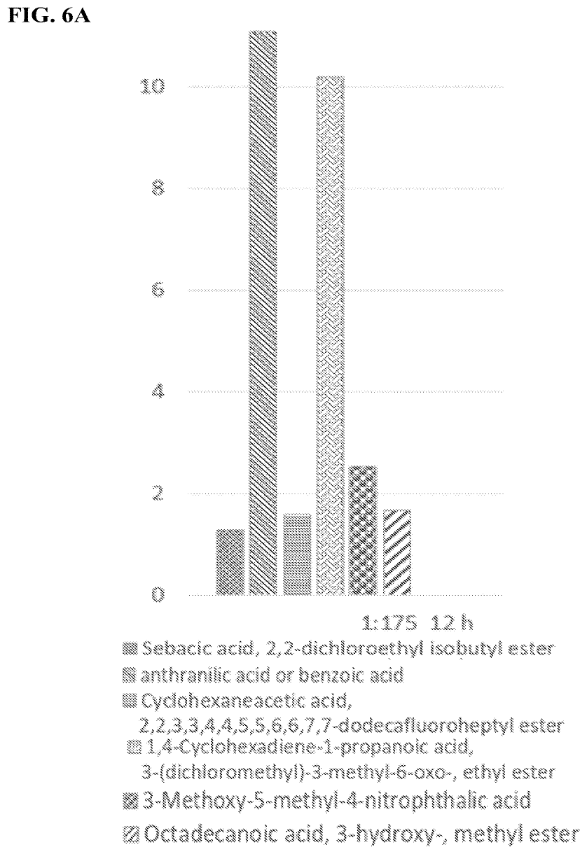

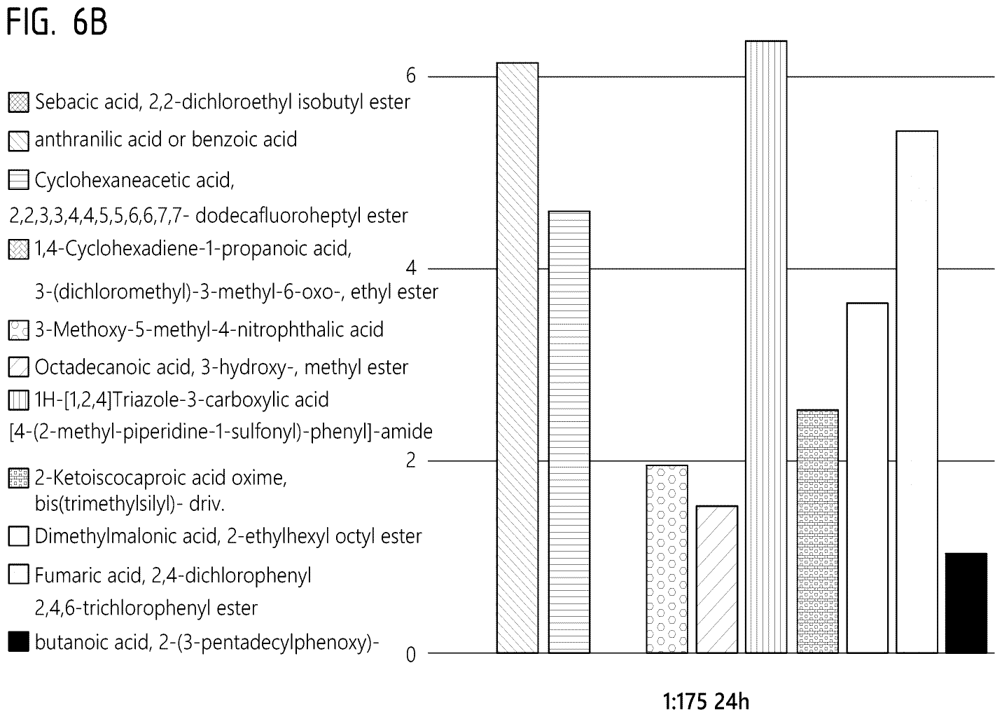

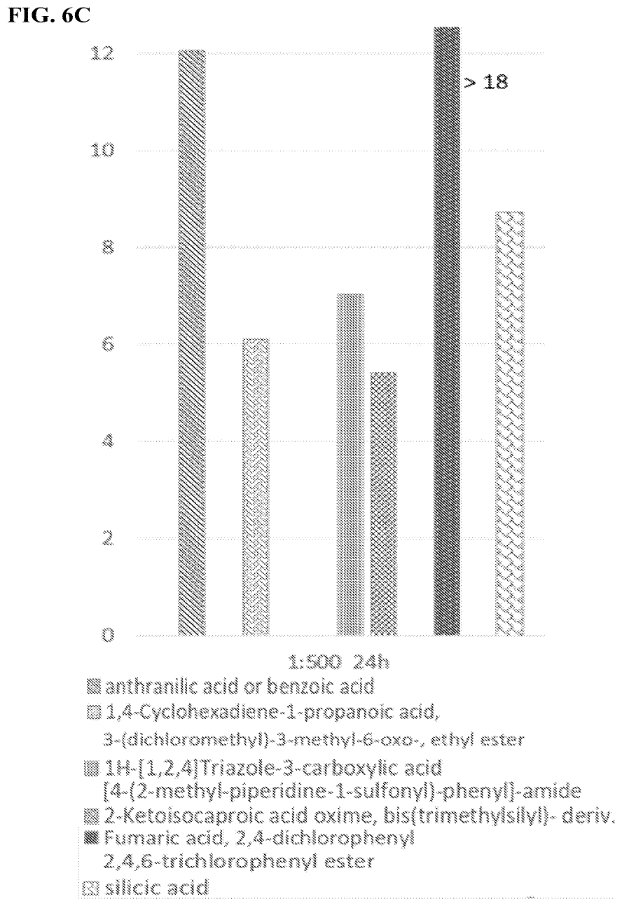

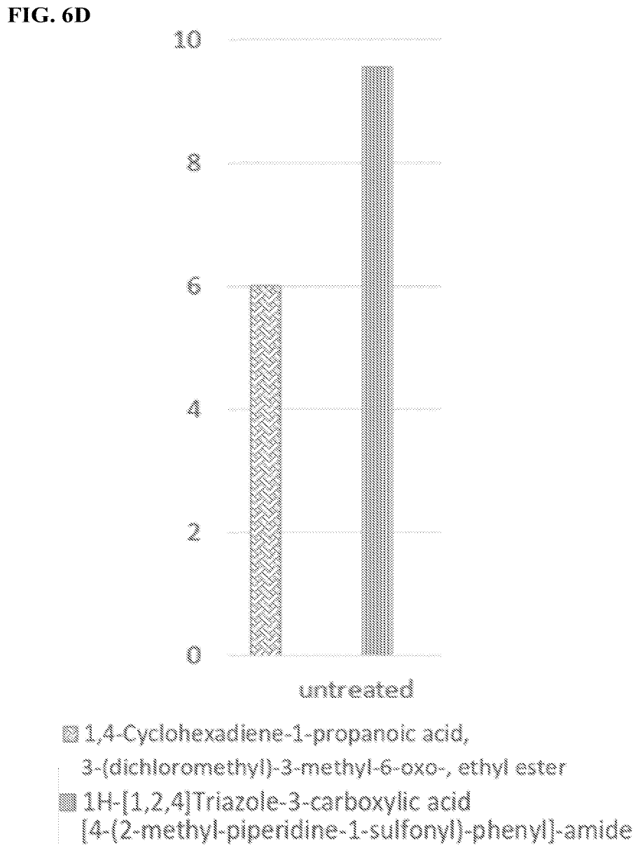

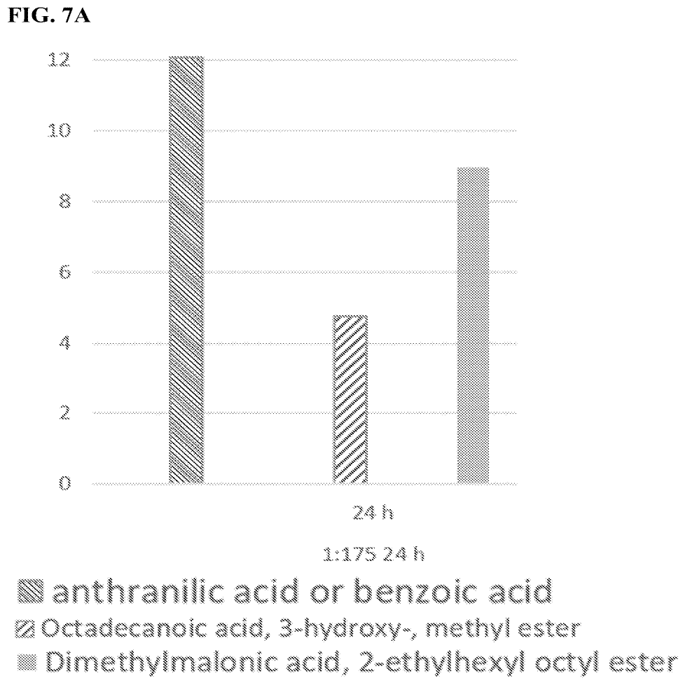

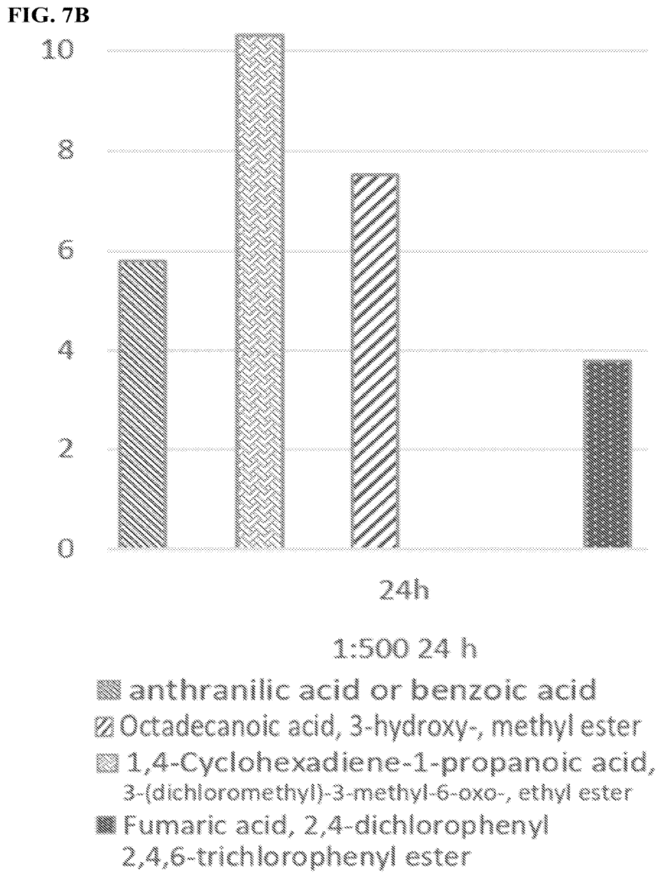

FIGS. 6A-6E shows results for the okra seeds in the study. The results show that sebacic acid, 2,2-dichloroethyl isobutyl ester levels are particularly elevated in treated okra seeds compared to untreated okra seeds. FIGS. 7A-7C shows results for the tomato seeds in the study. The results show that among other markers, sebacic acid, 2,2-dichloroethyl isobutyl ester and anthranilic acid or benzoic acid levels are particularly elevated in treated tomato seeds compared to untreated tomato seeds.

Seeds were similarly prepared for LCMS analysis. Seeds were soaked in BAM-FX solutions for 30 min at room temperature. A first dish included control untreated seeds. A first dish included control untreated seeds. A second dish included okra seeds that were soaked in 1:175 for 30 min. A third dish included okra seeds soaked in 1:500 for 30 min. A fourth dish included tomato seeds soaked in 1:175 for 30 min. A fifth dish included tomato seeds soaked in 1:500 for 30 min. A sixth dish included Okra seeds treated with 1 mL of Aspergillus sp. The sixth dish served as a positive control since fungus is known to cause biotic stress in plants, thereby inducing production of biomarkers.

Seeds were sowed in soil pots. From each soil pot, 10 seeds were collected after 24 hours and 7 days growth. Seeds were then crushed to a powder. Subsequently, 1 ml of 1:0.2 methanol: chloroform was added to 1 g of the crushed powder. The mixture was sonicated for 15 min at 40 Htz. 30 C, and an extraction was completed with the cold methanol procedure. After 24 hours, samples were analyzed by LCMS.

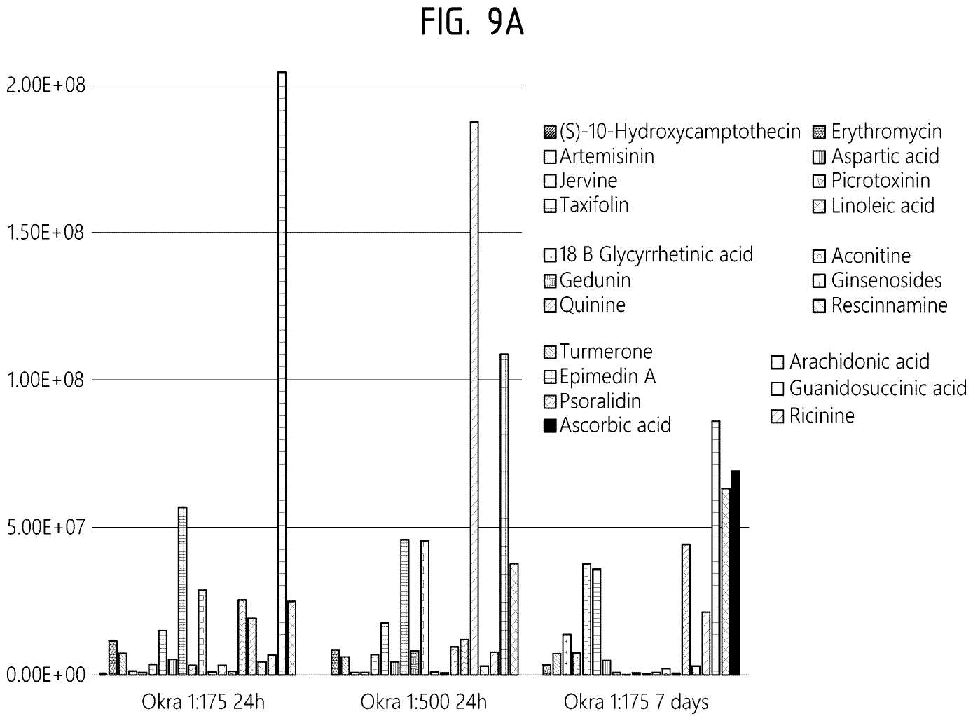

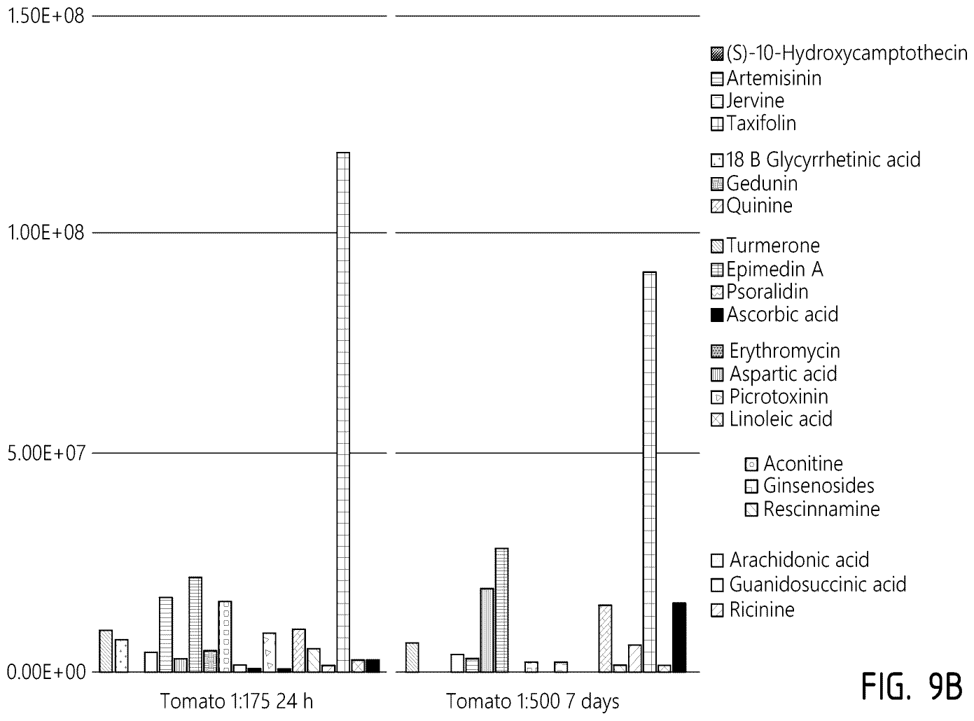

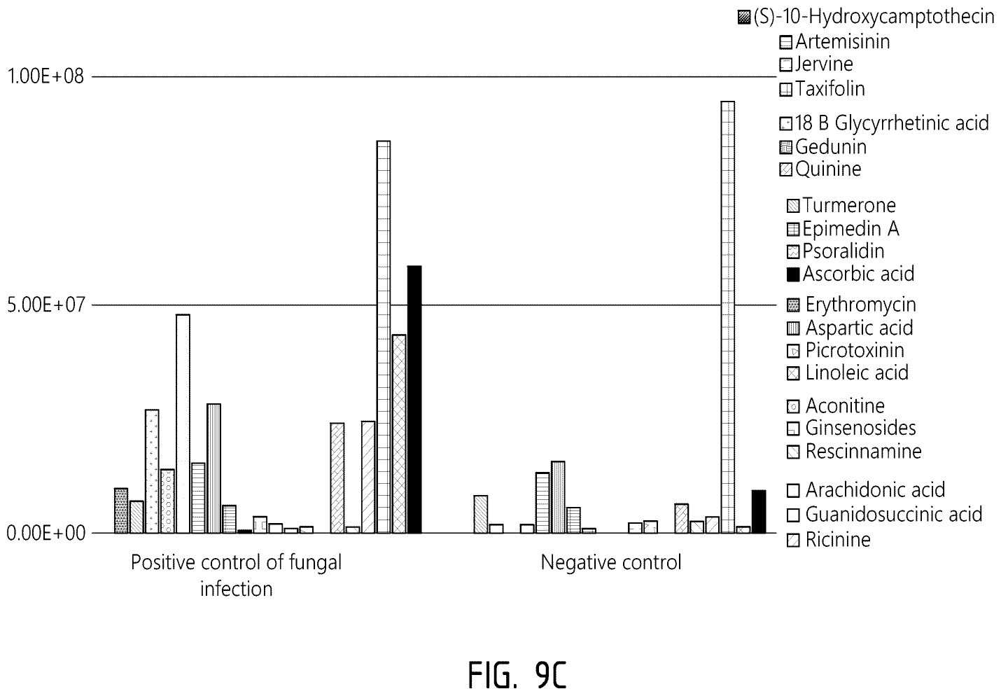

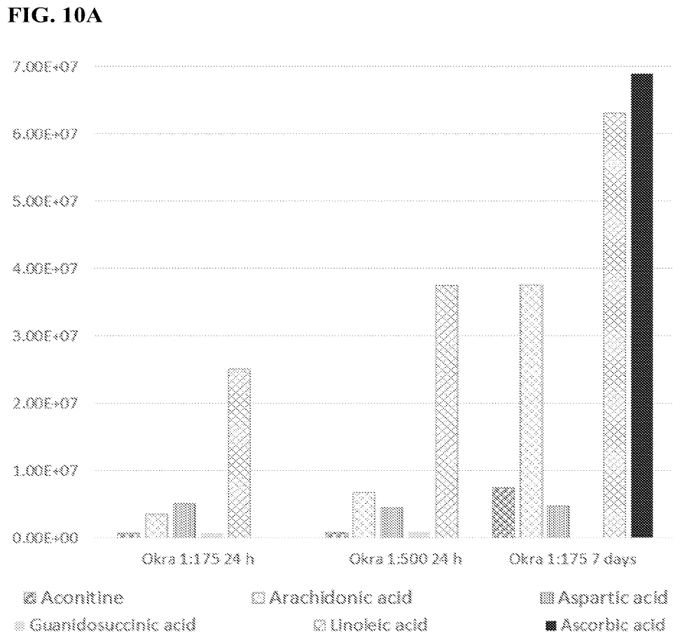

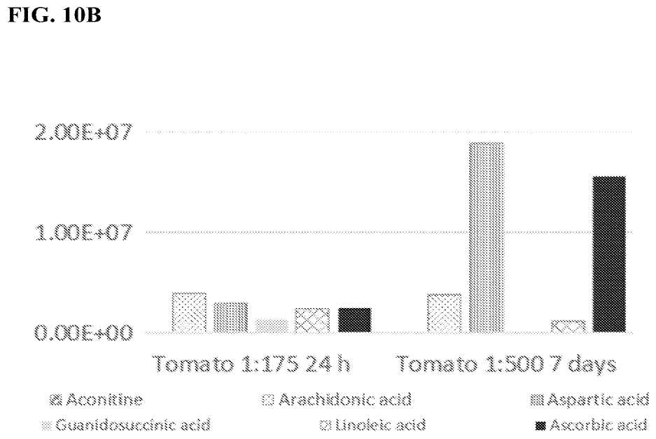

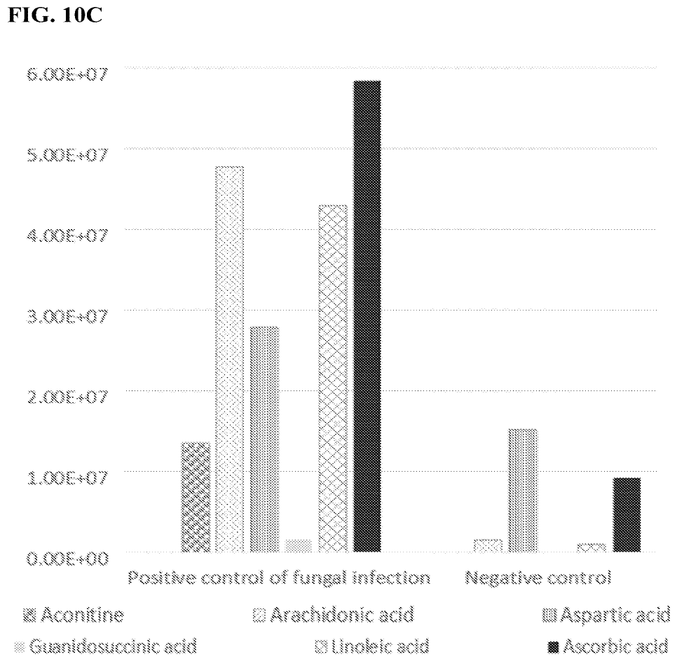

FIGS. 9A-9D show results for the study. The results indicate that production of several biomarkers, including Epoimedin A, Ginseenosides, Quinine, and Taxifolin are produced in particularly high levels upon treatment with BAM-FX.

### Example 17. Effect of BAM-FX—Leaf Treatment

The purpose of this study was the analyze carboxylic acid induction in full grown chili plants.

BAM-FX dilutions were prepared (1:250). A first group included three plants that were untreated controls. A second group included three plants whose leaves were sprayed with BAM-FX (1:250). After 24 hours, leaves were collected from each groups and kept at −80 C for 12 hours. After 12 hours of incubation at low temperature, leaf paste was prepared. 1 ml of 1:0.2 methanol: chloroform solution was added to 1 g of the crushed leaf paste. This mixture was sonicated for 15 min at 40 Htz at 30 C. Extraction with cold methanol procedure was completed. After 24 hours, methyl esters were prepared and subjected to GCMS analysis.

On the seventh day, leaf samples were collected again and analyzed by preparing the leaf paste and cold methanol extraction.

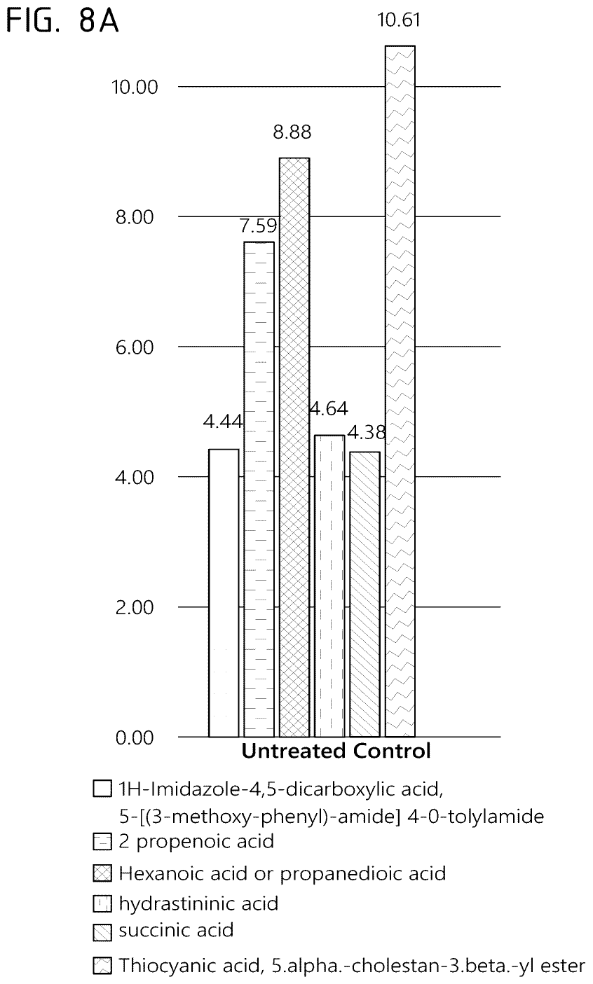

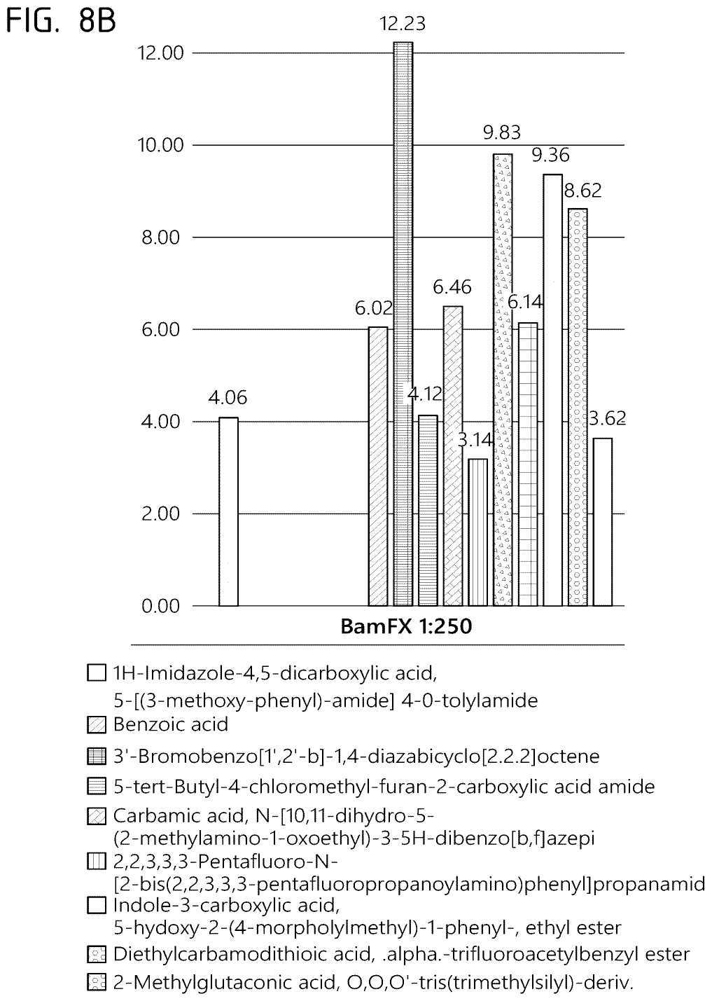

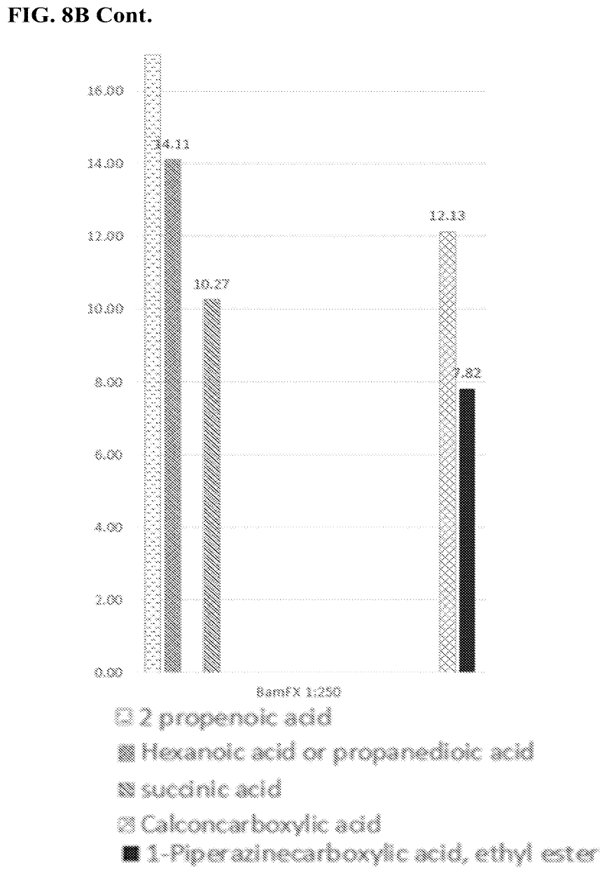

FIG. 8 shows the results for the study. The results show that among other acids, Indole-3-carboxylic acid, 5-hydroxy-2-(4-morpholylmethyl)-1-phenyl-, ethyl ester is particularly elevated in treated plants compared to untreated plants.

What is claimed is:

1. A composition comprising zinc, copper, and an acid, wherein the acid is selected from citric acid, sulfuric acid, oxalic acid, humic acid, fulvic acid, boric acid, acetic acid, and a combination thereof, and optionally ammonium sulfate, wherein the ratio of copper to zinc is between 1:2 and 1:20, and wherein said composition has plant priming activity.

2. The composition of claim 0, wherein the ratio of copper to zinc is between 1:3 and 1:10.

3. The composition of claim 0, wherein the ratio of copper to zinc is 1:3.

4. The composition of claim 0, wherein the ratio of copper to zinc is 1:5.

5. The composition of claim 0, wherein the ratio of copper to zinc is 1:10.

6. The composition of claim 1, wherein the zinc is zinc sulfate monohydrate (ZnSO₄—H₂O).

7. The composition of claim 6, wherein the zinc sulfate monohydrate (ZnSO₄·H₂O) has a zinc content of 36%.

8. The composition of claim 1, wherein the copper is copper (II) sulfate pentahydrate (CuSO₄·5H₂O).

9. The composition of claim 7, wherein the copper (II) sulfate pentahydrate (CuSO₄·5H₂O) has a copper content of 25%.

10. The composition of claim 1, further comprising iron.

11. The composition of claim 10, wherein the ratio of ratio of copper to zinc to iron is 1:3:1.

12. The composition of claim 10, wherein the iron is iron (II) sulfate heptahydrate (FeSO₄·7H₂O).

13. The composition of claim 1, wherein the acid is between about 0.1% and 20% of the total weight.

14. The composition of claim 1, wherein the acid is citric acid.

15. The composition of claim 14, wherein the citric acid is between about 5% and 10% of the total weight.

16. The composition of claim 1, wherein the acid is fulvic acid.

17. The composition of claim 16, wherein the fulvic acid is between about 1% and about 5% of the total weight.

18. The composition of claim 1, wherein the acid is boric acid.

19. The composition of claim 18, wherein the boric acid is between about 0.1% and about 1% of the total weight.

20. The composition of claim 1, further comprising a binding agent.

21. The composition of claim 18, wherein the binding agent is selected from molasses, gum, native starch, and modified starch.

22. The composition of claim 1, wherein the composition does not comprise ammonium sulfate.

23. The composition of claim 1, wherein the acid is not sulfuric acid.

24. The composition of claim 1, wherein the composition is formulated as a dry powder.

25. A composition comprising zinc sulfate monohydrate (ZnSO₄·H₂O), copper (II) sulfate pentahydrate (CuSO₄·5H₂O), and an acid, wherein the acid is selected from citric acid, sulfuric acid, oxalic acid, humic acid, fulvic acid, boric acid, acetic acid, and a combination thereof, wherein the ratio of copper to zinc is between 1:2 and 1:20, and wherein the composition is formulated as a dry powder.

26. The composition of claim 1, wherein the composition is formulated as a foliar spray, seed treatment, or drenching treatment.

27. A composition comprising zinc sulfate monohydrate (ZnSO₄—H₂O), copper (II) sulfate pentahydrate (CuSO₄·5H₂O), and an acid, wherein the acid is selected from citric acid, sulfuric acid, oxalic acid, humic acid, fulvic acid, boric acid, acetic acid, and a combination thereof, wherein the ratio of copper to zinc is between 1:2 and 1:20, and wherein the composition is formulated as a foliar spray.

28. The composition of claim 1, wherein the composition is enclosed within a calcium lignin sulfate capsule.

29. A method of reducing cellular damage to a plant comprising treating the plant with composition comprising zinc, copper, and acid, wherein the acid is selected from citric acid, sulfuric acid, oxalic acid, humic acid, fulvic acid, boric acid, acetic acid, and a combination thereof, and optionally ammonium sulfate, wherein the ratio of copper to zinc is between 1:2 and 1:20.

30. A method of priming a plant against abiotic stress factors comprising treating the plant with a composition comprising zinc, copper, and acid, wherein the acid is selected from citric acid, sulfuric acid, oxalic acid, humic acid, fulvic acid, boric acid, acetic acid, and a combination thereof, and optionally ammonium sulfate, wherein the ratio of copper to zinc is between 1:2 and 1:20.

31. The method according to claim 30, wherein the abiotic stress factor is drought, salinity, heat, or combinations thereof.

32. A method of promoting growth of a plant comprising treating the plant with a composition comprising zinc, copper, and acid, wherein the acid is selected from citric acid, sulfuric acid, oxalic acid, humic acid, fulvic acid, boric acid, acetic acid, and a combination thereof, and optionally ammonium sulfate, wherein the ratio of copper to zinc is between 1:2 and 1:20.

33. A method of priming a plant against biotic stress factors comprising treating the plant with a composition comprising zinc, copper, and acid, wherein the acid is selected from citric acid, sulfuric acid, oxalic acid, humic acid, fulvic acid, boric acid, acetic acid, and a combination thereof, wherein the ratio of copper to zinc is between 1:2 and 1:20.

34. The method according to claim 33, wherein the biotic stress factor is fungal, bacterial, viral, or insect infection or combinations thereof.

35. The method of claim 29, wherein treating the plant comprises treating a seed of the plant with the composition.

36. A method of controlling a fungus infection in a plant susceptible thereto, the method comprising applying a composition comprising zinc, copper, and acid, wherein the acid is selected from citric acid, sulfuric acid, oxalic acid, humic acid, fulvic acid, boric acid, acetic acid, and a combination thereof, and optionally ammonium sulfate, wherein the ratio of copper to zinc is between 1:2 and 1:20.

37. The method of claim 36, wherein the composition is applied to a seed of the plant.

38. The method of claim 35, wherein the seed is soaked in a solution comprising the composition.

39. The method of claim 29, wherein the ratio of copper to zinc is between 1:3 and 1:10.

40. The method of claim 29, wherein the ratio of copper to zinc is 1:3.

41. The method of claim 29, wherein the ratio of copper to zinc is 1:5.

42. The method of claim 29, wherein the ratio of copper to zinc is 1:10.

43. The method of claim 29, wherein the zinc is zinc sulfate monohydrate (ZnSO₄·H₂O).

44. The method of claim 43, wherein the zinc sulfate monohydrate (ZnSO₄·H₂O). has a zinc content of 36%.

45. The method of claim 30, wherein following treatment the plant increases production of one or more plant priming biomarkers.

46. The method of claim 45, wherein the one or more biomarkers include silicic acid, butanoic acid, ascorbic acid, linoleic acid, hexanoic acid, propanedioic acid, succinic acid, 2-Ketoisocaproic acid oxime, bis(trimethylsilyl)- derivative, 5-tert-butyl-4-chloromethyl-furan-2-carboxylic acid amide, fumaric acid, 2,4-dichlorophenyl 2,4,6-trichlorophenyl ester, guanidosuccinic acid, aspartic acid, arachidonic acid, acontine, quinine, epimedin A, ginsenosides, taxifolin, psoralidin, artemisinin, picrotoxinin, indole-3-carboxylic acid, 5-hydroxy-2-(4-morpholylmethyl)-1-phenyl-, ethyl ester, sebacic acid, 2,2-dichloroethyl isobutyl ester, Cyclohexaneacetic acid, 2,2,3,3,4,4,5,5,6,6,7,7-dodecafluoroheptyl ester, 1,4-Cyclohexadiene-1-propanoic acid, 3-(dichloromethyl)-3-methyl-6-oxo-, ethyl ester, anthranilic acid, or benzoic acid.

47. The method of claim 29, wherein the copper is copper (II) sulfate pentahydrate (CuSO₄·5H₂O).

48. The method of claim 47, wherein the copper (II) sulfate pentahydrate (CuSO₄·5H₂O) has a copper content of 25%.

49. The method of claim 29, further comprising iron.

50. The method of claim 49, wherein the ratio of ratio of copper to zinc to iron is 1:3:1.

51. The method of claim 49, wherein the iron is iron (II) sulfate heptahydrate (FeSO₄·7H₂O).

52. The method of claim 29, wherein the acid is between about 0.1% and 20% of the total weight.

53. The method of claim 29, wherein the acid is citric acid.

54. The method of claim 53, wherein the citric acid is between about 5% and 10% of the total weight.

55. The method of claim 30, wherein the acid is fulvic acid.

56. The method of claim 55, wherein the fulvic acid is between about 1% and about 5% of the total weight.

57. The method of claim 29, wherein the acid is boric acid.

58. The method of claim 57, wherein the boric acid is between about 0.1% and about 1% of the total weight.

59. The method of claim 29, further comprising a binding agent.

60. The method of claim 59, wherein the binding agent is selected from molasses, gum, native starch, and modified starch.

61. The method of claim 28, wherein the composition does not comprise ammonium sulfate.

62. The method of claim 28, wherein the acid is not sulfuric acid.

63. A method of making the composition of claim 1, comprising weighing, grinding, and mixing each component to a defined particle size.

64. The method of claim 63, wherein the defined particle size is about 250 μm to about 400 μm.
